(19) United States
(12) Patent Application Publication
(10) Pub. No.: US 2026/0270897 A1
(43) Pub. Date: Sep. 10, 2026

(54) APPARATUS AND METHOD FOR TRANSMITTING AND RECEIVING SYNCHRONIZATION SIGNAL IN WIRELESS COMMUNICATION SYSTEM

(71) Applicant: LG Electronics Inc., Seoul (KR)

(72) Inventors: Kukheon CHOI, Seoul (KR); Seungmin WOO, Seoul (KR); Youngtaek HONG, Seoul (KR)

(21) Appl. No.: 19/165,434

(22) PCT Filed: Mar. 15, 2024
(86) PCT No.: PCT/KR2024/003292

§ 371 Date: Sep. 15, 2025

(30) Foreign Application Priority Data
Mar. 15, 2023 (KR) 10-2023-0033613

(51) Int. Cl. H04W 56/00; H04L 5/00

(52) U.S. Cl. CPC H04W 56/001; H04L 5/0051

(57) ABSTRACT

The purpose of the present disclosure is to transmit and receive synchronization signal multiplexed in a frequency domain in a wireless communication system. An operation method of a user equipment (UE) comprises the step of: receiving, from a base station, at least one synchronization signal block (SSB) among a plurality of SSBs including a first SSB and a second SSB, detecting a synchronization signal included in the at least one SSB, transmitting, to the base station, a feedback signal based on the synchronization signal, and performing a communication with the base station, wherein the first SSB and the second SSB are multiplexed in a frequency domain within one time interval.

### TECHNICAL FIELD

The following description relates to a wireless communication system, and to a device and a method for transmitting and receiving a synchronization signal in the wireless communication system.

### BACKGROUND ART

Wireless communication systems have been widely deployed to provide various types of communication services such as voice or data. In general, a wireless communication system is a multiple access system that supports communication of multiple users by sharing available system resources (a bandwidth, transmission power, etc.). Examples of multiple access systems include a code division multiple access (CDMA) system, a frequency division multiple access (FDMA) system, a time division multiple access (TDMA) system, an orthogonal frequency division multiple access (OFDMA) system, and a single carrier frequency division multiple access (SC-FDMA) system.

In particular, as a large number of communication devices require a large communication capacity, the enhanced mobile broadband (eMBB) communication technology, as compared to the conventional radio access technology (RAT), is being proposed. In addition, not only massive machine type communications (massive MTC), which provide a variety of services anytime and anywhere by connecting multiple devices and objects, but also a communication system considering a service/user equipment (UE) sensitive to reliability and latency is being proposed. Various technical configurations for this are being proposed.

### DISCLOSURE

### Technical Problem

The present disclosure is directed to an apparatus and a method for transmitting and receiving a synchronization signal in a wireless communication system.

The present disclosure is directed to an apparatus and a method for transmitting and receiving a plurality of synchronization signals multiplexed in a frequency domain in a wireless communication system.

The present disclosure is directed to an apparatus and a method for performing communication using a reconfigurable intelligent surface (RIS) in a wireless communication system.

The present disclosure is directed to an apparatus and a method for performing communication using a network-controlled repeater (NCR) in a wireless communication system.

The present disclosure is directed to an apparatus and a method for transmitting and receiving a plurality of synchronization signals for performing beam measurement in a wireless communication system.

The present disclosure is directed to an apparatus and a method for determining a reference point based on a synchronization signal in a wireless communication system.

The present disclosure is directed to an apparatus and a method for transmitting an index of a synchronization signal in a wireless communication system.

The present disclosure is directed to an apparatus and a method for performing configuration related to a transmission type of a synchronization signal in a wireless communication system.

The present disclosure is directed to an apparatus and a method for transmitting a feedback signal based on a plurality of synchronization signals in a wireless communication system.

The present disclosure is directed to an apparatus and a method for determining the number of synchronization signals included in a time interval to which frequency domain multiplexed synchronization signals are allocated in a wireless communication system.

The technical purposes to be achieved in the present disclosure are not limited to the matters mentioned above, and other technical problems not mentioned may be considered by those skilled in the art to which the technical configuration of the present disclosure is applied from the embodiments of the present disclosure to be described below.

### Technical Solution

According to an embodiment of the present disclosure, a method performed by user equipment (UE) in a wireless communication system may comprise: receiving, from a base station, at least one synchronization signal block (SSB) among a plurality of SSBs including a first SSB and a second SSB; detecting a synchronization signal included in the at least one SSB; transmitting, to the base station, a feedback signal based on the synchronization signal; and performing communication with the base station, wherein the first SSB and the second SSB may be multiplexed in a frequency domain within one time interval.

According to an embodiment of the present disclosure, a method performed by a base station in a wireless communication system may comprise: transmitting, to user equipment (UE), a plurality of synchronization signal blocks (SSBs) including a first SSB and a second SSB; receiving, the UE, a feedback signal based on a detected synchronization signal; and performing communication with the UE, wherein the first SSB and the second SSB may be multiplexed in a frequency domain within one time interval.

According to an embodiment of the present disclosure, user equipment (UE) in a wireless communication system may be provided with: a transceiver; and

May comprise: processor connected to the transceiver, wherein the processor may control to: receive, from a base station, at least one synchronization signal block (SSB) among a plurality of SSBs including a first SSB and a second SSB; detect a synchronization signal included in the at least one SSB; transmit, to the base station, a feedback signal based on the synchronization signal; and perform communication with the base station, wherein the first SSB and the second SSB may be multiplexed in a frequency domain within one time interval.

According to an embodiment of the present disclosure, a base station in a wireless communication system may comprise: a transceiver; and a processor connected to the transceiver, wherein the processor may control to: transmit, to user equipment (UE), a plurality of synchronization signal blocks (SSBs) including a first SSB and a second SSB; receive, from the UE, a feedback signal based on a detected synchronization signal; and perform communication with the UE, wherein the first SSB and the second SSB may be multiplexed in a frequency domain within one time interval.

According to an embodiment of the present disclosure, a communication apparatus may comprise: at least one processor; and at least one computer memory connected to the at least one processor, storing instructions that instruct operations according to being executed by the at least one processor, wherein the operations may comprise: receiving, from a base station, at least one synchronization signal block (SSB) among a plurality of SSBs including a first SSB and a second SSB; detecting a synchronization signal included in the at least one SSB; transmitting, to the base station, a feedback signal based on the synchronization signal; and performing communication with the base station, wherein the first SSB and the second SSB may be multiplexed in a frequency domain within one time interval.

According to an embodiment of the present disclosure, a non-transitory computer-readable medium storing at least one instruction may comprise: the at least one instruction executable by a processor, wherein the at least one instruction may control a device to: receive, from a base station, at least one synchronization signal block (SSB) among a plurality of SSBs including a first SSB and a second SSB; detect a synchronization signal included in the at least one SSB; transmit, to the base station, a feedback signal based on the synchronization signal; and perform communication with the base station, wherein the first SSB and the second SSB may be multiplexed in a frequency domain within one time interval.

The above-described features of the present disclosure are only some of the preferred embodiments of the present disclosure, and various embodiments reflecting the technical features of the present disclosure may be derived and understood by one with ordinary skill in the art based on the detailed description of the present disclosure that follows.

### Advantageous Effects

According to embodiments based on the present disclosure, the following effects may be achieved.

According to embodiment of the present disclosure, the synchronization signals may be efficiently transmitted and received.

The effects obtainable from the embodiments of the present disclosure are not limited to the effects mentioned above, and other effects not mentioned may be clearly derived and understood by those skilled in the art to which the technical configuration of the present disclosure is applied from the description of the embodiments of the present disclosure below. That is, unintended effects resulting from implementing the configuration described in the present disclosure may also be derived by those skilled in the art from the embodiments of the present disclosure.

### BRIEF DESCRIPTION OF THE DRAWINGS

The accompanying drawings are provided to help understanding of the present disclosure, and may provide embodiments of the present disclosure together with a detailed description. However, the technical features of the present disclosure are not limited to specific drawings, and the features disclosed in each drawing may be combined with each other to constitute a new embodiment. Reference numerals in each drawing may refer to structural elements.

FIG. 1 illustrates an example of a communication system applicable to the present disclosure.

FIG. 2 illustrates an example of a wireless device applicable to the present disclosure.

FIG. 3 illustrates a method of processing a transmitted signal applicable to the present disclosure.

FIG. 4 illustrates an example of a communication structure providable in a 6th generation (6G) system applicable to the present disclosure.

FIG. 4 illustrates a communication procedure between a terminal and a base station that are applicable to the present disclosure.

FIG. 5 illustrates an example of a communication structure providable in a 6G system applicable to the present disclosure.

FIG. 6 illustrates an electromagnetic spectrum applicable to the present disclosure.

FIG. 7 illustrates a THz communication method applicable to the present disclosure.

FIG. 8 illustrates a THz signal generation method applicable to the present disclosure.

FIG. 9 illustrates a wireless communication transceiver applicable to the present disclosure.

FIG. 10 illustrates a transmitter structure applicable to the present disclosure.

FIG. 11 illustrates a system information transmission procedure applicable to the present disclosure.

FIG. 12 illustrates a beam management procedure applicable to the present disclosure.

FIG. 13 illustrates an example of a procedure for transmitting system information for Terahertz (THz) communication.

FIG. 14 illustrates an example of a communication scenario using a reconfigurable intelligent surface (RIS) according to an embodiment of the present disclosure.

FIG. 15 illustrates an example of using RIS in a penetration environment in which radio waves from an outdoor base station penetrate into indoor according to an embodiment of the present disclosure.

FIGS. 16a to 16d illustrate examples of RIS configuration environments according to an embodiment of the present disclosure.

FIGS. 17a and 17b illustrate examples of a relay network layer structure according to an embodiment of the present disclosure.

FIG. 18 illustrates an example of link modeling related to a network-controlled repeater (NCR) according to an embodiment of the present disclosure.

FIG. 19 illustrates an example in which a beam of a base station and a beam of RIS are formed according to an embodiment of the present disclosure.

FIG. 20 illustrates an example in which a synchronization signal block (SSB) is allocated to one frame structure according to an embodiment of the present disclosure.

FIG. 21 illustrates an example of a first SSB transmission type multiplexed in a frequency domain according to an embodiment of the present disclosure.

FIG. 22 illustrates an example of a procedure in which user equipment (UE) performs synchronization by using synchronization signals multiplexed in a frequency domain according to an embodiment of the present disclosure.

FIG. 23 illustrates an example of a procedure in which a base station performs communication with UE by using synchronization signals multiplexed in a frequency domain according to an embodiment of the present disclosure.

FIG. 24 illustrates an example of ambiguity of a reference time point in an SSB frame structure multiplexed in a frequency domain according to an embodiment of the present disclosure.

FIGS. 25a and 25b illustrate examples of a structure in which SSBs are allocated to the same time interval according to an embodiment of the present disclosure.

FIG. 26 illustrates an example of a procedure in which UE transmits a feedback signal based on a plurality of synchronization signals according to an embodiment of the present disclosure.

FIG. 27 illustrates an example of a procedure in which UE determines a reference point based on a synchronization signal according to an embodiment of the present disclosure.

FIG. 28 illustrates an example of a procedure in which a base station receives a feedback signal based on a plurality of synchronization signals according to an embodiment of the present disclosure.

FIG. 29 illustrates an example of a second SSB transmission type according to an embodiment of the present disclosure.

FIG. 30 illustrates an example of a third SSB transmission type according to an embodiment of the present disclosure.

FIGS. 31a and 31b illustrate examples of a fourth SSB transmission type according to an embodiment of the present disclosure.

FIG. 32 illustrates an example of a fifth SSB transmission type according to an embodiment of the present disclosure.

FIG. 33 illustrates another example of a fifth SSB transmission type in which SSBs are allocated in an on-off method according to an embodiment of the present disclosure.

FIG. 34 illustrates an example of a sixth SSB transmission type according to an embodiment of the present disclosure.

FIG. 35 illustrates an example of a procedure in which a base station transmits a plurality of synchronization signals multiplexed in a frequency domain through RIS or NCR according to an embodiment of the present disclosure.

FIGS. 36a and 36b illustrate examples of signaling procedures for transmitting synchronization signals multiplexed in a frequency domain according to an embodiment of the present disclosure.

FIG. 37 illustrates an example of signaling between a base station and UE according to an embodiment of the present disclosure.

FIG. 38 illustrates an example of a wireless device applicable to the present disclosure.

FIG. 39 illustrates an example of a hand-held device applicable to the present disclosure.

FIG. 40 illustrates an example of a car or an autonomous driving vehicle applicable to the present disclosure.

FIG. 41 illustrates an example of a car to the present disclosure.

FIG. 42 illustrates an example of an XR device applicable to the present disclosure.

FIG. 43 illustrates an example of a robot applicable to the present disclosure.

FIG. 44 illustrates an example of artificial intelligence (AI) device applicable to the present disclosure.

### MODE FOR INVENTION

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the embodiments of the present disclosure, a description is mainly made of a data transmission and reception relationship between a base station (BS) and a mobile station. A BS refers to a terminal node of a network, which directly communicates with a mobile station. A specific operation described as being performed by the BS may be performed by an upper node of the BS.

Namely, it is apparent that, in a network comprised of a plurality of network nodes including a BS, various operations performed for communication with a mobile station may be performed by the BS, or network nodes other than the BS. The term “BS” may be replaced with a fixed station, a Node B, an evolved Node B (eNode B or eNB), a next generation Node B (gNode B or gNB), an advanced base station (ABS), an access point, etc.

In the embodiments of the present disclosure, the term terminal may be replaced with a UE, a mobile station (MS), a subscriber station (SS), a mobile subscriber station (MSS), a mobile terminal, an advanced mobile station (AMS), etc.

A transmitter is a fixed and/or mobile node that provides a data service or a voice service and a receiver is a fixed and/or mobile node that receives a data service or a voice service. Therefore, a mobile station may serve as a transmitter and a BS may serve as a receiver, on an uplink (UL). Likewise, the mobile station may serve as a receiver and the BS may serve as a transmitter, on a downlink (DL).

The embodiments of the present disclosure may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, 3GPP 5th generation (5G) new radio (NR) system, and a 3GPP2 system. In particular, the embodiments of the present disclosure may be supported by the standard specifications, 3GPP TS 36.211, 3GPP TS 36.212, 3GPP TS 36.213, 3GPP TS 36.321 and 3GPP TS 36.331.

In addition, the embodiments of the present disclosure are applicable to other radio access systems and are not limited to the above-described system. For example, the embodiments of the present disclosure are applicable to systems applied after a 3GPP 5G NR system and are not limited to a specific system.

That is, steps or parts that are not described to clarify the technical features of the present disclosure may be supported by those documents. Further, all terms as set forth herein may be explained by the standard documents.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

The embodiments of the present disclosure can be applied to various radio access systems such as code division multiple access (CDMA), frequency division multiple access (FDMA), time division multiple access (TDMA), orthogonal frequency division multiple access (OFDMA), single carrier frequency division multiple access (SC-FDMA), etc.

Hereinafter, in order to clarify the following description, a description is made based on a 3GPP communication system (e.g., LTE, NR, etc.), but the technical spirit of the present disclosure is not limited thereto. LTE may refer to technology after 3GPP TS 36.xxx Release 8. In detail, LTE technology after 3GPP TS 36.xxx Release 10 may be referred to as LTE-A, and LTE technology after 3GPP TS 36.xxx Release 13 may be referred to as LTE-A pro. 3GPP NR may refer to technology after TS 38.xxx Release 15. 3GPP 6G may refer to technology TS Release 17 and/or Release 18. “xxx” may refer to a detailed number of a standard document. LTE/NR/6G may be collectively referred to as a 3GPP system.

For background arts, terms, abbreviations, etc. used in the present disclosure, refer to matters described in the standard documents published prior to the present disclosure. For example, reference may be made to the standard documents 36.xxx and 38.xxx.

### Communication System Applicable to the Present Disclosure

Without being limited thereto, various descriptions, functions, procedures, proposals, methods and/or operational flowcharts of the present disclosure disclosed herein are applicable to various fields requiring wireless communication/connection (e.g., 5G).

Hereinafter, a more detailed description will be given with reference to the drawings. In the following drawings/description, the same reference numerals may exemplify the same or corresponding hardware blocks, software blocks or functional blocks unless indicated otherwise.

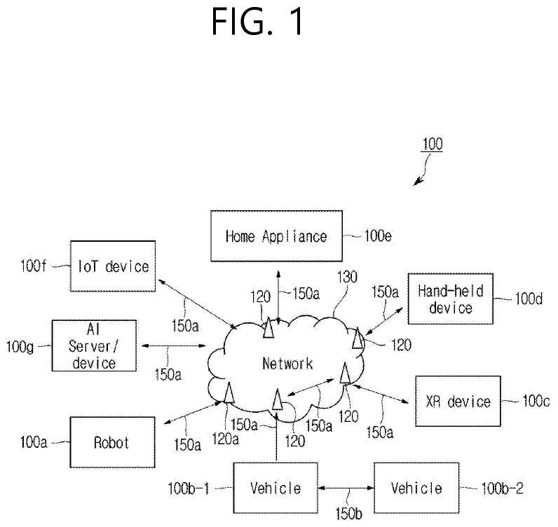

FIG. 1 illustrates an example of a communication system applicable to the present disclosure.

Referring to FIG. 1, the communication system 100 applicable to the present disclosure includes a wireless device, a base station and a network. The wireless device refers to a device for performing communication using radio access technology (e.g., LTE, LTE-A, LTE-A pro, NR, 5G, 5G-A or 6G) and may be referred to as a communication/wireless/5G device. Without being limited thereto, the wireless device may include a robot 100 a, vehicles 100 b-1 and 100 b-2, an extended reality (XR) device 100 c, a hand-held device 100 d, a home appliance 100 e, an Internet of Thing (IoT) device 100 f, and an artificial intelligence (AI) device/server 100 g. For example, the vehicles may include a vehicle having a wireless communication function, an autonomous vehicle, a vehicle capable of performing vehicle-to-vehicle communication, etc. The vehicles 100 b-1 and 100 b-2 may include an unmanned aerial vehicle (UAV) (e.g., a drone). The XR device 100 c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The hand-held device 100 d may include a smartphone, a smart pad, a wearable device (e.g., a smart watch or smart glasses), a computer (e.g., a laptop), etc. The home appliance 100 e may include a TV, a refrigerator, a washing machine, etc. The IoT device 100 f may include a sensor, a smart meter, etc. For example, the base station 120 and the network 130 may be implemented by a wireless device, and a specific wireless device 120 a may operate as a base station/network node for another wireless device.

The wireless devices 100 a to 100 f may be connected to the network 130 through the base station 120. AI technology is applicable to the wireless devices 100 a to 100 f, and the wireless devices 100 a to 100 f may be connected to the AI server 100 g through the network 130. The network 130 may be configured using a 3G network, a 4G (e.g., LTE) network, a 5G (e.g., NR) network or a 6G network, etc. The wireless devices 100 a to 100 f may communicate with each other through the base station 120/the network 130 or perform direct communication (e.g., sidelink communication) without through the base station 120/the network 130. For example, the vehicles 100 b-1 and 100 b-2 may perform direct communication (e.g., vehicle to vehicle (V2V)/vehicle to everything (V2X) communication). In addition, the IoT device 100 f (e.g., a sensor) may perform direct communication with another IoT device (e.g., a sensor) or the other wireless devices 100 a to 100 f.

Wireless communications/connections 150 a, 150 b and 150 c may be established between the wireless devices 100 a to 100 f/the base station 120 and the base station 120/the base station 120. Here, wireless communication/connection may be established through various radio access technologies such as uplink/downlink communication 150 a, sidelink communication 150 b (or D2D communication) or communication 150 c between base stations (e.g., relay, integrated access backhaul (IAB)). The wireless device and the base station/wireless device or the base station and the base station may transmit/receive radio signals to/from each other through wireless communication/connection 150 a, 150 b and 150 c. For example, wireless communication/connection 150 a, 150 b and 150 c may enable signal transmission/reception through various physical channels. To this end, based on the various proposals of the present disclosure, at least some of various configuration information setting processes for transmission/reception of radio signals, various signal processing procedures (e.g., channel encoding/decoding, modulation/demodulation, resource mapping/demapping, etc.), resource allocation processes, etc. may be performed.

### Wireless Device Applicable to the Present Disclosure

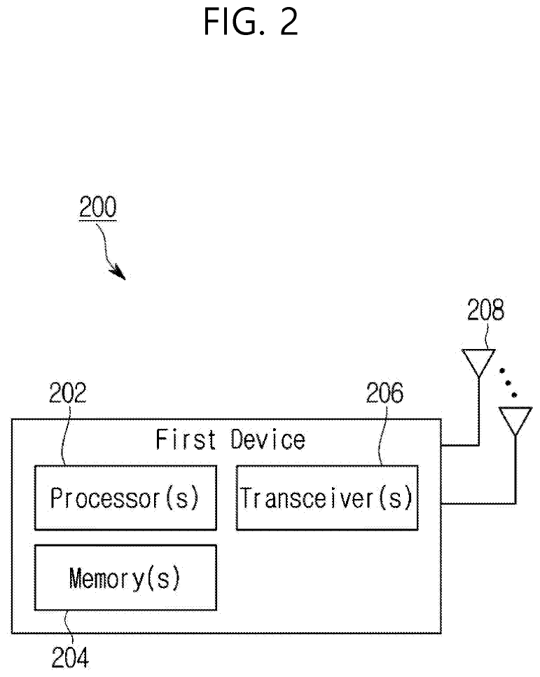

FIG. 2 illustrates an example of a wireless device applicable to the present disclosure.

Referring to FIG. 2, a wireless device 200 may transmit/receive a radio signal through various wireless access technologies (e.g., LTE, LTE-A, LTE-A pro, NR, 5G, 5G-A, 6G). The wireless device 200 may include at least one processor 202 and at least one memory 204 and additionally further include at least one transceiver 206 and/or at least one antenna 208.

The processor 202 may be configured to control the memory 204 and/or the transceiver 206 and to implement the descriptions, functions, procedures, proposals, methods, and/or operation flowcharts disclosed in this document. For example, the processor 202 may generate first information/signal by processing information in the memory 204 and then transmit a radio signal including the first information/signal through the transceiver 206. In addition, the processor 202 may receive a radio signal including second information/signal through the transceiver 206 and then store information obtained from signal processing of the second information/signal in the memory 204. The memory 204 may be connected to the processor 202 and store a variety of information associated with an operation of the processor 202. For example, the memory 204 may store a software code including instructions for implementing some or all of processes controlled by the processor 202 or for implementing the descriptions, functions, procedures, proposals, methods, and/or operation flowcharts disclosed in this document. Herein, the processor 202 and the memory 204 may be a part of a communication modem/circuit/chip designed for implementing a wireless communication technology. The transceiver 206 may be connected to the processor 202 and transmit and/or receive a radio signal through the at least one antenna 208. The transceiver 206 may be a transmitter and/or a receiver. The transceiver 206 may be used interchangeably with a radio frequency (RF) unit. In the present disclosure, a wireless device may mean a communication modem/circuit/chip.

Hereinafter, a hardware element of the wireless device 200 will be described in further detail. Although not being limited thereto, at least one protocol layer may be implemented by the at least one processor 202. For example, the at least one processor 202 may implement at least one layer (e.g., a functional layer such as physical (PHY), media access control (MAC), radio link control (RLC), packet data convergence protocol (PDCP), radio resource control (RRC), and service data adaptation protocol (SDAP)). The at least one processor 202 may generate at least one protocol data unit (PDU) and/or at least one service data unit (SDU) according to the descriptions, functions, procedures, proposals, methods, and/or operation flowcharts disclosed in this document. The at least one processor 202 may generate a message, control information, data, or information according to the descriptions, functions, procedures, proposals, methods, and/or operation flowcharts disclosed in this document. The at least one processor 202 may generate a signal (e.g., a baseband signal) including a PDU, an SDU, a message, control information, data, or information according to a function, a procedure, a suggestion and/or a method, which are disclosed in the present document, and provide the signal to the at least one transceiver 206. The at least one processor 202 may receive a signal (e.g., a baseband signal) from the at least one transceiver 206 and obtain a PDU, an SDU, a message, control information, data, or information according to the descriptions, functions, procedures, proposals, methods, and/or operation flowcharts disclosed in this document.

The at least one processor 202 may be referred to as a controller, a microcontroller, a microprocessor, or a microcomputer. The at least one processor 202 may be implemented by hardware, firmware, software, or a combination thereof. As an example, at least one application specific integrated circuit (ASIC), at least one digital signal processor (DSP), at least one digital signal processing devices (DSPD), at least one programmable logic device (PLD), or at least one field programmable gate array (FPGA) may be included in the at least one processor 202. The descriptions, functions, procedures, proposals, methods, and/or operation flowcharts disclosed in this document may be implemented using firmware or software, and the firmware or software may be implemented to include the modules, procedures, or functions. Firmware or software configured to perform the descriptions, functions, procedures, proposals, methods, and/or operation flowcharts disclosed in this document may be included in the at least one processor 202 or may be stored in the at least one memory 204 and executed by the at least one processor 202. The descriptions, functions, procedures, proposals, methods, and/or operation flowcharts disclosed in this document may be implemented using firmware or software in the form of code, an instruction, and/or a set of instructions.

The at least one memory 204 may be connected to the at least one processor 202 and store various forms of data, signals, messages, information, programs, codes, indications, and/or instructions. The at least one memory 204 may be configured as a read only memory (ROM), a random access memory (RAM), an erasable programmable read only memory (EPROM), a flash memory, a hard drive, a register, a cache memory, a computer-readable storage media, and/or a combination thereof. The at least one memory 204 may be located at the interior and/or exterior of the at least one processor 202. In addition, the at least one memory 204 may be connected to the at least one processor 202 through various technologies such as wired or wireless connection.

The at least one transceiver 206 may transmit user data, control information, and wireless signals/channels, mentioned in the methods and/or operation flowcharts of this document, to at least one other device. The at least one transceiver 206 may receive user data, control information, and wireless signals/channels, mentioned in the descriptions, functions, procedures, proposals, methods, and/or operation flowcharts disclosed in this document, from at least one other device. For example, the at least one transceiver 206 may be connected to the at least one processor 202 and transmit and receive radio signals. For example, the at least one processor 202 may control the at least one transceiver 206 to transmit user data, control information, or a radio signal to at least one other device. In addition, the at least one processor 202 may control the at least one transceiver 206 to receive user data, control information, or a radio signal from at least one other device. In addition, the at least one transceiver 206 may be connected to the at least one antenna 208, and the at least one transceiver 206 may be configured to transmit and receive user data, control information, radio signals/channels mentioned in the descriptions, functions, procedures, proposals, methods and/or operation flowcharts disclosed in this document through the at least one antenna 208. In this document, the at least one antenna may be a plurality of physical antennas or a plurality of logical antennas (e.g., antenna ports). The at least one transceiver 206 may convert received radio signals/channels from RF band signals into baseband signals in order to process received user data, control information, and radio signals/channels using the at least one processor 202. The at least one transceiver 206 may convert the user data, control information, and radio signals/channels processed using the at least one processor 202 from the baseband signals into the RF band signals. To this end, the at least one transceiver 206 may include an (analog) oscillator and/or a filter.

The constituents of the wireless device, which are described in reference to FIG. 2, may be referred to as other terms from functional aspects. For example, the processor 202 may be referred to as a control unit, the transceiver 206 may be referred to as a communication unit, and the memory 204 may be referred to as a storage unit. In some cases, the communication unit may be used for a meaning including at least a part of the processor 202 and the transceiver 206.

The structure of the wireless device, which is described in reference to FIG. 2, may be understood as a structure of at least a part of various devices. As an example, the structure of the wireless device, which is described in reference to FIG. 2, may be at least a part of various devices described with reference to FIG. 1 (e.g., a robot 100a, a vehicle 100b-1, 100b-2, an XR device 100c, a hand-held device 100d, a home appliance 100e, an IoT device 100f, an AI device/a server 100g). Furthermore, according to various embodiments, apart from the constituents exemplified in FIG. 2, a device may further other constituents.

For example, a device may be a hand-held device such as a smartphone, a smart pad, a wearable device (e.g., a smart watch, smart glasses), and a hand-held computer (e.g., a laptop, etc.). In this case, the device may further include at least one of a power supply unit that supplies power and includes a wired/wireless charging circuit, a battery and the like, an interface unit including at least one port (e.g., an audio input/output port, a video input/output port) for connection to another device, and an input/output unit for inputting and outputting video information/signals, audio information/signals, data and/or information input from a user.

For example, a device may be a mobile device such as a mobile robot, a vehicle, a train, a manned/unmanned aerial vehicle (AV), and a ship. In this case, the device may further include at least one of a drive unit including at least one of the engine, motor, powertrain, wheels, brake, and steering device of the device, a power supply unit that supplies power and includes a wired/wireless charging circuit, a battery and the like, a sensor unit that senses state information of the device or surrounding the device, environment information and user information, an autonomous driving unit that performs functions such as route maintenance, speed control and destination setting, and a location measurement unit that obtains moving object location information through a global positioning system (GPS) and various sensors.

For example, a device may be an XR device such as an HMD, a head-up display (HUD) provided in a vehicle, a television, a smartphone, a computer, a wearable device, a home appliance device, a digital signage, a vehicle, and a robot. In this case, the device may further include at least one of a power supply unit that supplies power and includes a wired/wireless charging circuit, a battery and the like, an input/output unit that obtains control information and data from outside and outputs a generated XR object, and a sensor unit that senses state information of the device or surrounding the device, environment information and user information.

For example, a device may be a robot that may be classified for industrial use, medical use, domestic use, military use and the like according to purposes of use or fields. In this case, the device may further include at least one of a sensor unit that senses state information of the device or surrounding the device, environment information and user information and a drive unit that moves robot joints and performs various other physical operations.

For example, a device may be an AI device such as a TV, a projector, a smartphone, a PC, a laptop, a terminal for digital broadcasting, a tablet PC, a wearable device, a set-top box (STB), a radio, a washing machine, a refrigerator, a digital signage, a robot, and a vehicle. In this case, the device may further include at least one of an input unit that obtains various types of data from outside, an output unit that generates outputs associated with sight, hearing, or touch, a sensor unit that senses state information of the device or surrounding the device, environment information and user information, and a training unit that uses learning data to learn a model consisting of artificial neural networks.

The structure of the wireless device exemplified in FIG. 2 may be understood as a part of a RAN node (e.g., a base station, a DU, a RU, a RRH, etc.). That is, the device exemplified in FIG. 2 may be a RAN node. In this case, the device may further include a wired transceiver for front haul and/or back haul communication. However, in case the front haul and/or back haul communication is based on wireless communication, the at least one transceiver 206 exemplified in FIG. 2 may be used for the front haul and/or back haul communication, and no wired transceiver may be included.

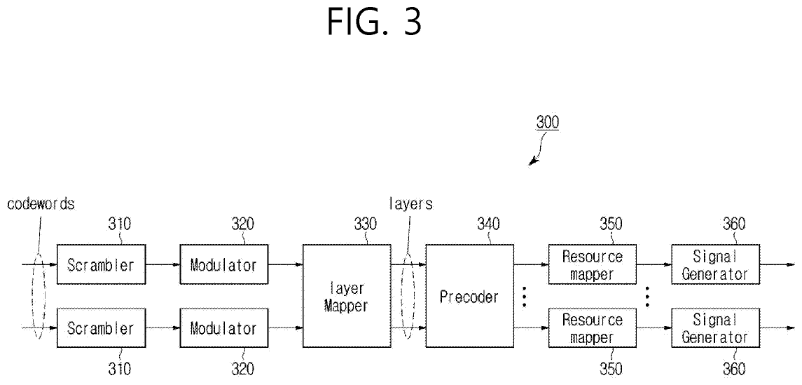

FIG. 3 illustrates a method of processing a transmitted signal applicable to the present disclosure. For example, the transmitted signal may be processed by a signal processing circuit. At this time, a signal processing circuit 300 may include a scrambler 310, a modulator 320, a layer mapper 330, a precoder 340, a resource mapper 350, and a signal generator 360. At this time, for example, the operation/function of FIG. 3 may be performed by the processors 202 and/or the transceiver 206 of FIG. 2. In addition, for example, the hardware element of FIG. 3 may be implemented in the processors 202 of FIG. 2 and/or the transceivers 206 of FIG. 2. For example, blocks 310 to 360 may be implemented in the processors 202 of FIG. 2. In addition, blocks 310 to 350 may be implemented in the processors 202 of FIG. 2 and a block 360 may be implemented in the transceivers 206 of FIG. 2, without being limited to the above-described embodiments.

A codeword may be converted into a radio signal through the signal processing circuit 300 of FIG. 3. Here, the codeword is a coded bit sequence of an information block. The information block may include a transport block (e.g., a UL-SCH transport block or a DL-SCH transport block). Herein, the information block may include data related to artificial intelligence (AI) (e.g., learning data, AI model data, input data, output data, etc.), and the codeword may be a coded bit sequence corresponding to the data related to AI. The radio signal may be transmitted through various physical channels (e.g., a PUSCH and a PDSCH). Specifically, the codeword may be converted into a bit sequence scrambled by the scrambler 310. The scramble sequence used for scramble is generated based in an initial value and the initial value may include ID information of a wireless device, etc. The scrambled bit sequence may be modulated into a modulated symbol sequence by the modulator 320. The modulation method may include pi/2-binary phase shift keying (pi/2-BPSK), m-phase shift keying (m-PSK), m-quadrature amplitude modulation (m-QAM), etc.

A complex modulation symbol sequence may be mapped to at least one transport layer by the layer mapper 330. Herein, a transport layer is a logical resource unit for mapping a signal or data transmitted through spatial resources to antenna ports, and one transport layer may correspond to one stream or one antenna port. Each of complex modulation symbols included in the complex modulation symbol sequence is mapped to at least one transport layer, thereby determining through which antenna port the symbol is transmitted. Modulation symbols of each transport layer may be mapped to corresponding antenna port(s) by the precoder 340 (precoding). The output z of the precoder 340 may be obtained by multiplying the output y of the layer mapper 330 by an N*M precoding matrix W. Here, N may be the number of antenna ports and M may be the number of transport layers. Here, the precoder 340 may perform precoding after transform precoding (e.g., discrete Fourier transform (DFT)) for complex modulation symbols. In addition, the precoder 340 may perform precoding without performing transform precoding.

The resource mapper 350 may map modulation symbols of each antenna port to time-frequency resources. The time-frequency resources may include a plurality of symbols (e.g., a CP-OFDMA symbol and a DFT-s-OFDMA symbol) in the time domain and include a plurality of subcarriers in the frequency domain. The signal generator 360 may generate a radio signal from the mapped modulation symbols, and the generated radio signal may be transmitted to another device through each antenna. To this end, the signal generator 360 may include an inverse fast Fourier transform (IFFT) module, a cyclic prefix (CP) insertor, a digital-to-analog converter (DAC), a frequency uplink converter, etc.

A signal processing procedure for a received signal in the wireless device may be configured as the inverse of the signal processing procedures 310 to 360 of FIG. 3. For example, the wireless device (e.g., 200 of FIG. 2) may receive a radio signal from the outside through an antenna port/transceiver. The received radio signal may be converted into a baseband signal through a signal restorer. To this end, the signal restorer may include a frequency downlink converter, an analog-to-digital converter (ADC), a CP remover, and a fast Fourier transform (FFT) module. Thereafter, the baseband signal may be restored to a codeword through a resource de-mapper process, a postcoding process, a demodulation process and a de-scrambling process. The codeword may be restored to an original information block through decoding. Accordingly, a signal processing circuit (not shown) for a received signal may include a signal restorer, a resource de-mapper, a postcoder, a demodulator, a de-scrambler and a decoder.

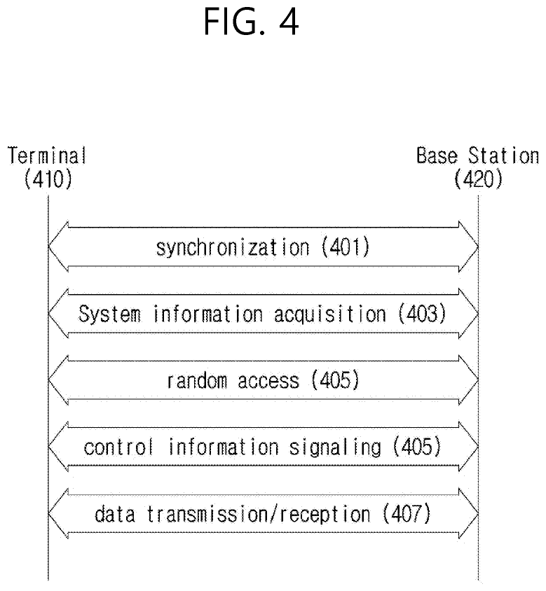

FIG. 4 illustrates a communication procedure between a terminal and a base station that are applicable to the present disclosure. FIG. 4 exemplifies an operation of transmitting and/or receiving data by a terminal 410 and a base station 420 and operations performed prior to the operation.

Referring to FIG. 4, at step S401, the terminal 410 and the base station 420 perform synchronization. For example, the terminal 410 performs an initial cell search operation. Specifically, the terminal 410 may detect at least one synchronization signal that is transmitted from the base station 420 according to a predefined rule. Herein, the synchronization signal may include a plurality of synchronization signals that are classified according to structure or purpose (e.g., a primary synchronization signal, a secondary synchronization signal). Thus, the terminal 410 may identify the boundary of a frame, a subframe, a slot and/or a symbol of the base station 420 and obtain information on the base station 420 (e.g., a cell identifier).

At step S403, the terminal 410 obtains system information transmitted from the base station 420. The system information is information related to the attribute, feature and/or capability of the base station 420, which is necessary to access the base station 420 and to use a service, and may be classified according to a content (e.g., whether or not it is absolutely necessary for access) and a transmission structure (e.g., a channel used therein, whether or not on-demand provision is performed) and be classified, for example, into a master information block (MIB) and a system information block (SIB). If necessary, the terminal 410 may transmit a signal for requesting system information before receiving system information. The system information may include information related to an AI function. For example, the system information may include, as information necessary for an operation performed based on AI, at least one of information related to an AI model, information related to training, and information related to inference/prediction. However, the request and provision of the system information may be performed after a random access procedure described below.

At step S405, the terminal 410 and the base station 420 perform the random access procedure. The terminal 410 may transmit and/or receive at least one message (e.g., a random access preamble, a random access response (RAR) message) for the random access procedure based on information related to a random access channel of the base station 420 (e.g., a channel position, a channel structure, a structure of a supported preamble), which is obtained through the system information. For example, the terminal 410 may transmit a preamble (e.g., MSG1) through a random access channel, receive a RAR message (e.g., MSG2), transmit a message (e.g., MSG3) including information related to the terminal 410 (e.g., identification information) by using scheduling information included in the RAR message to the base station 420, and receive a message (e.g., MSG4) for contention resolution and/or connection configuration. As another example, MSG1 and MSG3 as a single message or MSG2 and MSG4 as a single may be transmitted and received.

At step S407, the terminal 410 and the base station 420 perform signaling of control information. Herein, control information may be defined in various layers such as a layer for controlling connection (e.g., a radio resource control (RRC) layer), a layer for processing mapping between a logical channel and a transmission channel (e.g., a media access control (MAC) layer), and a layer for processing a physical channel (e.g., a physical (PHY) channel). For example, the terminal 410 and the base station 420 may perform at least one of signaling for establishing connection, signaling for determining a communication-related configuration, and signaling for indicating an allocated resource. In addition, signaling of control information may be performed to deliver information related to an AI function. For example, the information related to the AI function may include, as information necessary for an operation performed based on AI, at least one of information related to an AI model, information related to training, and information related to inference/prediction. More specifically, the information related to the AI function signaled at step 407 may be combined and/or integrated with the information related to the AI function signaled at step 403, and the two may be defined in a structure that is hierarchical, complementary, or alternative.

At step S409, the terminal 410 and the base station 420 transmit and/or receive data. In other words, the terminal 410 and the base station 420 may process data based on the signaling of the control information and transmit and/or receive the data. For example, when transmitting the data, the terminal 410 or the base station 420 may perform, for information bits, at least one of channel encoding, rate matching, scrambling, constellation mapping, layer mapping, waveform modulation, antenna mapping and resource mapping. On the other hand, when receiving the data, the terminal 410 or the base station 420 may perform at least one of signal extraction from a resource, waveform demodulation for each antenna, signal arrangement considering layer mapping, constellation demapping, descrambling, and channel decoding. Herein, the transmitted data is data related to AI and may include, for example, data for an AI-based operation or data generated by an AI-based operation.

Steps 401 to 409 described with reference to FIG. 4 are not necessarily required to be performed in the order exemplified in FIG. 4, and the order of at least some of the steps may be changed. In addition, at least some of steps 401 to 409 may be integrated into a single step or may be omitted. That is, the steps exemplified in FIG. 4 may be performed in various modified forms.

### 6G Communication System and Core Implementation Technology of 6G System

A 5G system defines various operation bands within a frequency range 1 (FR1) from 410 MHz to 7,125 MHz and a frequency range 2 (FR2) from 24,250 MHz to 71,000 MHz. Various frequencies are being discussed as operation bands of the subsequent 6G system, and the use of higher frequencies than the 5G system is under consideration for a broader bandwidth and a higher transmission speed. Among the frequencies, the use of a THz (Terahertz) frequency band is under discussion including a range from about 100 GHz to 10 THz. The THz frequency band is a band with both the penetrability of radio waves and the straightness of light waves, and communication using the THz frequency band is expected to serve as a transitional role from the existing radio wave-centered communication to light wave-based communication.

Thus, a 6G (wireless communication) system using a THz frequency band has purposes such as (i) very high data rate per device, (ii) a very large number of connected devices, (iii) global connectivity, (iv) very low latency, (v) decrease in energy consumption of battery-free IoT devices, (vi) ultra-reliable connectivity, and (vii) connected intelligence with machine learning capacity. The vision of the 6G system may include four aspects such as “intelligent connectivity”, “deep connectivity”, “holographic connectivity” and “ubiquitous connectivity”, and the 6G system may satisfy the requirements shown in Table 1 below.

TABLE 1

| | | |
|---|---|---|
| Per device peak data rate | 1 | Tbps |
| E2E latency | 1 | ms |
| Maximum spectral efficiency | 100 | bps/Hz |

| | |
|---|---|
| Mobility support | Up to 1000 km/hr |
| Satellite integration | Fully |
| AI | Fully |
| Autonomous vehicle | Fully |
| XR | Fully |
| Haptic Communication | Fully |

At this time, the 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion and enhanced data security.

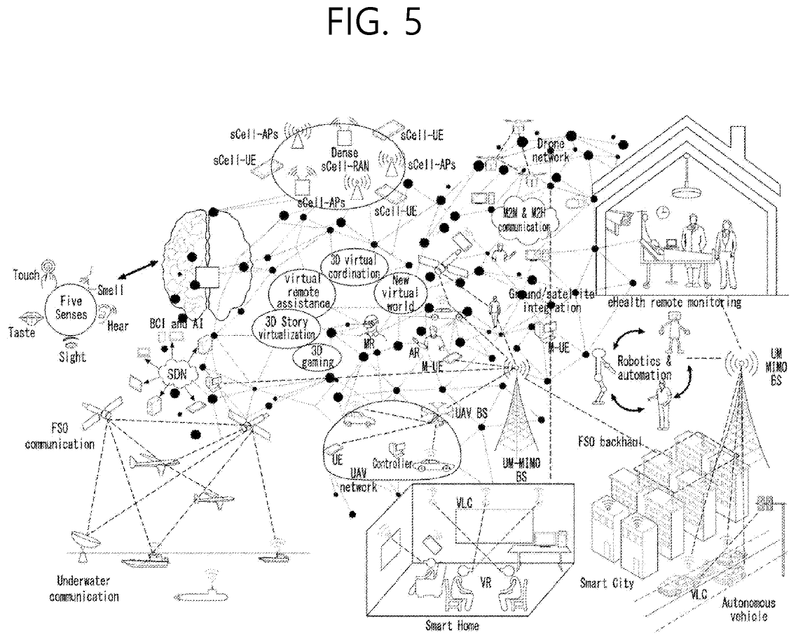

FIG. 5 illustrates an example of a communication structure providable in a 6G system applicable to the present disclosure. Referring to FIG. 5, the 6G system will have 50 times higher simultaneous wireless communication connectivity than a 5G wireless communication system. URLLC, which is the key feature of 5G, will become more important technology by providing end-to-end latency less than 1 ms in 6G communication. At this time, the 6G system may have much better volumetric spectrum efficiency unlike frequently used domain spectrum efficiency. The 6G system may provide advanced battery technology for energy harvesting and very long battery life and thus mobile devices may not need to be separately charged in the 6G system. In addition, in 6G, new network characteristics may be as follows.
Satellites integrated network: To provide a global mobile group, 6G will be integrated with satellite. Integrating terrestrial waves, satellites and public networks as one wireless communication system may be very important for 6G.
Connected intelligence: Unlike the wireless communication systems of previous generations, 6G is innovative and wireless evolution may be updated from “connected things” to “connected intelligence”. AI may be applied in each step (or each signal processing procedure which will be described below) of a communication procedure.
Seamless integration of wireless information and energy transfer: A 6G wireless network may transfer power in order to charge the batteries of devices such as smartphones and sensors. Therefore, wireless information and energy transfer (WIET) will be integrated.
Ubiquitous super 3-dimension connectivity: Access to networks and core network functions of drones and very low earth orbit satellites will establish super 3D connection in 6G ubiquitous.

In the new network characteristics of 6G, several general requirements may be as follows.
Small cell networks: The idea of a small cell network was introduced in order to improve received signal quality as a result of throughput, energy efficiency and spectrum efficiency improvement in a cellular system. As a result, the small cell network is an essential feature for 5G and beyond 5G (5 GB) communication systems. Accordingly, the 6G communication system also employs the characteristics of the small cell network.
Ultra-dense heterogeneous network: Ultra-dense heterogeneous networks will be another important characteristic of the 6G communication system. A multi-tier network composed of heterogeneous networks improves overall QoS and reduce costs.
High-capacity backhaul: Backhaul connection is characterized by a high-capacity backhaul network in order to support high-capacity traffic. A high-speed optical fiber and free space optical (FSO) system may be a possible solution for this problem.
Radar technology integrated with mobile technology: High-precision localization (or location-based service) through communication is one of the functions of the 6G wireless communication system. Accordingly, the radar system will be integrated with the 6G network.
Softwarization and virtualization: Softwarization and virtualization are two important functions which are the bases of a design process in a 5 GB network in order to ensure flexibility, reconfigurability and programmability.

To satisfy the above characteristics, for core implementation technologies of 6G system, artificial intelligence (AI), Terahertz (THz) communication, optical wireless technology, FSO backhaul network, massive MIMO technology, blockchain, 3D networking, quantum communication, unmanned aerial vehicles, cell-free communication, wireless information and energy transfer (WIET), integration of sensing and communication, integration of access and backhaul networks, hologram beamforming, big data analysis, large intelligence surface (LIS) and other technologies may be adopted.

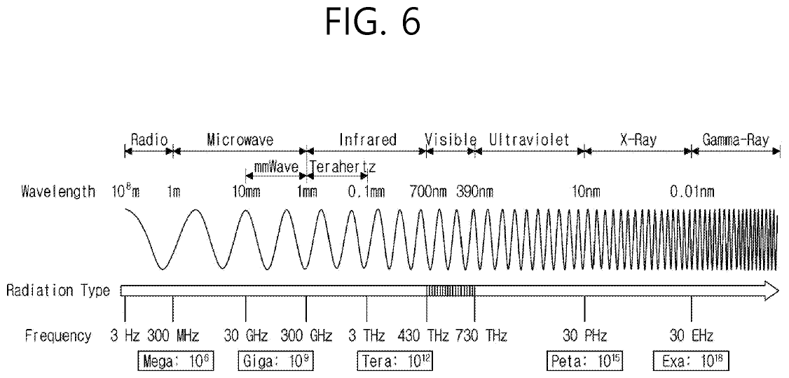

For example, THz communication may be utilized in a 6th Generation (6G) system. THz communication is communication using a spectrum in a frequency band between 0.3 THz and 3 THz having a corresponding wavelength in a range of 0.1 mm to 1 mm as shown in FIG. 6. Referring to FIG. 6, the frequency band of THz waves is located in an intermediate region between an infrared band and a millimeter wave band, and accordingly, the THz wave may be understood as radio waves having the shortest wavelength and at the same time as lightwaves having the longest wavelength. As a result, the THz wave shares some characteristics of infrared and microwaves and, specifically, may have both the penetrability of radio waves and the rectilinearity of lightwaves.

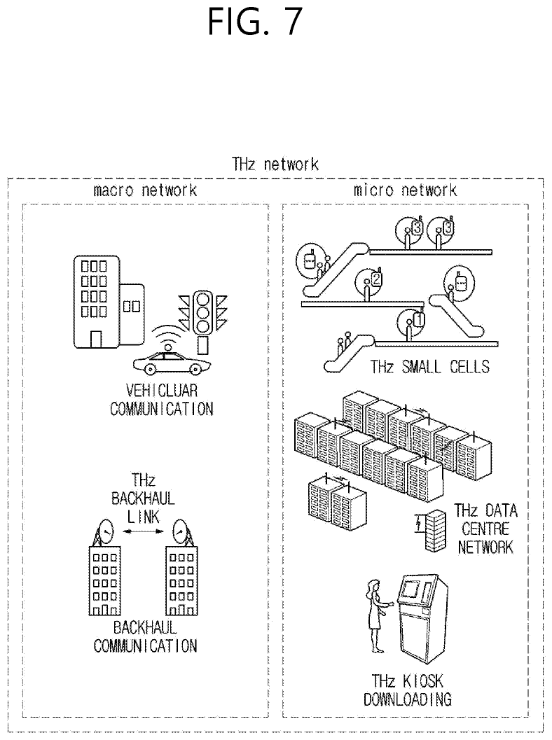

FIG. 7 illustrates a transmitter structure applicable to the present disclosure.

Referring to FIG. 7, in order to modulate data into an optical signal, the optical source of the laser may change the phase of a signal by passing through the optical wave guide. At this time, data is carried by changing electrical characteristics through microwave contact or the like. Thus, the optical modulator output is formed in the form of a modulated waveform.

The data may be provided by a data signal generator. Herein, the data may include various user data, configuration information, control information, etc. transmitted through a channel. Furthermore, the data may include data related to an AI-based operation, for example, information for setting an AI model, input data for a task of the AI model, or output data for a task of the AI model. To this end, a component related to an AI function (e.g., an AI processing unit) may be included in the data signal generator or may interoperate with the data signal generator.

A photoelectric modulator (O/E converter) may generate THz pulses according to optical rectification operation by a nonlinear crystal, photoelectric conversion (O/E conversion) by a photoconductive antenna, and emission from a bunch of relativistic electrons. The terahertz pulse (THz pulse) generated in the above manner may have a length of a unit from femto second to pico second. The photoelectric converter (O/E converter) performs down conversion using non-linearity of the device.

Given THz spectrum usage, multiple contiguous GHz bands are likely to be used as fixed or mobile service usage for the terahertz system. According to the outdoor scenario criteria, available bandwidth may be classified based on oxygen attenuation 10\hat{ }2 dB/km in the spectrum of up to 1 THz. Accordingly, a framework in which the available bandwidth is composed of several band chunks may be considered. As an example of the framework, if the length of the terahertz pulse (THz pulse) for one carrier (carrier) is set to 50 ps, the bandwidth (BW) is about 20 GHz.

Effective down conversion from the infrared band to the terahertz band depends on how to utilize the nonlinearity of the O/E converter. That is, for down-conversion into a desired terahertz band (THz band), design of the photoelectric converter (O/E converter) having the most ideal non-linearity to move to the corresponding terahertz band (THz band) is required. If a photoelectric converter (O/E converter) which is not suitable for a target frequency band is used, there is a high possibility that an error occurs with respect to the amplitude and phase of the corresponding pulse.

In a single carrier system, a terahertz transmission/reception system may be implemented using one photoelectric converter. In a multi-carrier system, as many photoelectric converters as the number of carriers may be required, which may vary depending on the channel environment. Particularly, in the case of a multi-carrier system using multiple broadbands according to the plan related to the above-described spectrum usage, the phenomenon will be prominent. In this regard, a frame structure for the multi-carrier system can be considered. The down-frequency-converted signal based on the photoelectric converter may be transmitted in a specific resource region (e.g., a specific frame). The frequency domain of the specific resource region may include a plurality of chunks. Each chunk may be composed of at least one component carrier (CC).

FIG. 7 illustrates a THz communication method applicable to the present disclosure. Referring to FIG. 7, THz wireless communication uses a THz wave having a frequency of approximately 0.1 to 10 THz (1 THz=1012 Hz), and may mean terahertz (THz) band wireless communication using a very high carrier frequency of 100 GHz or more. The THz wave is located between radio frequency (RF)/millimeter (mm) and infrared bands, and (i) transmits non-metallic/non-polarizable materials better than visible/infrared rays and has a shorter wavelength than the RF/millimeter wave and thus high straightness and is capable of beam convergence.

In addition, the photon energy of the THz wave is only a few meV and thus is harmless to the human body. A frequency band which will be used for THz wireless communication may be a D-band (110 GHz to 170 GHz) or a H-band (220 GHz to 325 GHz) band with low propagation loss due to molecular absorption in air. Standardization discussion on THz wireless communication is being discussed mainly in IEEE 802.15 THz working group (WG), in addition to 3GPP, and standard documents issued by a task group (TG) of IEEE 802.15 (e.g., TG3d, TG3e) specify and supplement the description of this disclosure. The THz wireless communication may be applied to wireless cognition, sensing, imaging, wireless communication, and THz navigation.

Specifically, referring to FIG. 7, a THz wireless communication scenario may be classified into a macro network, a micro network, and a nanoscale network. In the macro network, THz wireless communication may be applied to vehicle-to-vehicle (V2V) connection and backhaul/fronthaul connection. In the micro network, THz wireless communication may be applied to near-field communication such as indoor small cells, fixed point-to-point or multi-point connection such as wireless connection in a data center or kiosk downloading. Table 2 below shows an example of technology which may be used in the THz wave.

TABLE 2

| | |
|---|---|
| Transceivers Device | Available immature: UTC-PD, RTD and SBD |
| Modulation | Low order modulation techniques (OOK, QPSK), |
| and coding | LDPC, Reed Soloman, Hamming, Polar, Turbo |
| Antenna | Omni and Directional, phased array with low |
| | number of antenna elements |
| Bandwidth | 69 GHz (or 23 GHz) at 300 GHz |
| Channel models | Partially |
| Data rate | 100 Gbps |
| Outdoor deployment | No |
| Fee space loss | High |
| Coverage | Low |
| Radio Measurements | 300 GHz inddor |
| Device size | Few micrometers |

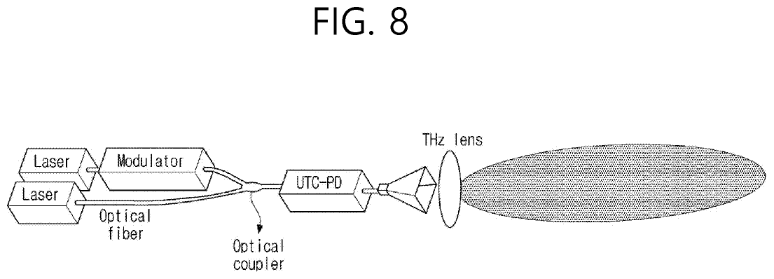

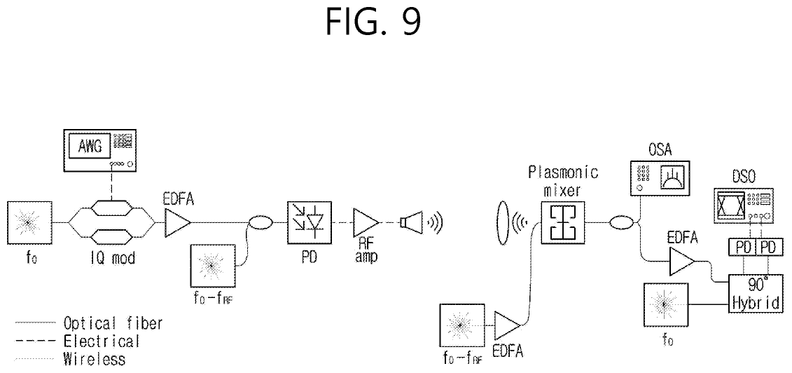

FIG. 8 illustrates a THz signal generation method applicable to the present disclosure. FIG. 9 illustrates a wireless communication transceiver applicable to the present disclosure. Referring to FIGS. 8 and 9, the optical device-based THz wireless communication technology means a method of generating and modulating a THz signal using an optical device. The optical device-based THz signal generation technology refers to a technology that generates an ultrahigh-speed optical signal using a laser and an optical modulator, and converts it into a THz signal using an ultrahigh-speed photodetector. This technology is easy to increase the frequency compared to the technology using only the electronic device, can generate a high-power signal, and can obtain a flat response characteristic in a wide frequency band. In order to generate the THz signal based on the optical device, as shown in FIG. 8, a laser diode, a broadband optical modulator, and an ultrahigh-speed photodetector are required. In the case of FIG. 8, the light signals of two lasers having different wavelengths are combined to generate a THz signal corresponding to a wavelength difference between the lasers. In FIG. 8, an optical coupler refers to a semiconductor device that transmits an electrical signal using light waves to provide coupling with electrical isolation between circuits or systems, and a uni-travelling carrier photo-detector (UTC-PD) is one of photodetectors, which uses electrons as an active carrier and reduces the travel time of electrons by bandgap grading. The UTC-PD is capable of photodetection at 150 GHz or more. In FIG. 9, an erbium-doped fiber amplifier (EDFA) represents an optical fiber amplifier to which erbium is added, a photo detector (PD) represents a semiconductor device capable of converting an optical signal into an electrical signal, and OSA represents an optical sub assembly in which various optical communication functions (e.g., photoelectric conversion, electrophotic conversion, etc.) are modularized as one component, and DSO represents a digital storage oscilloscope.

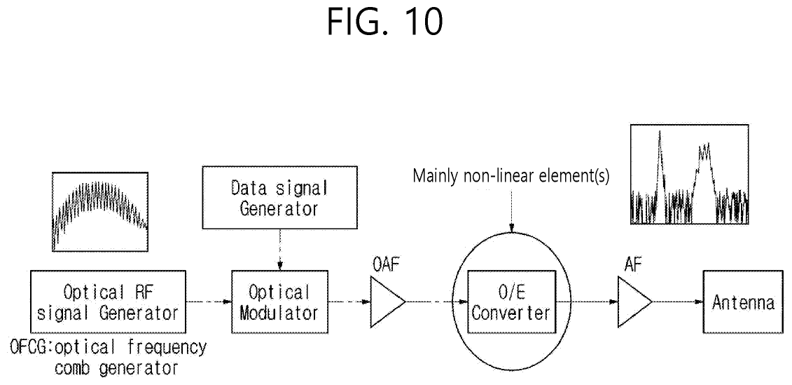

FIG. 10 illustrates a transmitter structure applicable to the present disclosure. Referring to FIG. 10, generally, the optical source of the laser may change the phase of a signal by passing through the optical wave guide. At this time, data is carried by changing electrical characteristics through microwave contact or the like. Thus, the optical modulator output is formed in the form of a modulated waveform. A photoelectric modulator (O/E converter) may generate THz pulses according to optical rectification operation by a nonlinear crystal, photoelectric conversion (O/E conversion) by a photoconductive antenna, and emission from a bunch of relativistic electrons. The terahertz pulse (THz pulse) generated in the above manner may have a length of a unit from femto second to pico second. The photoelectric converter (O/E converter) performs down conversion using non-linearity of the device.

Given THz spectrum usage, multiple contiguous GHz bands are likely to be used as fixed or mobile service usage for the terahertz system. According to the outdoor scenario criteria, available bandwidth may be classified based on oxygen attenuation 10\hat{ }2 dB/km in the spectrum of up to 1 THz. Accordingly, a framework in which the available bandwidth is composed of several band chunks may be considered. As an example of the framework, if the length of the terahertz pulse (THz pulse) for one carrier (carrier) is set to 50 ps, the bandwidth (BW) is about 20 GHz.

Effective down conversion from the infrared band to the terahertz band depends on how to utilize the nonlinearity of the O/E converter. That is, for down-conversion into a desired terahertz band (THz band), design of the photoelectric converter (O/E converter) having the most ideal non-linearity to move to the corresponding terahertz band (THz band) is required. If a photoelectric converter (O/E converter) which is not suitable for a target frequency band is used, there is a high possibility that an error occurs with respect to the amplitude and phase of the corresponding pulse.

In a single carrier system, a terahertz transmission/reception system may be implemented using one photoelectric converter. In a multi-carrier system, as many photoelectric converters as the number of carriers may be required, which may vary depending on the channel environment. Particularly, in the case of a multi-carrier system using multiple broadbands according to the plan related to the above-described spectrum usage, the phenomenon will be prominent. In this regard, a frame structure for the multi-carrier system can be considered. The down-frequency-converted signal based on the photoelectric converter may be transmitted in a specific resource region (e.g., a specific frame). The frequency domain of the specific resource region may include a plurality of chunks. Each chunk may be composed of at least one component carrier (CC).

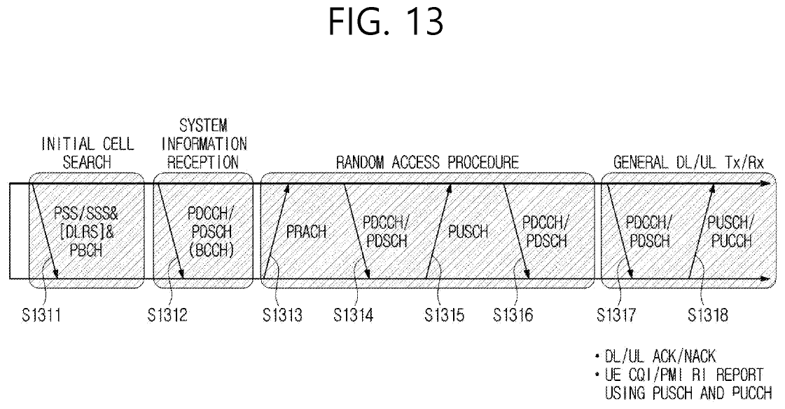

Transmitting system information (e.g., MIB) in a THz frequency band may be inefficient because, in a high frequency band, beam sweeping has to be performed more frequently in order to cover all areas of the cell as a beam width becomes narrower. In particular, when there are not many users in the cell, transmitting system information through such a method is more inefficient. Accordingly, a system information transmission procedure such as FIG. 13 described below may be used.

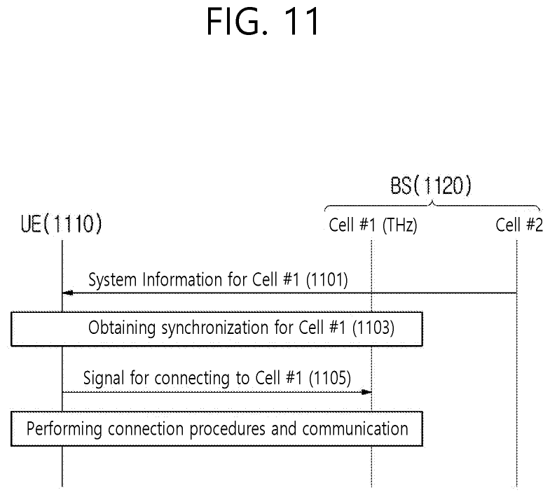

FIG. 11 illustrates a system information transmission procedure applicable to the present disclosure. FIG. 13 illustrates an example of a procedure for transmitting system information for Terahertz (THz) communication. The procedure exemplified in FIG. 13 may be combined with various embodiments of the present disclosure described below. For example, embodiments described below may be performed based on system information obtained by the procedure exemplified in FIG. 11. As another example, information and/or data transmitted in the procedure exemplified in FIG. 11 may be generated and/or processed according to embodiments described below.

Referring to FIG. 11, in step 1101, the base station 1120 transmits system information of the cell #1 through the cell #2. That is, the base station 1120 provides at least two cells, the cell #1 uses a THz frequency band, and the cell #2 uses a frequency band other than the THz frequency band. Herein, the system information includes at least one of SFN, PDCCH configuration for SIB1, cell barring, cell re-selection, subcarrier spacing generated in a higher layer, and may include at least one of SFN, half frame indicator, SSB index generated in a physical layer. To this end, in an example, the cell #1 and the cell #2 may have a relationship of a secondary cell and a primary cell.

In step 1103, the UE 1110 obtains synchronization for the cell #1. The synchronization may be obtained by detecting a synchronization signal. Generally, synchronization is obtained before receiving system information, but since system information of the cell #1 is received from the cell #2, the synchronization for the cell #1 may be obtained after receiving the system information. In an example, the UE 1110 may obtain synchronization based on the system information. However, different from FIG. 11, the synchronization may be obtained before step 1101.

In step 1105, the UE 1110 transmits a signal for accessing the cell #1. For example, the signal may include a random access preamble. A structure of the signal and a resource (e.g., a channel) for transmitting the signal may be identified through system information. Thereafter, in step 1107, the UE 1110 and the base station 1120 perform an access procedure for the cell #1 and perform communication. In this step, operations according to various embodiments described below may be performed.

The procedure described with reference to FIG. 11 may be performed when the UE 1101 initially accesses the cell #1 of the base station 1120. Alternatively, a similar procedure may be performed when the UE 1101 hands over to the cell #1 of the base station 1120. However, in case of handover, system information of the cell #1 may be received from a cell of another base station, not from the cell #2 of the base station 1120.

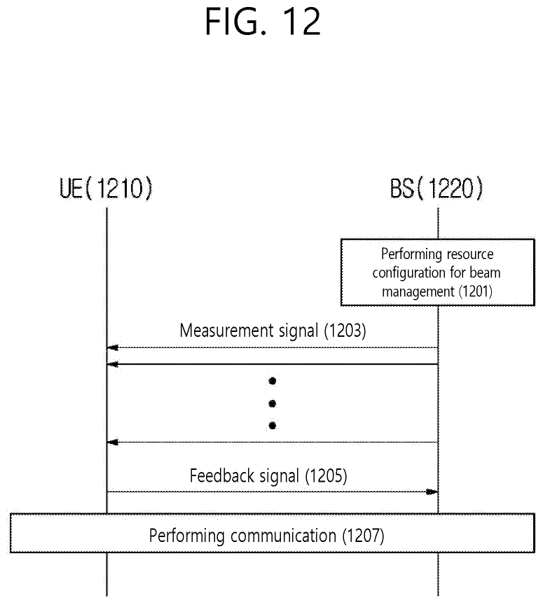

Extreme pathloss is expected in communication in the terahertz (THz) band, and in order to overcome this, a terminal and a base station should use a very sharp beam. The use of the sharp beam means that the terminal and the base station must perform beam control along with beamforming, and the number of beams used is very large. Therefore, it takes a very long time to align transmission/reception beams between the base station and the terminal. In addition, when the beam alignment between the base station and the terminal is distorted due to movement or movement of the terminal, time for re-aligning the beam is frequently required, which may cause a link to become unstable. Accordingly, a beam management procedure such as that shown in FIG. 12 below may be used.

FIG. 12 illustrates a beam management procedure applicable to the present disclosure. FIG. 12 illustrates an example of a procedure for searching and/or selecting beams for THz communication. The procedure exemplified in FIG. 12 may be combined with various embodiments of the present disclosure described below. For example, embodiments described below may be performed by using at least one beam obtained by the procedure exemplified in FIG. 11. As another example, information and/or data transmitted in the procedure exemplified in FIG. 12 may be generated and/or processed according to embodiments described below. Herein, the beam may be referred to as a ‘spatial domain filter,’ a ‘spatial domain transmission filter,’ a ‘spatial domain reception filter,’ and another term having an equivalent technical meaning.

Referring to FIG. 12, in step 1201, the base station 1220 configures a resource for beam management. Herein, the resource may include at least one of a time-frequency resource, a channel, a spatial resource (e.g., an antenna port). For example, the base station 1220 may utilize a beam search signal (BSS) transmitted spatially separated from an existing downlink signal/channel for beam search. Herein, the BSS may be transmitted based on a dedicated port for beam search. The dedicated port may be a different port from a port for transmission of an existing downlink signal/channel (e.g., SSB, PDSCH). The BSS is a term defined for convenience of description, and the technical idea according to this embodiment is not limited to the term BSS itself. That is, a signal transmitted based on a dedicated port defined/configured for beam search may be included in the technical idea according to this embodiment.

In step 1203, the base station 1201 transmits measurement signals by using a plurality of transmission beams. For example, the measurement signals may include at least one of a reference signal, a synchronization signal. At this time, the measurement signals may be transmitted as many as the number of beams requiring measurement, and may be transmitted in a multi-beam transmission method in which a plurality of beams are simultaneously formed to reduce a sweeping time. Herein, the multi-beam transmission may be performed based on at least one of a multi-panel, a sub-array, a true time delay (TTD).

In step 1205, the UE 1210 transmits a feedback signal to the base station 1220. The feedback signal indicates at least one beam selected by the UE 1210. The UE 1210 may select at least one preferred beam based on the measurement signals received in step 1203. In step 1207, the UE 1210 and the base station 1220 perform communication. At this time, the UE 1210 may perform communication with the base station 1220 by using the beam selected in step 1205. In case channel reciprocity is established, a transmission beam of the UE 1210 may also be determined through step 1203 and step 1205, so that a transmission operation of the UE 1210 may also be performed by using the beam selected in step 1205. In case channel reciprocity is not established, in order to determine a transmission beam of the UE 1210, a procedure including transmission of measurement signals by the UE 1210 and transmission of a feedback signal by the base station 1220 may be performed in advance. In step 1207, operations according to various embodiments described below may be performed.

FIG. 13 illustrates physical channels applicable to the present disclosure and a signal transmission method using the same.

The UE which is turned on again in a state of being turned off or has newly entered a cell performs initial cell search operation in step S1311 such as acquisition of synchronization with a base station. Specifically, the UE performs synchronization with the base station, by receiving a Primary Synchronization Channel (P-SCH) and a Secondary Synchronization Channel (S-SCH) from the base station, and acquires information such as a cell Identifier (ID).

Thereafter, the UE may receive a physical broadcast channel (PBCH) signal from the base station and acquire intra-cell broadcast information. Meanwhile, the UE may receive a downlink reference signal (DL RS) in an initial cell search step and check a downlink channel state. The UE which has completed initial cell search may receive a physical downlink control channel (PDCCH) and a physical downlink control channel (PDSCH) according to physical downlink control channel information in step S1312, thereby acquiring more detailed system information.

Thereafter, the UE may perform a random access procedure such as steps S1313 to S1316 in order to complete access to the base station. To this end, the UE may transmit a preamble through a physical random access channel (PRACH) (S1313) and receive a random access response (RAR) to the preamble through a physical downlink control channel and a physical downlink shared channel corresponding thereto (S1314). The UE may transmit a physical uplink shared channel (PUSCH) using scheduling information in the RAR (S1315) and perform a contention resolution procedure such as reception of a physical downlink control channel signal and a physical downlink shared channel signal corresponding thereto (S1316).

The UE, which has performed the above-described procedures, may perform reception of a physical downlink control channel signal and/or a physical downlink shared channel signal (S1317) and transmission of a physical uplink shared channel (PUSCH) signal and/or a physical uplink control channel (PUCCH) signal (S1318) as general uplink/downlink signal transmission procedures.

The control information transmitted from the UE to the base station is collectively referred to as uplink control information (UCI). The UCI includes hybrid automatic repeat and request acknowledgement/negative-ACK (HARQ-ACK/NACK), scheduling request (SR), channel quality indication (CQI), precoding matrix indication (PMI), rank indication (RI), beam indication (BI) information, etc. At this time, the UCI is generally periodically transmitted through a PUCCH, but may be transmitted through a PUSCH in some embodiments (e.g., when control information and traffic data are simultaneously transmitted). In addition, the UE may aperiodically transmit UCI through a PUSCH according to a request/instruction of a network.

### Downlink Channel Structure

The base station may transmit a related signal to The UE via a downlink channel to be described later, and the UE may receive the related signal from the base station via the downlink channel to be described later.

The Physical Downlink Shared Channel (PDSCH) may carry downlink data (e.g., DL-shared channel transport block, DL-SCH TB) and may be applied with a modulation method such as quadrature phase shift keying (QPSK), 16 quadrature amplitude modulation (QAM), 64 QAM, and 256 QAM. A codeword is generated by encoding TB. The PDSCH may carry multiple codewords. Scrambling and modulation mapping are performed for each codeword, and modulation symbols generated from each codeword are mapped to one or more layers. Each layer is mapped to a resource together with a demodulation reference signal (DMRS) to generate an OFDM symbol signal, and is transmitted through a corresponding antenna port.

The Physical Downlink Control Channel (PDCCH) carries downlink control information (DCI) and is applied with a QPSK modulation method, etc. One PDCCH consists of 1, 2, 4, 8, or 16 control channel elements (CCEs) based on an aggregation level (AL). One CCE consists of 6 resource element groups (REGs). One REG is defined by one OFDM symbol and one (P) RB.

The UE performs decoding (aka, blind decoding) on a set of PDCCH candidates to acquire DCI transmitted via the PDCCH. The set of PDCCH candidates decoded by the UE is defined as a PDCCH search space set. The search space set may be a common search space or a UE-specific search space. The UE may acquire DCI by monitoring PDCCH candidates in one or more search space sets configured by MIB or higher layer signaling.

### Uplink Channel Structure

The UE may transmit a related signal to the base station via an uplink channel to be described later, and the base station may receive the related signal from the UE via the uplink channel to be described later.

The Physical Uplink Shared Channel (PUSCH) carries uplink data (e.g., UL-shared channel transport block, UL-SCH TB) and/or uplink control information (UCI) and is transmitted based on a CP-OFDM (Cyclic Prefix-Orthogonal Frequency Division Multiplexing) waveform, DFT-s-OFDM (Discrete Fourier Transform-spread-Orthogonal Frequency Division Multiplexing) waveform, or the like. When the PUSCH is transmitted based on the DFT-s-OFDM waveform, the UE transmits the PUSCH by applying a transform precoding. For example, if the transform precoding is not possible (e.g., transform precoding is disabled), the UE may transmit the PUSCH based on the CP-OFDM waveform, and if the transform precoding is possible (e.g., transform precoding is enabled), the UE may transmit the PUSCH based on the CP-OFDM waveform or the DFT-s-OFDM waveform. The PUSCH transmission may be dynamically scheduled by an UL grant within DCI, or may be semi-statically scheduled based on high layer (e.g., RRC) signaling (and/or layer 1 (L1) signaling (e.g., PDCCH)) (configured grant). The PUSCH transmission may be performed based on a codebook or a non-codebook.

The Physical Uplink Control Channel (PUCCH) may carry uplink control information, HARQ-ACK, and/or scheduling request (SR), and may be divided into multiple PUCCHs based on a PUCCH transmission length.

### SPECIFIC EMBODIMENT OF THE PRESENT DISCLOSURE

The present disclosure may be applied to a procedure for transmitting a synchronization signal by using a reconfigurable intelligent surface (RIS). Specifically, the present disclosure has a purpose of improving transmission efficiency of a signal through a reflective surface having a specific reflection characteristic by using a reconfigurable intelligent surface (RIS), and efficiently performing transmission of a synchronization signal. To this end, the present disclosure proposes a scheme for performing an initial access procedure by using a synchronization signal, and controlling passive elements of the RIS based on the initial access procedure. A frame structure in which synchronization signals multiplexed in a frequency domain are arranged may be provided to transmit a plurality of synchronization signals within a specific time interval. First, various components related to a wireless communication environment using the RIS will be described below.

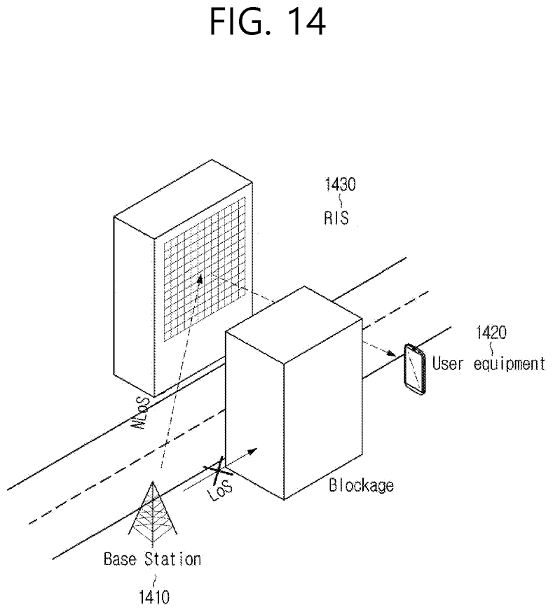

FIG. 14 illustrates an example of a communication scenario using a reconfigurable intelligent surface (RIS) according to an embodiment of the present disclosure.

In sixth generation (6G) mobile communication requiring high spectral efficiency, the use of an ultra high frequency band is essential, and RIS is attracting attention as a core candidate technology to compensate for low penetration and coverage caused thereby. RIS, which may artificially reconfigure a radio wave environment, may obtain high system gain and coverage at low cost.

Herein, RIS may be expressed by other various terms, such as intelligent reflecting surface (IRS), intelligent reflecting surface, intelligent surface, and is not limited to a specific name.

The RIS 1430, as shown in FIG. 14, improves communication performance by securing a non-line of sight (NLoS) path when a line of sight path between a base station (BS) 1410 and user equipment (UE) 1420 is blocked. The RIS 1430 converts an incident radio wave into a specific reflected wave or refracted wave, and at this time, a surface of the RIS 1430 is configured by appropriately arranging unit cells consisting of reconfigurable elements. The RIS 1430 dynamically controls amplitude, phase, polarization, etc. of the radio wave by enabling the unit cells configuring the surface to be independently programmable, and generally controls the unit cells through an IC-based element. This element may be implemented through a transistor-based IC chip such as a varactor diode or a PIN diode. An impedance of this element is determined according to an applied bias voltage, and an effective permittivity and a reflection coefficient vary as parameters according thereto. Through this, an additional phase shift may be given in a reflection process, which may change a boundary condition to create an arbitrary desired reflection angle.

In a study on RIS design, there is a case of verifying performance including designing an RIS surface operating in a 28 GHz band, calculating and optimizing a phase distribution for beamforming of each unit cell according to a distance between a transmitter (Tx) and the RIS surface, and verifying the performance. 400 unit cells were used, each unit cell was spaced at a half wavelength, and 800 diodes were used to vary a reflection phase of the unit cells. The performance was verified in beam steering at 0 degrees, 30 degrees, 45 degrees, 60 degrees, and two horn antennas having a gain of 17 dB were used as Tx and Rx antennas to perform performance measurement. Generally, it was confirmed that the use of the RIS provided a signal strength improvement effect of about 25 dB compared to a metal surface which may serve as a reflector, and detailed performance indicators of the RIS are shown in Table 3 below.

TABLE 3

| Aperture size | 10 cm × 10 cm | |
|---|---|---|
| Number of elements | 400 | |
| Polarization | Dual linear | |
| Element's spacing | λ/2 | |
| Operating frequency rang | [27.5 Ghz, 29.5 Ghz] | |
| Instantaneous bandwidth | 500 | MHz |
| Directivity | 22.5 | dBi |
| Scan range (El., Az.) | ±60° | |
| Switching rate | 100 | kHz |

FIG. 15 illustrates an example of using RIS in a penetration environment in which radio waves from an outdoor base station penetrate into indoor according to an embodiment of the present disclosure. As another usage of the RIS 1530, a method of extending indoor coverage by improving penetration characteristics when delivering a base station signal incoming from outside into a building, as shown in FIG. 15, is being considered. That is, studies on improving indoor communication coverage by utilizing the RIS 1530 are being conducted, and a method of improving indoor coverage by using a transparent RIS 1530 surface operating in a 28 GHz band is also being studied.

In case the RIS 1530 is used as a transmission surface, an optimization process of appropriately varying a phase distribution of each unit cell of the RIS 1530 surface to focus a beam in a desired direction is required. A method of optimizing the phase distribution of unit cells of a transmit array by considering beam steering angles of 0 degrees, 15 degrees, 30 degrees, 45 degrees may also be considered. In an example, by using an optimization algorithm, a range of phase variation required in a beamforming scenario may be minimized from 59 degrees ~112 degrees to 46 degrees ~80 degrees, which may be effectively used for improving communication performance in case of performing beam tracking by varying a beam in real time in an actual communication environment.

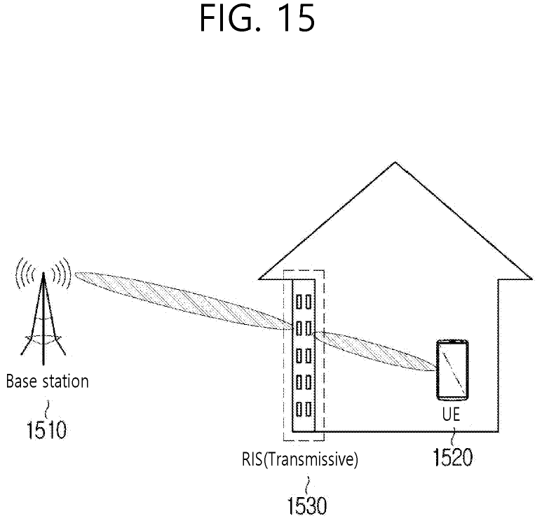

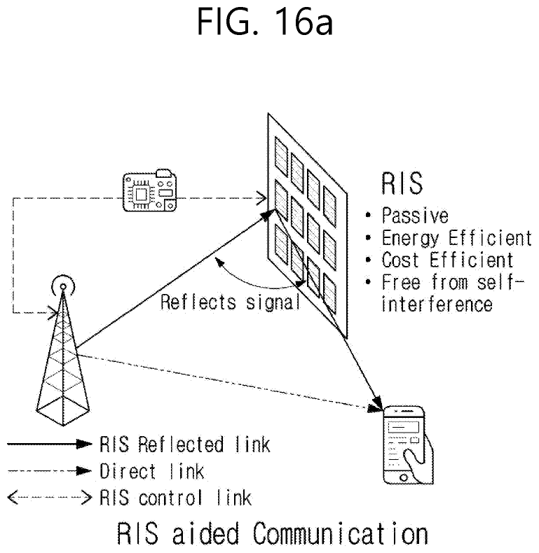

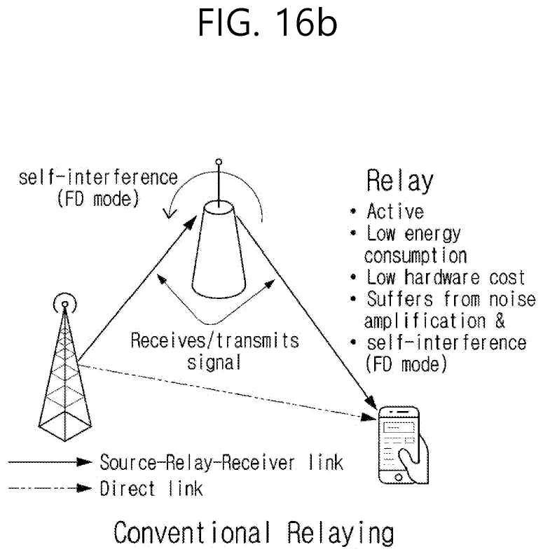

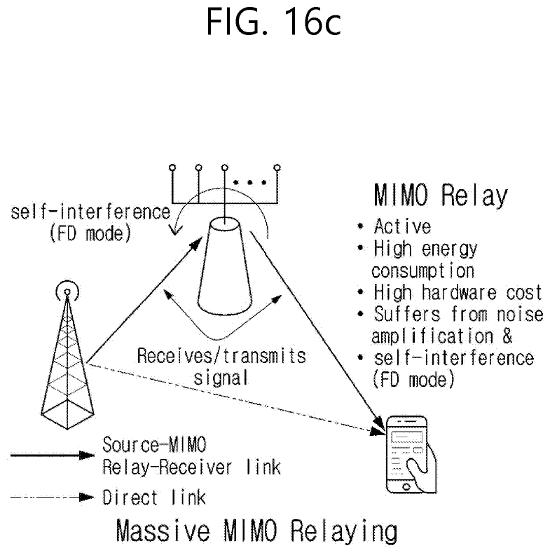

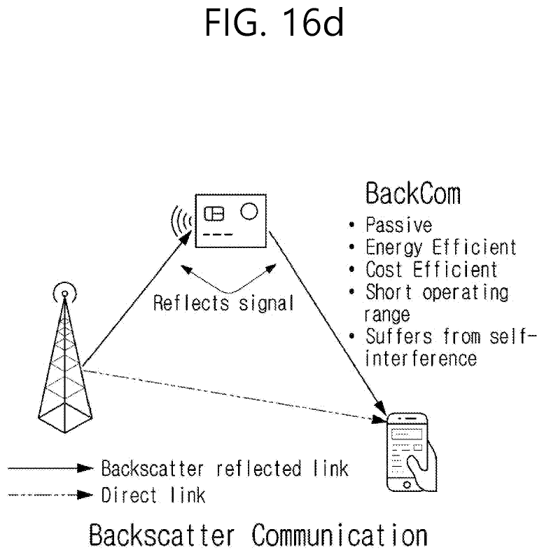

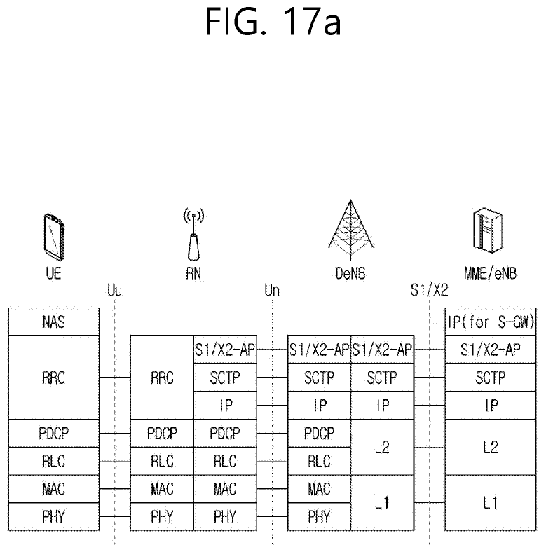

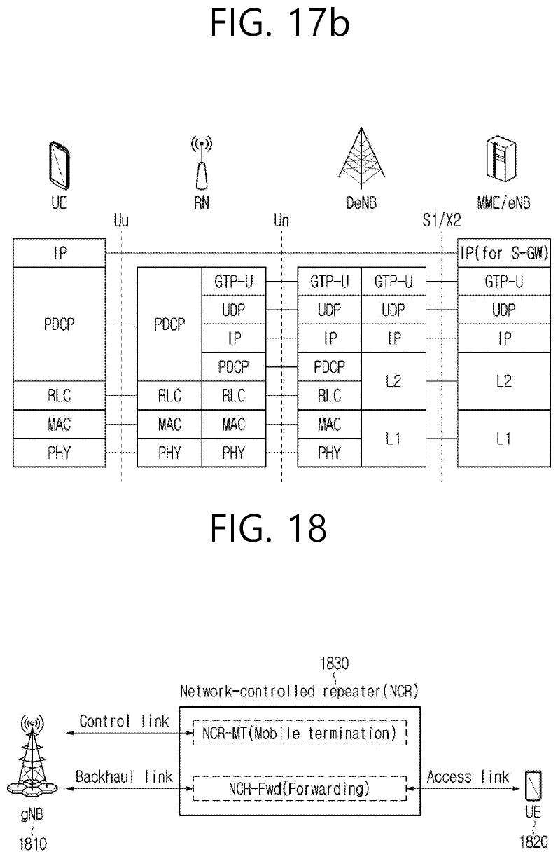

FIGS. 16a to 16d illustrate examples of RIS configuration environments according to an embodiment of the present disclosure. As shown in FIGS. 16a to 16d, studies on deployment of existing relay network nodes (e.g., integrated access and backhaul (IAB) of 3GPP) are being conducted. A basic structure of such an IAB is that a link exists between a base station and a relay, and the relay has a wireless backhaul connected to a network. A subject of signaling is the base station, and the relay is configured to be instructed by the base station. Accordingly, when data are transmitted to the relay, the relay amplifies a strength of the data or re-decodes and re-encodes the data according to transmission instruction of the base station, and transmits the data to a terminal finally instructed. Therefore, the relay network node has a network layer structure similar to the base station, which may be inefficient in terms of infrastructure cost for increasing coverage. The relay network layer structure may be represented by FIGS. 17a and 17b.

On the other hand, recently, studies on an RF repeater have been actively conducted through Rel. 17. Generally, the RF repeater refers to a node of an amplify-and-forward type. That is, the RF repeater may be considered a node in a passive form in terms of RF, simply forwarding data. When improving coverage, it is efficient in terms of cost and is a type of node free from self-interference. Accordingly, studies may be conducted on an RF repeater node having a structure of receiving instruction from a network to receive various control signals in order to increase network coverage. In particular, a network-controlled repeater (NCR) may be controlled by receiving side control information from the network, and has advantages such as noise amplification, spatial directivity between a base station and a terminal, and simplification of the network. In terms of a network layer structure, the NCR and the RIS node may be regarded as almost similar.

FIG. 18 illustrates an example of link modeling related to a network-controlled repeater (NCR) according to an embodiment of the present disclosure. An NCR-MT is a function entity capable of exchanging control information through a control link (C-link) between a base station 1810 and an NCR 1830, and the control link operates based on an NR-Uu interface. That is, the base station 1810 considers the NCR 1830 also as a terminal 1820. An NCR-fwd means a function entity performing a role of amplifying and forwarding UL/DL RF signals based on side control information received by the NCR 1830. A backhaul link means a link between the base station 1810 and the NCR 1830 for transmission from the base station 1810 to the terminal 1820, and an access link means a link between the NCR 1830 and the terminal 1820 for transmission of data received from the NCR 1830 to the terminal 1820. As a basic NCR 1830 link structure, the control link and the backhaul link have similar type-A and type-D channel characteristics (see QCL). Herein, the side control information may include information as follows.

### 1) Beam Information

In case of a backhaul link and a control link, both fixed beams and adaptive beams may be considered in the NCR, wherein the fixed beam means a case in which the beam cannot be changed in the NCR for both a C-link and a backhaul link. Beam correspondence may be assumed to be applied not only to DL/UL of the backhaul link in the NCR-Fwd but also to DL/UL of the C-link in the NCR-MT.

Basically, in case carriers of the NCR-MT operate in a frequency band delivered by the NCR-Fwd, for the backhaul link, the same TCI state as the C-link is assumed for a beam in the NCR-Fwd. When adaptive beams are adopted for the C-link and the backhaul link, indication and determination of a beam of the backhaul link may be performed as follows.
Option 1: A beam of the backhaul link may be indicated by new signaling. The new signaling may be performed as dynamic signaling and/or semi-static signaling (e.g., RRC signaling/MAC CE) indicating a beam(s) from a set of beams of the C-link. However, it is not limited to that the beam of the backhaul link is always indicated by the new signaling.
Option 2: A beam of the backhaul link may be determined by a predefined rule. For example, in a slot/symbol having simultaneous DL reception/UL transmission in both the C-link and the backhaul link, the beam of the backhaul link is the same as the beam of the C-link. Otherwise, the beam of the backhaul link follows one of the beams of the C-link. Herein, other predefined rules are not excluded.

For at least the access link, and for at least FR2, beam information is useful and is recommended as side control information for the NCR to control operation of the access link.

With respect to access link beam indication, a beam of the access link for the NCR-Fwd is indicated by a beam index in which both dynamic indication and semi-persistent indication including semi-static indication are considered.

A time domain resource corresponding to an access link beam is explicitly determined based on a time domain resource explicitly indicated per beam indicator. A single beam indicator may indicate one or a plurality of beams. Different parameters may be indicated for a semi-static or dynamic beam indicator.

Beam correspondence is assumed for DL/UL of the access link in the NCR-Fwd. That is, the DL beam and the UL beam of the access side that correspond to each other have the same beam index. A forwarding direction of a beam indicated in the access link may be determined based on a corresponding time domain resource and UL/DL TDD configuration. Forwarding operation (or forwarding direction) of a beam indicated in the access link within variable symbols may be separately discussed.

### 2) Timing Information

In case of NCR timing, the following assumptions may be considered.
A DL reception timing of the NCR-Fwd coincides with a DL reception timing of the NCR-MT.
A UL transmission timing of the NCR-Fwd coincides with a UL transmission timing of the NCR-MT.
A DL transmission timing of the NCR-Fwd is delayed after a DL reception timing of the NCR-MT (or the NCR-Fwd) due to internal delay.

A UL reception timing of the NCR-Fwd is advanced before a UL transmission timing of the NCR-MT (or the NCR-Fwd) due to internal delay.

An existing terminal mechanism is sufficient to achieve DL/UL timing for the NCR-MT.

### 3) Information on UL-DL Configuration

In case of a TDD UL/DL configuration of the NCR, at least a semi-static TDD UL/DL configuration is required for the NCR including a C-link, a backhaul link, and an access link. In flexible symbols (e.g., TDD-UL-DL-ConfigCommon, TDD-UL-DL-ConfigDedicated) based on the semi-static configuration, the following operations of the NCR-Fwd may be considered.
Option 1: The NCR-Fwd is off or is expected not to forward through such symbols.
Option 2: The NCR-Fwd follows a TDD operation determined by the NCR-MT. That is, the TDD operation is determined by the NCR-MT based on an SFI indication or scheduling received from the base station. This means that no new side control signaling is required.
Option 3: The NCR-Fwd follows new active side control signaling for DL/UL forwarding through such symbols.

For the backhaul link and the access link, the same TDD UL/DL configuration is always assumed. In case the NCR-MT and the NCR-Fwd operate in the same frequency band, the same TDD UL/DL configuration is assumed also for the C-link, the backhaul link, and the access link.

### 4) On-Off Information

On-off information is useful for the NCR to control operation of the NCR-Fwd. The NCR-Fwd always expects “OFF” unless otherwise explicitly or implicitly indicated by the base station. This is applied regardless of an RRC state of the NCR-MT. This is applied regardless of a DRX state of the NCR-MT for controlling on-off operation of the NCR-Fwd when the NCR-MT is in an RRC-idle/inactive state.

In order to indicate on-off information from the base station to the NCR for controlling operation of the NCR-Fwd, the following options may be considered.
Option 1: Explicit indication of an on-off state (e.g., through dynamic signaling or semi-static signaling) or an on-off pattern (e.g., periodic/semi-static on-off pattern or a new DRX-like pattern for on-off).
Option 2: Implicit indication through signaling of other side control information (e.g., beam, DL/UL configuration, or PC information). This example does not indicate whether PC information is required.

Other solutions (e.g., a potential combination of explicit and implicit solutions) may be further discussed in a normative stage.

RRC and MAC CE parameters may be defined as shown in Table 4 to Table 6.

For periodic beam indication, parameters as shown in Table 4 may be defined.

TABLE 4

| Parameter name | Field descriptions | Value range |
|---|---|---|
| ncr- | List of periodic forwarding | SEQUENCE |
| PeriodicFwdResource | resource sets to add and/or | (SIZE(1..maxNrofPeriodicFwd |
| SetToAddModList | modify. | ResourceSet)) OF NCR- |
| | | PeriodicFwdResourceSet |
| | | maxNrofPeriodicFwdResource |
| | | Set-SIZE(ncr-periodicity) |
| ncr- | List of periodic forwarding | SEQUENCE |
| PeriodicFwdResource | resource sets to remove. | (SIZE(1..maxNrofPeriodicFwd |
| SetToRemoveList | | ResourceSet)) OF NCR- |
| | | PeriodicFwdResourceSetId |
| NCR- | Each periodic forwarding | SEQUENCE{ncr- |
| PeriodicFwdResource | resource set includes a list of | PeriodicFwdResourceSetId, |
| Set | periodic forwarding resource, a | ncr- |
| | common periodicity and a | PeriodicFwdResourceToAdd |
| | common reference SCS. | ModList, ncr- |
| | | PeriodicFwdResourceToRemove |
| | | List, ncr-periodicity, ncr- |
| | | referenceSCS} |
| ncr- | Periodic forwarding resource | INTEGER |
| PeriodicFwdResource | set ID. | (0..maxNrofPeriodicFwdResourceSet- |
| SetId | | 1) |
| ncr- | List of periodic forwarding | SEQUENCE |
| PeriodicFwdResource | resources to add and/or modify. | (SIZE(1..maxNrofPeriodicFwd |
| ToAddModList | | Resource)) OF NCR- |
| | | PeriodicFwdResource |
| | | FFS: |
| | | maxNrofPeriodicFwdResource |
| ncr- | List of periodic forwarding | SEQUENCE |
| PeriodicFwdResource | resources to remove. | (SIZE(1..maxNrofPeriodicFwd |
| ToRemoveList | | Resource)) OF NCR- |
| | | PeriodicFwdResourceId |
| ncr-periodicity | Indicates the periodicity for the | ENUMERATED {sl1, sl2, |
| | list of forwarding resource in | sl4, sl5, sl8, sl10, sl16, sl20, |
| | slot. | sl32, sl40, sl64, sl80, sl128, |
| | | sl160, sl256, sl320, sl512, |
| | | sl640, sl1024, sl1280, sl2560, |
| | | sl5120, sl10240} |
| ncr-referenceSCS | Indicates the reference | SubcarrierSpacing |
| | subcarrier spacing for all the | |
| | time resource in the list | |
| NCR- | A periodic forwarding resource. | SEQUENCE{ncr- |
| PeriodicFwdResource | | PeriodicFwdResourceId, ncr- |
| | | beam Index, ncr- |
| | | PeriodicTimeResource} |
| ncr- | Periodic forwarding resource | INTEGER |
| PeriodicFwdResourceId | ID. | (0..maxNrofPeriodicFwdResource- |
| | | 1) |
| ncr-beamIndex | Indicates logical beam index | INTEGER(0..127) |
| | for NCR access link. NCR is | |
| | assumed to be ON over the | |
| | indicated time domain resource | |
| | if there is beam indication. | |
| ncr- | Indicates the time resource for | SEQUENCE{slotOffsetPeriodic, |
| PeriodicTimeResource | periodic beam indication. NCR | symbolOffset, |
| | is assumed to be ON over the | durationInSymbols} |
| | indicated time domain resource | |
| | if there is beam indication. | |
| slotOffsetPeriodic | Indicates slot offset in one | INTEGER(0..ncr-periodicity- |
| | period. | 1) |
| symbolOffset | Indicates symbol offset in one | INTEGER(0..13) |
| | slot. | |
| durationInSymbols | Indicates the time duration in | INTEGER(1..448) |
| | number of symbols. | |

For aperiodic beam indication, parameters as shown in Table 5 may be defined.

TABLE 5

| Parameter name | Field descriptions | Value range |
|---|---|---|
| NCR- | Aperiodic time resource | SEQUENCE{NCR- |
| AperiodicFwdResource | configuration for beam | AperiodicFwdTimeResource |
| Set | indication for NCR. The | ToAddModList, NCR- |
| | configuration includes a list of | AperiodicFwdTimeResource |
| | time domain resource that can | ToRemoveList} |
| | be selected in aperiodic | |
| | forwarding. | |
| NCR- | List of aperiodic NCR | SEQUENCE |
| AperiodicFwdTimeResource | forwarding time resource to | (SIZE(1..maxNrofAperiodicFwd |
| ToAddModList | add and/or modify. | TimeResource)) OF ncr- |
| | | AperiodicFwdTimeResource |
| | | maxNrofAperiodicFwdTime |
| | | Resource = 128 |
| NCR- | List of aperiodic NCR | SEQUENCE |
| AperiodicFwdTimeResource | forwarding time resource to | (SIZE(1..maxNrofAperiodicFwd |
| ToRemoveList | remove. | TimeResource)) OF ncr- |
| | | AperiodicFwdTimeResourceId |
| NCR- | Indicates the time resource for | SEQUENCE {ncr- |
| AperiodicFwdTimeResource | aperiodic beam indication. | AperiodicFwdTimeResourceId, |
| | NCR is assumed to be ON over | slotOffsetAperiodic, |
| | the indicated time domain | symbolOffset, |
| | resource if there is beam | durationInSymbols} |
| | indication. | |
| ncr- | Aperiodic forwarding time | INTEGER(0..maxNrofAperiodic |
| AperiodicFwdTimeResourceId | resource ID. | FwdTimeResource-1) |
| slotOffsetAperiodic | Indicates slot offset used to | INTEGER(0..maxSlotOffset |
| | define the start slot of | Aperiodic-1) |
| | aperiodic time resource. The | maxSlotOffsetAperiodic = 4 |
| | value refers to the slot offset | |
| | between the start slot and the | |
| | time instant when the DCI | |
| | signalling is applied, e.g., n + k, | |
| | where n is time instant when | |
| | DCI is received and k is | |
| | scheduling offset defined in | |
| | 38.214. | |
| symbolOffset | Indicates symbol offset within | INTEGER(0..13) |
| | the slot. | |
| durationInSymbols | Indicates the time duration in | INTEGER(1..28) |
| | number of symbols. | |

For an NCR-MT dedicated radio network temporary identifier (RNTI), parameters as shown in Table 6 may be defined.

TABLE 6

| Parameter name | Field descriptions | Value range |
|---|---|---|
| NCR-RNTI | This field indicates the NCR- | To be |
| | RNTI assigned to NCR-MT, | determined |
| | which is used to scramble the | by RAN2. |
| | PDCCHs carrying side control | |
| | information and PDCCHs used | |
| | to schedule the PDSCH | |
| | carrying the side control | |
| | information. | |

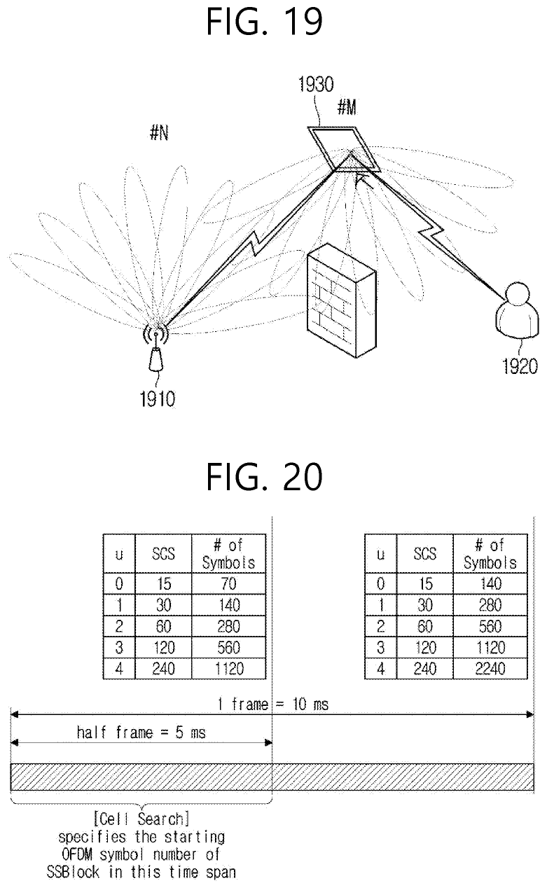

Similar to the NCR, a RIS node has advantages such as noise amplification, spatial directivity between a base station and a terminal, simplification of a network, by receiving side control information from the network. From an economic point of view, it is more efficient than an existing relay, and it may perform an auxiliary role in coverage extension or throughput improvement according to transmission multiplexing in components of the network. Additionally, by using passive RIS and active RIS, beamforming can be performed. Also, the RIS may perform different beamforming in multiple bands. Similar to the case of the NCR, the RIS may be basically configured such that a beam index for the NCR-Fwd is transmitted in an active/semi-static form for access link beam indication. Herein, the beam indexes may be resource IDs. A major difference between the NCR and the RIS is that a quasi co-location (QCL) relationship of Tx/Rx beams in the backhaul link and the access link may not exist. Therefore, in case the RIS node is controlled by the network, an access link beam indication procedure of the RIS may be performed in the same method as using the NCR, but to perform this operation, the number of resources and resource IDs as much as (the number of beams of the BS)×(the number of beams of the RIS) may be required as shown in FIG. 19.

In such an operation, in case an existing SSB transmission method (that is, a time domain one SSB transmission scheme) is used at initial access, a situation in which an initial access completion time interval becomes longer may occur. Therefore, overall transmission latency of a communication system may be caused, or a phenomenon in which wireless support of terminals within a specific coverage becomes difficult may occur.

The present disclosure proposes introduction of a technique of arranging SSBs for the RIS in a frequency domain. In addition, the present disclosure proposes a method of additionally using a PBCH payload and a DMRS of the PBCH to solve a problem of uncertainty of detecting a reference point A occurring at this time. The present disclosure proposes a technique of active SSB configuration and operation for efficient resources in the SSB frequency domain while solving the uncertainty of detecting the reference point A.

FIG. 20 illustrates an example in which a synchronization signal block (SSB) is allocated to one frame structure according to an embodiment of the present disclosure. In NR, the number of SSBs is configured according to SCS (sub-carrier spacing) and frequency, and normally, up to four SSBs (Lₘₐₓ) may be configured for 15 kHz SCS and 3 GHz or lower. In this criterion, in case of a terminal in a situation as shown in FIG. 19, an initial configuration time interval of up to 10 ms×(N×M)/4 may occur. Therefore, a method of multiplexing SSBs in a frequency domain may be considered. First, a basic procedure of generating and transmitting/receiving synchronization signals will be described.

Cell search means a process in which a terminal obtains time/frequency synchronization of a cell and detects a cell identifier (ID) of the cell (e.g., physical layer cell ID (PCID)). A PSS is used to detect a cell ID within a cell ID group, and an SSS is used to detect the cell ID group. A PBCH is used to detect an SSB (time) index and to detect a half-frame.

A cell search procedure of the terminal may be summarized as shown in Table 7 below.

TABLE 7

| | Type of | |
|---|---|---|
| | Signals | Operations |
| 1^{st} step | PSS | SS/PBCH block (SSB) symbol timing acquisition |
| | | Cell ID detection within a cell ID group |
| | | (3 hypothesis) |
| 2^{nd} Step | SSS | Cell ID group detection (336 hypothesis) |
| 3^{rd} Step | PBCH | SSB index and Half frame (HF) index(Slot and frame |
| | DMRS | boundary detection) |
| 4^{th} Step | PBCH | Time information (80 ms, System Frame Number |
| | | (SFN), SSB index, HF) |
| | | Remaining Minimum System |
| | | Information (RMSI) Control resource set |
| | | (CORESET)/Search space configuration |
| 5^{th} Step | PDCCH and | Cell access information |
| | PDSCH | RACH configuration |

There are 336 cell ID groups, and three cell IDs exist per cell ID group. A total of 1008 cell IDs exist, and the cell ID may be defined by [Equation 1].

$${N}_{ID}^{cell} = 3 {N}_{ID}^{( 1 )} + {N}_{ID}^{( 2 )} \\ where \\ {N}_{ID}^{( 1 )} ∈ \{ 0 , 1 , … , 335 \} \\ and \\ {N}_{ID}^{( 2 )} ∈ \{ 0 , 1 , 2 \} . \qquad [ Equation 1 ]$$

In [Equation 1],

$${N}_{ID}^{cell}$$

represents a cell ID (e.g., PCID).

$${N}_{ID}^{( 1 )}$$

represents a cell ID group and is provided/obtained through an SSS.

$${N}_{ID}^{( 2 )}$$

represents a cell ID within the cell ID group and is provided/obtained through a PSS.

A PSS sequence d_{PSS}(n) may be defined to satisfy [Equation 2].

$${d}_{PSS} ( n ) = 1 - 2 x ( m ) \\ m = ( n + 43 {N}_{ID}^{( 2 )} ) mod 127 \qquad [ Equation 2 ]$$

An SSS sequence d_{SSS}(n) may be defined to satisfy [Equation 3].

$${d}_{SSS} ( n ) = [ 1 - 2 {x}_{0} ( ( n + {m}_{0} ) mod 127 ) ] [ 1 - 2 {x}_{1} ( ( n + {m}_{1} ) mod 127 ) ] \\ {m}_{0} = 15 ⌊ \frac{{N}_{ID}^{( 1 )}}{112} ⌋ + 5 {N}_{ID}^{( 2 )} \\ {m}_{1} = {N}_{ID}^{( 1 )} mod 112 \qquad [ Equation 3 ]$$

A sequence r(m) for an SSB may be defined as shown in [Equation 4] below.

$$r ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) \qquad [ Equation 4 ]$$

In [Equation 4], c(n) means a sequence generated based on a pseudo-random sequence generator.

A scrambling sequence generator may be initialized as shown in [Equation 5] when each SS/PBCH block (SSB) occasion starts.

$${c}_{init} = {2}^{11} ( {\overline{ι}}_{SSB} + 1 ) ( ⌊ {N}_{ID}^{cell} / 4 ⌋ + 1 ) + {2}^{6} ( {\overline{ι}}_{SSB} + 1 ) + ( {N}_{ID}^{cell} mod 4 ) \qquad [ Equation 5 ]$$

In [Equation 5], i_{SSB} means least significant bits of a candidate SSB index, ι̅_{SSB} means a value determined by [Equation 6] below based on i_{SSB}, and

$${N}_{ID}^{cell}$$

means a physical layer cell ID.

$${\overline{ι}}_{SSB} = \{ \begin{matrix}{i}_{SSB} & if {\overline{L}}_{m ax} = 4 , \\ & where {i}_{SSB} is the two least significant bits \\ {i}_{SSB} + 4 {n}_{hf} & if {\overline{L}}_{m ax} > 4 , \\ & where {i}_{SSB} is the three least significant bits\end{matrix} \qquad [ Equation 6 ]$$

In [Equation 6], n_{hf} means a half-frame including an SSB. That is, when n_{hf}=0, a PBCH is transmitted in a first half-frame, and when n_{hf}=1, a PBCH is transmitted in a second half-frame. In addition, L̅ₘₐₓ means a maximum number of SS/PBCH blocks transmitted in a half-frame.

A terminal assumes that, b(0), . . . , b(M_{bit}−1) which is a block of bits, is scrambled before modulation, and becomes a scrambled bit block of \tilde{b}(0), . . . , \tilde{b}(M_{bit}−1) by [Equation 7] below.

$$\tilde{b} ( i ) = ( b ( i ) + c ( i + v {M}_{bit} ) ) mod 2 \qquad [ Equation 7 ]$$

In [Equation 7], c(i) means a scrambling sequence, and the scrambling sequence is initialized through

$${c}_{init} = {N}_{ID}^{cell}$$

at a start of an SS/PBCH block. In addition, in case of L̅ₘₐₓ=4, v means two least significant bits of a candidate SS/PBCH block index. In case of L̅ₘₐₓ>4, v means three least significant bits of a candidate SS/PBCH block index.

A terminal assumes that \tilde{b}(0), . . . , \tilde{b}(M_{bit}−1), which is a block of bits, is modulated by QPSK and becomes a block of complex-valued modulation symbols

$${d}_{PBCH} ( 0 ) , … , {d}_{PBCH} ( {M}_{symb} - 1 ) .$$

### SSB Generation

In a time domain, an SS/PBCH block consists of four OFDM symbols numbered in an increasing order from 0 to 3 within the SS/PBCH block, and PSS, SSS, and PBCH related to a DM-RS are mapped to the symbols based on [Table 8] below.

TABLE 8

| Channel | OFDM symbol number | Subcarrier number |
|---|---|---|
| or | relativetothestartofanSS/ | relativetothestartofanSS/ |
| signal | PBCHblock | PBCHblock |
| PSS | 0 | 56, 57, . . . , 182 |
| SSS | 2 | 56, 57, . . . , 182 |
| Set to 0 | 0 | 0, 1, . . . , 55, 183, 184, . . . , 239 |
| Set to 0 | 2 | 48, 49, . . . , 55, 183, 184, . . . , 191 |
| PBCH | 1, 3 | 0, 1, . . . , 239 |
| PBCH | 2 | 0, 1, . . . , 47, |
| | | 192, 193, . . . , 239 |
| DM-RS for | 1, 3 | 0 + v, 4 + v, 8 + v, . . . , 44 + v |
| PBCH | | |
| DM-RS for | 2 | 192 + v, 196 + v, . . . , 236 + v |
| PBCH | | |

In a frequency domain, an SS/PBCH block consists of 240 consecutive subcarriers, and the subcarriers are numbered in an order from 0 to 239 within the SS/PBCH block. Quantities k and l represent frequency and time indexes, respectively, within one SS/PBCH block. A terminal may assume that a complex-valued symbol corresponding to a resource element indicated as “Set to 0” in [Table 8] is set to 0. v in [Table 8] is given by

$$v = {N}_{ID}^{cell} mod 4.$$

k_{SSB} means a subcarrier offset from subcarrier 0 of a common resource block (CRB)

$${N}_{CRB}^{SSB}$$

to subcarrier 0 of the SS/PBCH block. Herein,

$${N}_{CRB}^{SSB}$$

may be obtained from a higher layer parameter offsetToPointA.
In case of an operation with shared spectrum channel access and an operation without shared spectrum channel access in FR2-2, four least significant bits of k_{SSB} are given by a higher layer parameter ssb-SubcarrierOffset, and in case of FR1, least significant bits of k_{SSB} are given by ā_{Ā+5} of a PBCH payload.
In case of an operation with shared spectrum channel access in FR1, four least significant bits of k_{SSB} are given by a higher layer parameter ssb-SubcarrierOffset, and least significant bits of k_{SSB} are given by ā_{Ā+5} of a PBCH payload. If k̅_{SSB}≥24, then k_{SSB}=k̅_{SSB}, otherwise k_{SSB}=2└k̅_{SSB}/2┘.

If ssb-SubcarrierOffset is not provided, k_{SSB} is derived from the frequency difference between the SS/PBCH block and Point A.

A UE may assume that the complex-valued symbols corresponding to resource elements that are part of a common resource block partially or fully overlapping with an SS/PBCH block and not used for SS/PBCH transmission are set to 0 in the OFDM symbols partially or fully overlapping with OFDM symbols where SS/PBCH is transmitted.

Regarding the SS/PBCH block, the UE assumes as follows:
Antenna port p=4000 is used for transmission of PSS, SSS, PBCH, and DM-RS for PBCH.
A cyclic prefix length and a subcarrier spacing for PSS, SSS, PBCH, and DM-RS for PBCH are the same.
In case of an SS/PBCH block type A, μ∈{0,1} and k_{SSB}∈{0, 1, 2, . . . , 23} use values of k_{SSB} and

$${N}_{CRB}^{SSB}$$

expressed in a 15 kHz subcarrier spacing.
In case of an SS/PBCH block type B of FR2-1, μ∈{3,4} and k_{SSB}∈{0, 1, 2, . . . , 11} use values of k_{SSB} expressed in a subcarrier spacing provided by a higher layer parameter subCarrierSpacingCommon and a value of

$${N}_{CRB}^{SSB}$$

expressed in a 60 KHz subcarrier spacing.
In case of an SS/PBCH block type B of FR2-2, μ∈{3,5,6} and k_{SSB}∈{0, 1, 2, . . . , 11} use values of k_{SSB} expressed in an SS/PBCH block subcarrier spacing and a value of

$${N}_{CRB}^{SSB}$$

expressed in a 60 kHz subcarrier spacing.
A center of subcarrier 0 of a resource block

$${N}_{CRB}^{SSB}$$

coincides with a center of subcarrier 0 of a common resource block having a subcarrier spacing. In this case, the subcarrier spacing is provided by a higher layer parameter subCarrierSpacingCommon for operation without shared spectrum channel access in FR1 and FR2-1. The subcarrier spacing is the same as an SS/PBCH block subcarrier spacing for operation without shared spectrum channel access in FR2-2 and for operation with shared spectrum channel access.
The common resource block overlaps with subcarrier 0 of a first resource block of the SS/PBCH block.

A UE may assume that SS/PBCH blocks transmitted with the same block index at the same center frequency location are quasi co-located with respect to Doppler spread, Doppler shift, average gain, average delay, delay spread, and spatial Rx parameters if applicable. A UE does not assume quasi co-location for transmission of other SS/PBCH blocks.

### Mapping of PSS, SSS, PBCH, and DM-RS

A UE may assume that a symbol sequence d_{PSS}(0), . . . , d_{PSS}(126) constituting a primary synchronization signal is scaled by a factor β_{PSS} to comply with PSS power allocation, and may be mapped to resource elements (k, l)_{p,μ} in an order in which k increases. Herein, k and l represent frequency and time indexes, respectively, within one SS/PBCH block.

A UE may assume that a symbol sequence d_{SSS}(0), . . . , d_{SSS}(126) constituting a secondary synchronization signal is scaled by a factor β_{SSS}, and may be mapped to resource elements (k, l)_{p,μ} in an order in which k increases. Herein, k and 1 represent frequency and time indexes, respectively, within one SS/PBCH block.

A UE may assume that a sequence d_{PBCH}(0), . . . , d_{PBCH}(M_{symb}−1) of complex-valued symbols constituting a physical broadcast channel is scaled by a factor β_{PBCH} to comply with PBCH power allocation, and may be mapped starting d_{PBCH}(0) from to resource elements (k, l)_{p,μ} satisfying a specific condition.

Mapping to resource elements (k, l)_{p,μ} not reserved for PBCH DM-RS increases first in index k and then in index l, wherein k and l represent frequency and time indexes, respectively, within one SS/PBCH block.

A UE may assume that a sequence of complex-valued symbols r(0), . . . , r(143) constituting a demodulation reference signal for an SS/PBCH block is scaled by a factor

$${β}_{PBCH}^{DM - RS}$$

to comply with PBCH power allocation, and may be mapped to resource elements (k, l)_{p,μ} in an order in which k increases first and l increases next. Herein, k and 1 represent frequency and time indexes, respectively, within one SS/PBCH block.

By using the above-described method, a base station may generate an SS/PBCH block and allocate it to radio resources. In the following, a procedure of multiplexing SS/PBCH blocks in a frequency domain based on the above-described method is described.

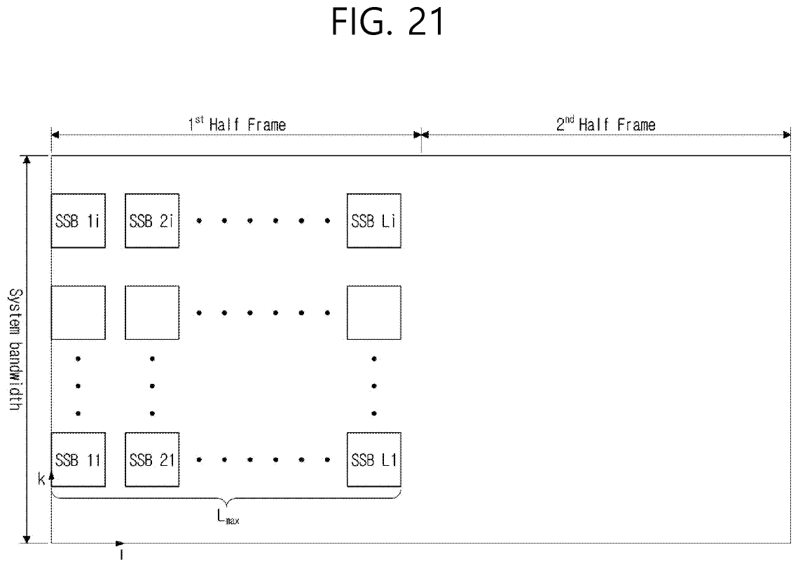

FIG. 21 illustrates an example of a first SSB transmission type multiplexed in a frequency domain according to an embodiment of the present disclosure. Referring to FIG. 21, a base station may allocate i SSBs in a time interval of existing SSBs by multiplexing them in the frequency domain based on a corresponding numerology.

When the base station allocates SSBs to resources as shown in FIG. 21, a conventional SSB configuration described above may be utilized for Tx/Rx beam setting of an access link using an RIS. In addition, configuration related to frequency domain multiplexing may include the number of SSBs and a spacing between adjacent SSBs. A frequency spacing may be indicated by a direct frequency value or may be expressed in a unit of an RB or an RE. Further, when a system band is configured, the number i of SSBs may be configured based on the system band, and an allocation method of SSBs may be determined based on the system band and the number of SSBs. When such a method is used, since the largest number of SSBs may be allocated to one frame (e.g., 10 ms interval), fast initial access may be performed considering beams of an active RIS.

As shown in FIG. 21, SSB l1 to SSB li may be multiplexed in a frequency domain in an 1-th time interval. A beam setting for SSB l1 to SSB li may be implemented in various ways and is not limited to a specific method. For example, a base station may transmit SSB l1 to SSB li with different beam settings, respectively. When the base station uses an RIS, passive elements of the RIS may not be changed during a specific time interval. Accordingly, a base station may fix parameters related to beamforming of the RIS (e.g., control values of passive elements of the RIS) during the 1-th time interval, and may transmit SSBs after forming beams between the base station and the NCR or the RIS differently by frequency band. As a specific example, when N (the number of RIS beams)×M (the number of beams of the base station) measurements are required as shown in FIG. 19, a number Lₘₐₓ of SSBs transmitted in a time domain in a specific frame may be determined as N, and a number i of SSBs multiplexed in a frequency domain may be determined as M, and SSBs may be allocated based thereon. That is, a base station may allocate SSBs in a structure as shown in FIG. 21, and a UE may measure N×M spatial characteristics by using SSBs belonging to one frame. However, the present disclosure is not limited to that all SSBs are transmitted with different beams. A base station may transmit specific SSBs through the same beam, and beamforming for each SSB may be determined in various ways.

The example of FIG. 21 shows an example in which SSBs are allocated to a time domain and a frequency domain. Herein, an SSB may be understood as a set of signals including at least one synchronization signal and at least one common channel. Specifically, an SSB may include a primary synchronization signal (PSS), a secondary synchronization signal (SSS), and a physical broadcast channel (PBCH). However, the SSB in the present disclosure may be referred to by different terms, for example, a synchronization signal set, a measurement signal set, a synchronization and broadcast signal block, or other terms having equivalent technical meaning.

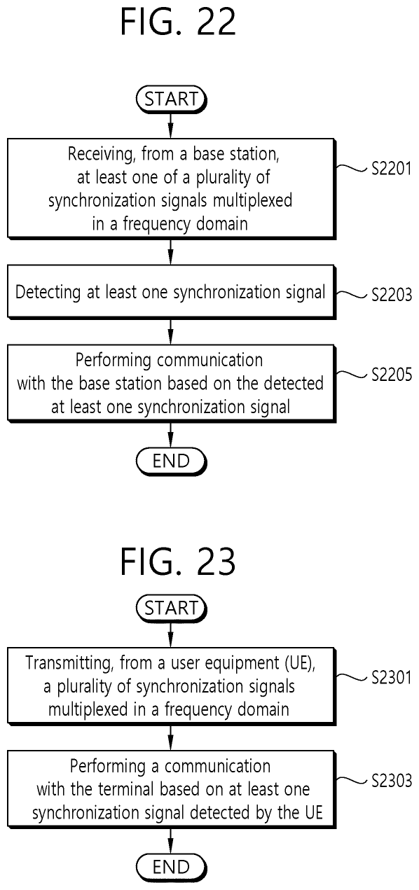

FIG. 22 illustrates an example of a procedure in which user equipment (UE) performs synchronization by using synchronization signals multiplexed in a frequency domain according to an embodiment of the present disclosure. By using FIG. 22, a plurality of synchronization signals may be simultaneously received during a specific time interval.

Referring to FIG. 22, in step S2201, the UE receives at least one of a plurality of synchronization signals multiplexed in a frequency domain from a base station. A synchronization signal may use various reference signals and is not limited to a specific name. For example, a synchronization signal may be received in a form included in an SS/PBCH block (SS/PBCH block, SSB). The SSB may be transmitted for initial access or quality measurement of a cell. In addition, the plurality of synchronization signals may be generated by a base station and may be transmitted through respective spatial resources. Accordingly, the plurality of synchronization signals may be transmitted based on beamforming individually determined. When a synchronization signal is transmitted in an SSB, beamforming for each of a plurality of SSBs may be determined based on beamforming between the base station and the RIS and beamforming from the RIS to the UE, and may be determined based on an SSB index. The plurality of synchronization signals may be delivered to the UE through the RIS or the NCR from the base station.

In step S2203, the UE detects at least one synchronization signal. When the UE receives a set of synchronization signals such as an SSB, the UE may detect a PSS, an SSS, and the like included in at least one SSB received in step S2201. For example, the UE may determine a synchronization signal to be detected based on a reference signal received power (RSRP) of at least one synchronization signal received. The UE may obtain time and/or frequency synchronization based on the detected synchronization signal and may obtain a physical layer cell ID of the corresponding cell.

In step S2205, the UE performs communication with the base station based on at least one detected synchronization signal. The base station may determine a beam for transmitting and receiving a signal based on a feedback signal. To this end, the UE may explicitly or implicitly deliver index information of at least one detected synchronization signal to the base station. When the synchronization signal is included in an SSB, SSB index information may be delivered to the base station. The base station may check which synchronization signal is detected by the UE based on the index information of the detected synchronization signal or the SSB index information delivered from the UE.

FIG. 23 illustrates an example of a procedure in which a base station performs communication with UE by using synchronization signals multiplexed in a frequency domain according to an embodiment of the present disclosure. Referring to FIG. 23, a base station may shorten a time until the UE detects a synchronization signal by generating synchronization signals multiplexed in a frequency domain and delivering them to the UE.

Referring to FIG. 23, in step S2301, the base station transmits a plurality of synchronization signals multiplexed in a frequency domain to the UE. Herein, a synchronization signal may be transmitted included in a synchronization signal block (SSB). The base station may allocate and transmit a plurality of SSBs in a specific time interval by differentiating frequency bands. In addition, the base station may determine information on a reference point and may explicitly or implicitly deliver the information on the reference point to the UE.

For each transmission of synchronization signals, a beam may be individually formed. That is, different beams may be formed for each of the plurality of synchronization signals, and some synchronization signals may be transmitted through the same beam. In addition, when the base station operates an NCR or an RIS, the base station may deliver information related to synchronization signals to the NCR or the RIS.

A procedure in which the base station transmits a synchronization signal or an SSB is not limited to a specific method. Therefore, the procedure may be transmitted considering a method for backward compatibility. A method for backward compatibility will be described below.

In step S2303, the base station performs communication with the UE based on a synchronization signal detected by the UE. As described above, when a plurality of synchronization signals are transmitted from the base station, the UE may detect at least one of the plurality of synchronization signals. Accordingly, the UE may deliver information on the synchronization signal detected by the UE to the base station through a feedback signal. The base station may determine a beam for communication based on the feedback signal and may perform communication based on the determined beam.

When transmitting an SSB multiplexed in a frequency domain, a large number of synchronization signals may be transmitted in a specific time interval, but ambiguity of a reference point A may occur due to the SSBs multiplexed in the frequency domain. The reference point is a point serving as a reference in a frequency domain and is used for configuring a frequency resource structure including subcarriers and resource blocks and determining locations of resources. The reference point may be configured in various ways, and the reference point may exist inside or outside a frequency band used by the UE. Information on the reference point may be explicitly or implicitly delivered to the UE.

That is, when a plurality of SSBs are transmitted in the same time interval as shown in FIG. 21, a reference point A found based on a CRB at an SSB detection time may not be an actual reference point A of the CRB.

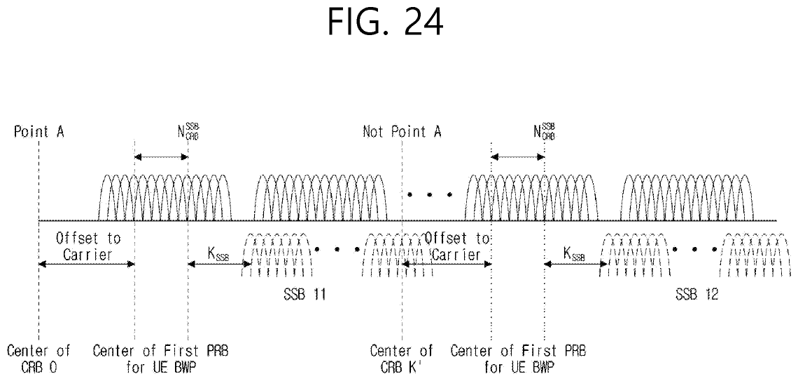

FIG. 24 illustrates an example of ambiguity of a reference time point in an SSB frame structure multiplexed in a frequency domain according to an embodiment of the present disclosure. In existing NR, a UE may simply estimate a reference point A or a center frequency based on offsetToCarrier,

$${N}_{CRB}^{SSB}$$

anu k_{SSB}. Herein, offsetToCarrier may mean a frequency gap between the reference point A and a first physical resource block (PRB) for a bandwidth part (BWP) of the UE (e.g., PRB 0).

$${N}_{CRB}^{SSB}$$

may mean a resource block offset between the lowest frequency of the corresponding SSB and the first PRB. k_{SSB} may mean a subcarrier offset from subcarrier 0 of a lowest CRB

$${N}_{CRB}^{SSB}$$

to subcarrier 0 of an SS/PBCH block. Accordingly, the UE may obtain a total offset value based on offsetToCarrier,

$${N}_{CRB}^{SSB}$$

and k_{SSB}, and may determine point A by subtracting the total offset value from the lowest subcarrier on which the SSB is detected. Although the present disclosure proposes a method of determining the total offset based on at least one of offsetToCarrier,

$${N}_{CRB}^{SSB}$$

or k_{SSB}, it is not limited thereto, and the total offset may be determined based on various parameters, and the reference point may be determined based on the total offset and information on the detected SSB.

When a plurality of SSBs are transmitted in the same time interval as shown in FIG. 24, a reference point A found based on SSB 11 and a reference point A found based on SSB 12 may be different. That is, when the UE detects SSB 12 and finds a reference point A by using N_{CRB}^{SSB} and k_{SSB} based on the detected SSB, the reference point A may not be an actual reference point A in the CRB. Accordingly, a value indicating which number of SSB in the frequency domain in the same time interval may be required. Below, a method of allocating SSBs applicable to the present disclosure is proposed.

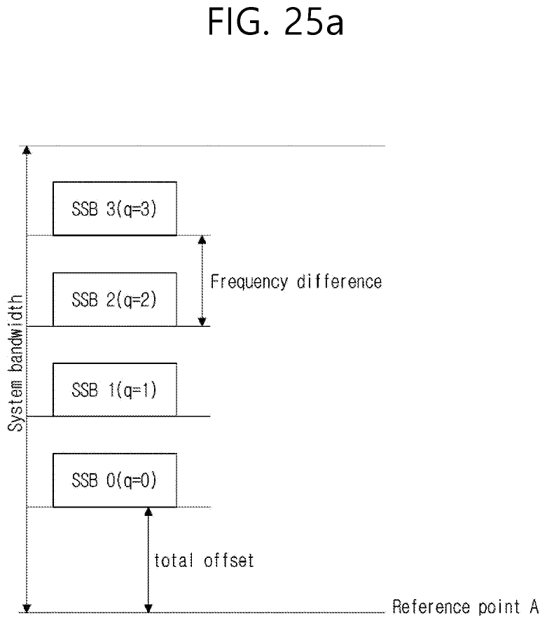

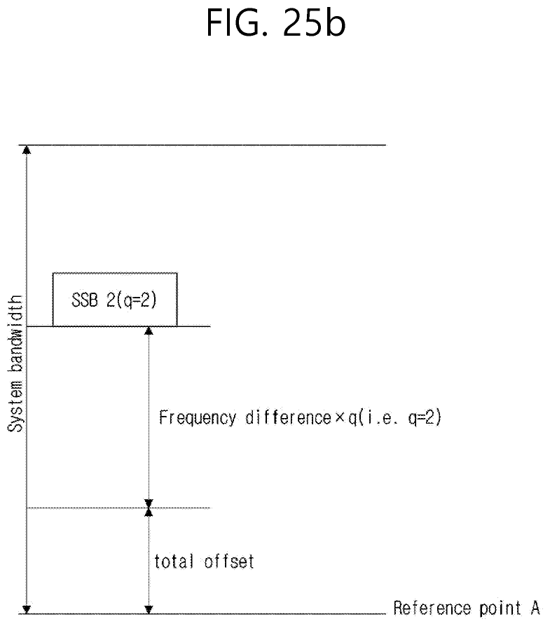

FIG. 25a illustrates an example of a structure in which an SSB is allocated to the same time interval according to an embodiment of the present disclosure. A base station may determine a number i of SSBs to be multiplexed in a frequency domain within one time interval. The number i may be determined based on at least one of the number of beamforming operations of the base station and the number of reflection patterns of the RIS (reconfigurable intelligent surface). Below, for convenience of explanation, it is assumed that the number i is determined as 4. The base station may determine a total offset value based on a reference point A, and may determine a band to which SSBs are to be allocated by subtracting the total offset value from a system bandwidth. When the base station divides the band to which SSBs are to be allocated by the number i=4, the base station may determine a frequency gap between SSBs. The base station may allocate SSB 0 to SSB 3 to resources of equal frequency intervals based on the frequency gap between SSBs. The base station may explicitly or implicitly deliver a value q indicating which number of SSB in a frequency domain each of SSB 0 to SSB 3 corresponds to the UE. For example, information on the value q may be delivered based on an SSB and will be described below. Below, the value q may be referred to as information related to a location in a frequency domain.

FIG. 25b illustrates an example of a method of finding a reference point A when a UE detects an SSB according to an embodiment of the present disclosure. For convenience of explanation, it is assumed that the UE detects SSB 2 among a plurality of SSBs transmitted in a form of FIG. 24.

The UE that detects a synchronization signal included in SSB 2 may receive, explicitly or implicitly from the base station, information such as the value q related to a location in a frequency domain based on SSB2, the number i, the total offset value, the system bandwidth. The UE may determine a frequency gap between SSBs by subtracting the total offset value from the system bandwidth and then dividing by the number i of SSBs allocated. Thereafter, the UE may determine a reference point A by calculating (the lowest frequency of SSB 2 including the detected synchronization signal)−(frequency gap×q (=2)+total offset).

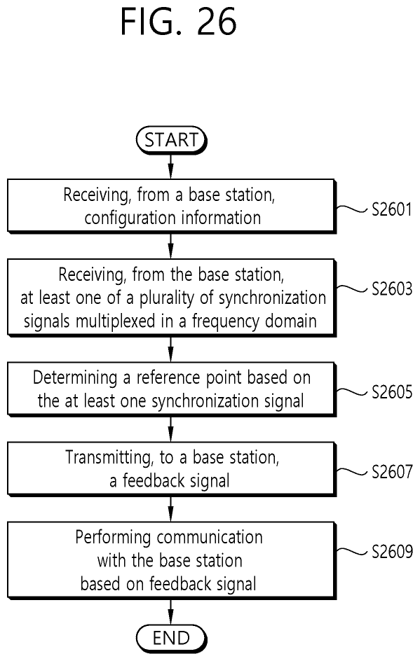

FIG. 26 illustrates an example of a procedure in which UE transmits a feedback signal based on a plurality of synchronization signals according to an embodiment of the present disclosure.

Referring to FIG. 26, in step S2601, the UE receives configuration information from a base station. The configuration information may be explicitly or implicitly delivered. The configuration information may include information on an SSB transmission type.

In step S2603, the UE receives at least one of a plurality of synchronization signals multiplexed in a frequency domain from the base station. The synchronization signals may be transmitted included in an SSB in various types described below and may include a plurality of synchronization signals in the same time interval.

In step S2605, the UE determines a reference point based on a detected synchronization signal. The UE may determine which synchronization signal among the at least one received synchronization signal is to be detected. The UE may determine the reference point based on the detected synchronization signal. For example, as described in FIG. 24B, the UE may determine the reference point based on at least one of a total frequency offset of a system bandwidth and the number of SSBs included in a specific time interval.

In step S2607, the UE transmits a feedback signal to the base station. By using the feedback signal, the UE may deliver information on the detected synchronization signal to the base station. The information on the detected synchronization signal may be explicitly or implicitly delivered. The information on the detected synchronization signal may include information indicating which synchronization signal has been detected, and may be delivered in a form of an index value of the detected synchronization signal or an index value of an SSB including the detected synchronization signal.

In step S2609, the UE performs communication with the base station based on the feedback signal. The base station may identify which synchronization signal has been detected based on the feedback signal received from the UE. The base station may transmit a data signal or the like to the UE based on a beam used to transmit the detected synchronization signal, and the UE may receive the data signal or the like from the base station.

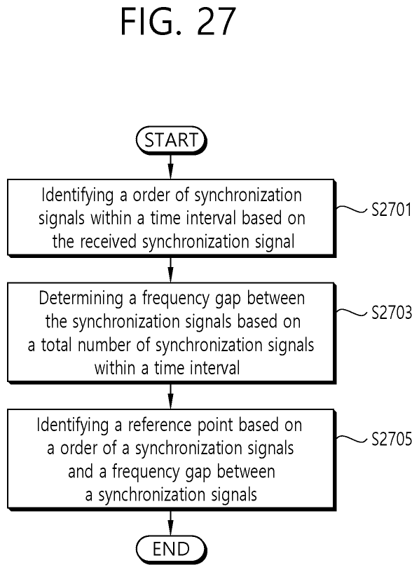

FIG. 27 illustrates an example of a procedure in which UE determines a reference point based on a synchronization signal according to an embodiment of the present disclosure. In FIG. 27, for convenience of explanation, it is assumed that the synchronization signal is transmitted included in an SSB. That is, receiving the synchronization signal may mean receiving the SSB including the synchronization signal.

In step S2701, the UE identifies an order of SSBs within a specific time interval based on a received SSB. The order of SSBs may be sequentially determined with value q related to a location in a frequency domain described in FIG. 25b, in which the SSB having the lowest frequency is set as 0. The information related to a location in a frequency domain may be explicitly or implicitly delivered. For example, the information related to a location in a frequency domain may be determined based on at least one of a value included in a payload of a PBCH of an SSB and a last bit value of an SSB index for scrambling of a DMRS of the PBCH.

In step S2703, the UE determines a frequency gap between reference signals based on a total number of SSBs in the time interval. For this purpose, the total number of SSBs multiplexed in a frequency domain may be delivered to the UE in various manners. For example, the total number of SSBs may be separately delivered from the base station through configuration information, or a preconfigured default value of the UE may be used. In another example, the total number of synchronization signals may be explicitly or implicitly included in an SSB. In addition, the UE may obtain system bandwidth and offset values through a MIB and a SIB based on an SSB. The UE may determine the frequency gap based on the obtained system bandwidth, offset values, and the total number of SSBs in the specific time interval.

In step S2705, the UE determines the reference point based on the order of SSBs and the frequency gap between the SSBs. For example, as shown in FIG. 25, the UE may determine the reference point by removing a value obtained by multiplying the total offset value and the frequency gap with the order value of the SSB from a frequency of the SSB.

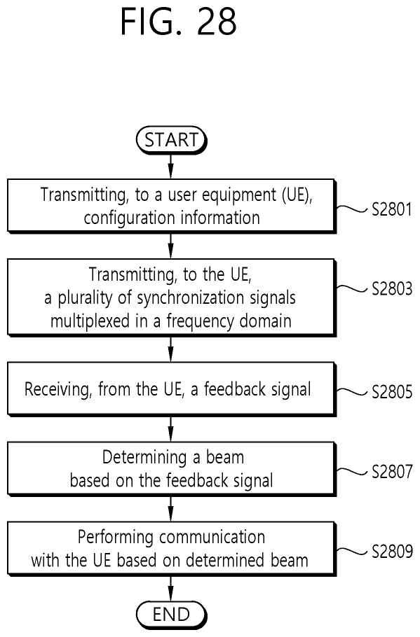

FIG. 28 illustrates an example of a procedure in which a base station receives a feedback signal based on a plurality of synchronization signals according to an embodiment of the present disclosure.

In step S2801, the base station transmits configuration information to a UE. The configuration information may be explicitly or implicitly delivered. The base station may determine a type of transmitting a plurality of synchronization signals, and the configuration information may include information related to a synchronization signal transmission type.

In step S2803, the base station transmits a plurality of synchronization signals multiplexed in a frequency domain to the UE. The base station may allocate a plurality of synchronization signals in one half-frame in a time domain. In addition, the base station may allocate a plurality of synchronization signals within a system bandwidth in a frequency domain. Accordingly, the base station may transmit synchronization signals multiplexed in the time domain and the frequency domain to the UE based on a synchronization signal transmission type. The multiplexed synchronization signals may be transmitted using different beams, respectively.

In step S2805, the base station receives a feedback signal from the UE. The UE may detect at least one synchronization signal among the plurality of synchronization signals, and may deliver information on the detected synchronization signal to the base station through the feedback signal.

In step S2807, the base station determines a beam based on the feedback signal. The base station may identify the detected synchronization signal by the UE based on the feedback signal, and may determine a beam of the base station based on the beam used for transmission of the detected synchronization signal. If the base station transmits the synchronization signal by using a RIS, the base station may control a beam of the RIS based on the beam used for transmission of the detected synchronization signal. The base station may deliver information related to a beam to the RIS in order to control the RIS. For example, the base station may deliver information on the detected synchronization signal to the RIS. If the synchronization signal is delivered included in an SSB, information on the detected synchronization signal may be delivered through an index value of the SSB.

In step S2809, the base station performs communication with the UE based on the determined beam. The base station may perform communication with the UE based on at least one of a base station beam determined in step S2807 or an RIS beam determined in step S2807.

Hereinafter, SSB transmission types applicable to various embodiments of the present disclosure will be described. For convenience of explanation in the present disclosure, it has been described that the synchronization signal is included in an SSB, but the present disclosure is equally applicable even when the synchronization signal is transmitted in another form.

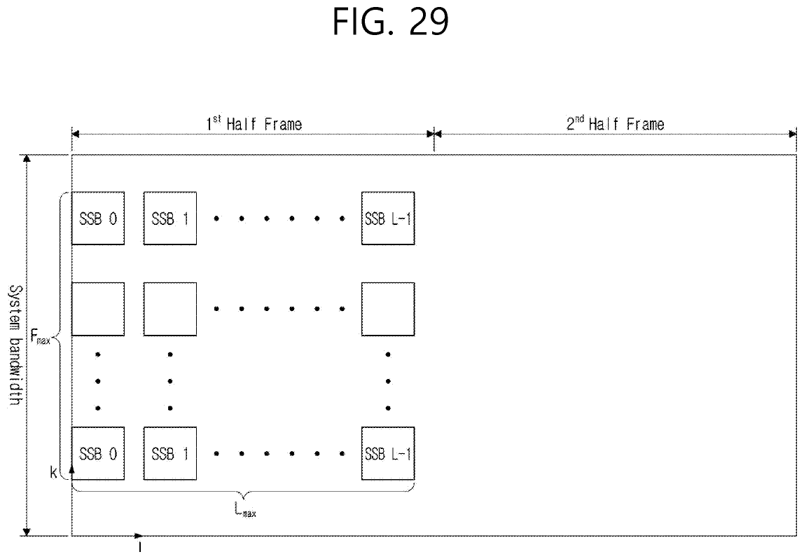

FIG. 29 illustrates an example of a second SSB transmission type according to an embodiment of the present disclosure. Referring to FIG. 29, a base station may allocate SSBs (synchronization signal blocks) in consideration of backward compatibility.

For backward compatibility, parameters used for configuring an SSB (synchronization signal block) in LTE or NR (new radio) may be utilized. For example, the above-described Lₘₐₓ, N_{CRB}^{SSB}, k_{SSB}, etc. may be used. In the present disclosure, backward compatibility means that even when additional configurations are added in the present disclosure, communication is not hindered by using the parameters used in LTE or NR, regardless of whether base station capability, UE capability, or a category of a UE is changed. Accordingly, a base station and a UE not reflecting the additional configurations of the present disclosure may operate based on the existing LTE or NR configurations without expecting the additional configurations.

A base station may set a resource block (RB) in which an SSB is allocated by determining a value Fₘₐₓ on a configured numerology. Here, the value Fₘₐₓ means the number of SSBs multiplexed in a frequency domain. In a second SSB transmission type, the value Fₘₐₓ is set to the same value in each time interval transmitting an SSB. In the second SSB transmission type, a UE may be configured with a value of Fₘₐₓ through a radio resource control (RRC) or a medium access control control element (MAC-CE), and a start position of a k-th SSB

$${k}_{CRB}^{ssb}$$

in a frequency domain may be determined based on a system bandwidth, Fₘₐₓ as shown in [Equation 8] below.

$${k}_{CRB}^{ssb} = q \frac{\begin{matrix}System bandwidth - \\ ( {k}_{ssb} + {N}_{sc}^{RB} * {N}_{CRB}^{SSB} + offsetToCarrier )\end{matrix}}{{F}_{max}} + {k}_{ssb} + {N}_{sc}^{RB} * {N}_{CRB}^{SSB} + offsetToCarrier \qquad \{ Equation 8 ]$$

$$where q = 0 , 1 , 2 , … , {F}_{max} - 1 and$$

$$\frac{System bandwidth - ( {k}_{ssb} + {N}_{sc}^{RB} * {N}_{CRB}^{SSB} + offsetToCarrier )}{{F}_{max}} \geq Number of RE per unit SSB$$

In [Equation 8],

$${N}_{sc}^{RB}$$

means the number or subcarriers per RB, offsetToCarrier means a frequency gap between reference point A and a first PRB (e.g., PRB 0) for a BWP of a UE, N_{CRB}^{SSB} means an RB offset between the lowest frequency of an SSB and the first PRB, and k_{SSB} means a subcarrier offset from the lowest subcarrier 0 of CRB

$${N}_{CRB}^{SSB}$$

to subcarrier 0 of the SS/PBCH block. The number of REs per unit SSB may vary depending on numerology. For example, in NR with an SCS of 15 kHz, the number of REs per unit SSB may be 240 (20 RBs).

A start RB position

$${kB}_{CRB}^{ssb}$$

of a k-th SSB in a frequency domain may be determined as shown in [Equation 9] below.

$${kB}_{CRB}^{ssb} = q \frac{\begin{matrix}⌊ System bandwidth / {N}_{sc}^{RB} ⌋ - \\ ( {N}_{CRB}^{SSB} + ⌊ offsetToCarrier / {N}_{sc}^{RB} ⌋ )\end{matrix}}{{F}_{max}} + {N}_{CRB}^{SSB} + ⌊ offsetToCarrier / {N}_{sc}^{RB} ⌋ \qquad [ Equation 9 ]$$

$$where q = 0 , 1 , 2 , … , {F}_{max} - 1 and$$

$$\frac{⌊ System bandwidth / {N}_{sc}^{RB} ⌋ - ( {N}_{CRB}^{SSB} + ⌊ offsetToCarrier / {N}_{sc}^{RB} ⌋ )}{{F}_{max}}$$

### Number of RB Per Unit SSB

An SSB index may be determined in the same way as in an existing configuration. For example, as shown in FIG. 29, the SSB index may be determined sequentially in time order. The above-described q may mean a beam ID of an RIS or an NCR. The value of q may be added to a payload of a PBCH in the q-th SSB of the PBCH, or may be added to ι̅_{SSB} including information related to a value included in a payload of the PBCH of an SSB and the last bit value i_{SSB} of an SSB index for scrambling of DMRS of the PBCH. For example, the value of ι̅_{SSB} may be determined as shown in [Equation 10] below.

$${\overline{ι}}_{SSB} = {i}_{SSB} + {2}^{2} {n}_{{h}_{f}} + {2}^{3} q \qquad [ Equation 10 ]$$

In [Equation 10], n_{hf} means a half-frame index value and may have a value of 0 or 1.

In another embodiment, the value of ι̅_{SSB} may be determined as shown in [Equation 11].

$${\overline{ι}}_{SSB} = {i}_{SSB} + {2}^{2} q + {2}^{α} {n}_{hf} \qquad [ Equation 11 ]$$

In [Equation 11], α is determined based on Fₘₐₓ. In one embodiment, when the number of bits for representing q is 2, α=4.

The value of ι̅_{SSB} is not limited to the form of [Equation 10] or [Equation 11], but may be implemented in various forms. Accordingly, ι̅_{SSB} may be determined based on at least one of i_{SSB}, n_{hf}, q, or a parameter value required for configuration of SSBs multiplexed on a frequency domain.

A UE may determine the presence of q based on information received through a payload of a PBCH or through the value of ι̅_{SSB}. Accordingly, the UE may identify that Fₘₐₓ SSBs multiplexed on a frequency domain are configured based on q.

In an embodiment, Fₘₐₓ is set to 4 through RRC or MAC-CE and a case where q=2 is included in the payload in SSB0 may be included. In this case, q may be represented as 10 in binary. Accordingly, in order to represent that the SSB index is 0 and a third SSB in a frequency domain, i_{SSB}=00 may be set, and information indicating that q=3 may be included in the PBCH. Accordingly, 2 bits may be added to the payload of the PBCH.

In another embodiment, Fₘₐₓ is set to 4 through RRC or MAC-CE and information related to q may be included in ι̅_{SSB} for scrambling of a DMRS of a PBCH in SSB0. Accordingly, the SSB index is 0, a synchronization signal exists in a first half-frame, i_{SSB}=00, n_{hf}=0, and q=11 are set in binary to represent a third SSB in a frequency domain, and the setting may be expressed as [Equation 12] below.

$${i}_{SSB} = \underline{10} \overline{0} \underline{00} \qquad [ Equation 12 ]$$

In another embodiment, a most significant bit (MSB) of q is set in a payload of a PBCH, and a least significant bit (LSB) of q may be included in ι̅_{SSB} for scrambling of a DMRS of the PBCH. Conversely, the LSB of q may be included in the payload of the PBCH, and the MSB of q may be included in ι̅_{SSB} for scrambling of the DMRS of the PBCH. Accordingly, a UE may determine q in a q_{MSB}q_{LSB} form by identifying the payload of the PBCH and ι̅_{SSB} for scrambling. Additionally, rate matching may be performed on a total payload size of the PBCH in consideration of resources of the PBCH.

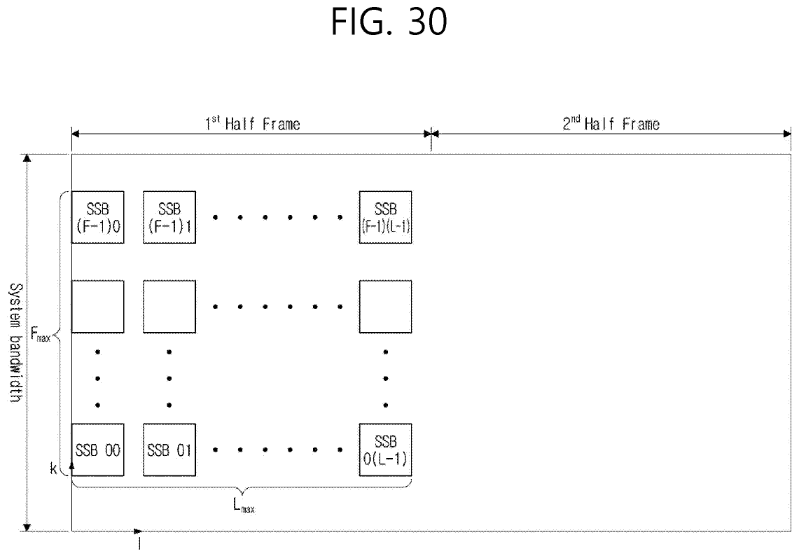

FIG. 30 illustrates an example of a third SSB transmission type according to an embodiment of the present disclosure. Referring to FIG. 30, a base station may allocate SSBs having different IDs respectively in consideration of backward compatibility.

For backward compatibility, parameters used to configure an SSB in LTE or NR may be used. In an embodiment, Lₘₐₓ,

$${N}_{CRB}^{SSB} ,$$

k_{SSB}, etc. described above may be used. a third SSB transmission type is different from a second SSB transmission type in that different SSB indexes are assigned to respective SSBs. That is, a base station may perform beam management using an SSB id, and SSD ids of the SSBs may be determined as shown in [Equation 13] below.

$$SSD id = {2}^{n} \times q + {\tilde{ι}}_{SSB} or q + {2}^{n} \times {\tilde{ι}}_{SSB} , \\ where {\tilde{ι}}_{SSB} = {i}_{SSB}^{DMRS} {i}_{SSB}^{PBCH} or {\tilde{ι}}_{SSB} = {i}_{SSB}^{PBCH} {i}_{SSB}^{DMRS} \qquad [ Equation 13 ]$$

In [Equation 13], \tilde{ι}_{SSB} means an SSB id without considering frequency multiplexing,

$${i}_{SSB}^{DMRS}$$

means an MSB or LSB part of \tilde{ι}_{SSB} used for scrambling of a DMRS of a PBCH, and

$${i}_{SSB}^{PBCH}$$

mean an MSB or LSB part of \tilde{ι}_{SSB} in a payload of a PBCH.

An SSB id may be included in ι̅_{SSB} used for a payload of a PBCH and scrambling of a DMRS of a PBCH by being divided based on M_{ssb}. In an embodiment, an MSB or LSB of the number of m_{ssb} bits of the SSB id is included in the payload of the PBCH, and bits except the M_{ssb} bits from the number of SSB id bits may be included in ι̅_{SSB} used for scrambling of the DMRS of the PBCH. Conversely, m_{ssb} bits of the SSB id may be included in ι̅_{SSB} used for scrambling of the DMRS of the PBCH, and bits except the M_{ssb} bits from the number of SSB id bits may be included in the payload of the PBCH.

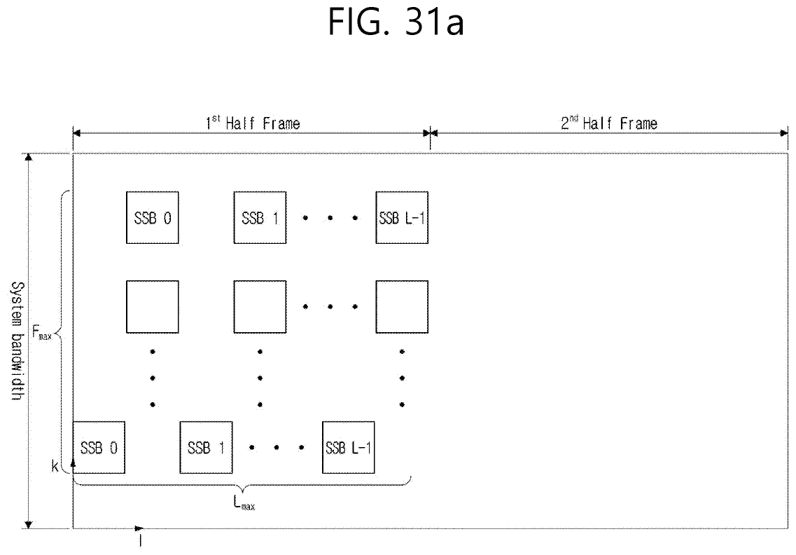

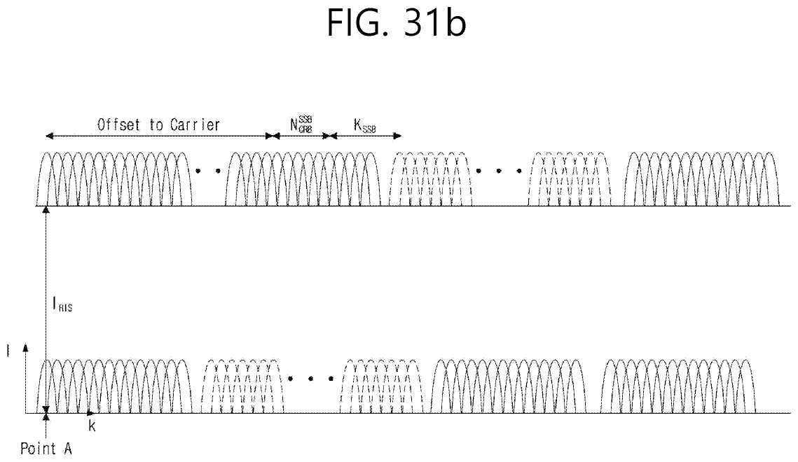

FIGS. 31a and 31b illustrate examples of a fourth SSB transmission type according to an embodiment of the present disclosure. Referring to FIGS. 31A and 31B, a base station may allocate frequency-multiplexed SSBs in a different time interval from existing SSBs without considering frequency multiplexing.

Unlike a second SSB transmission type and a third SSB transmission type, frequency-multiplexed SSBs are allocated to a different time interval from existing SSBs. Such a structure may be utilized in various forms. In an embodiment, a fourth SSB transmission type may be set to separate SSBs for configuration of an RIS or an NCR and SSBs not considering the RIS and the NCR into time intervals. Through this, a UE may be set to perform a two-step initial access. In an embodiment, a UE may perform initial access with a base station based on existing SSBs (q=0), and may perform initial access for an RIS or an NCR based on remaining SSBs (q>0). For this purpose, frequency-multiplexed SSBs may be allocated after IRIS OFDM symbols from the existing SSBs, respectively. That is, each frequency-multiplexed SSB may be allocated to a time interval shifted by a pre-configured value (e.g., l_{RIS}) from a time interval in which non-frequency-multiplexed SSBs are allocated.

In an embodiment, in a case where l_{RIS}=7 in a fourth SSB transmission type, parameter values as shown in [Table 9] may be set by RRC or MAC CE.

TABLE 9

| | | OFDM symbol number |
|---|---|---|
| | | relativetothestartofanSS/ |
| | OFDM symbol number | PBCHblockformulti- |
| Channel or | relativetothestartofanSS/ | frequencySSBs |
| signal | PBCHblock | (for RIS SSB or NCR SSB) |
| PSS | 0 | 7 |
| SSS | 2 | 9 |
| Set to 0 | 0 | 7 |
| | 2 | 19 |
| PBCH | 1, 3 | 8, 10 |
| | 2 | 9 |
| DM-RS for | 1, 3 | 8, 10 |
| PBCH | 2 | 9 |

That is, as shown in FIG. 31B, SSBs for an RIS or an NCR may be allocated from symbols after l_{RIS} symbols compared to an OFDM symbol number related to a starting point of an existing SS/PBCH block through RRC or MAC CE configuration, and a PSS, an SSS, set to 0, a PBCH may be allocated.

The above-described first SSB transmission type to fourth SSB transmission type may inefficiently use communication resources because a plurality of SSBs are allocated to all time intervals. Accordingly, in a case depending on a situation of a base station, a method of changing the number of frequency-multiplexed SSBs may be considered.

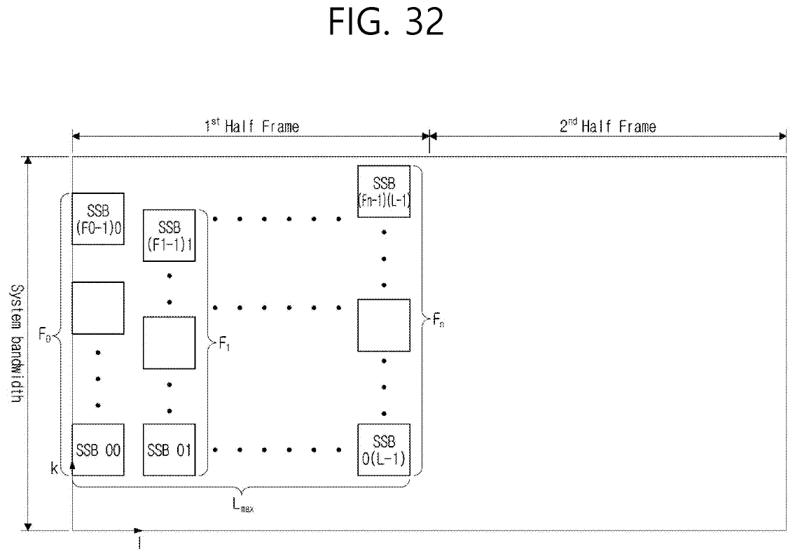

FIG. 32 illustrates an example of a fifth SSB transmission type according to an embodiment of the present disclosure. Referring to FIG. 32, a base station may change the number of frequency-multiplexed SSBs depending on a situation.

The base station may determine Fₗ₁, which is the number of frequency-multiplexed SSBs included in an l-th time interval, differently, respectively. In an embodiment, in a case where Lₘₐₓ=n+1, that is, the base station may determine F₀, F₁, . . . , Fₙ, which are numbers of SSBs to be frequency-multiplexed in time domains of existing SSBs. In this case,

$${k}_{CRB}^{ssb} ,$$

which is a start position of an SSB included in an (l+1)-th time interval and allocated to a q-th on a frequency domain, may be determined based on a system bandwidth and F₁ as shown in [Equation 14] below.

$${k}_{CRB}^{ssb} = q \frac{\begin{matrix}System bandwidth - \\ ( {k}_{ssb} + {N}_{sc}^{RB} * {N}_{CRB}^{SSB} + offsetToCarrier )\end{matrix}}{{F}_{l}} + {k}_{ssb} + {N}_{sc}^{RB} * {N}_{CRB}^{SSB} + offsetToCarrier where q = 0 , 1 , 2 , … , {F}_{l} - 1 \qquad [ Equation 14 ]$$

In [Equation 14],

$${N}_{sc}^{RB}$$

means the number of subcarriers per RB, offsetToCarrier means a frequency gap between a reference point A and a first PRB (e.g., PRB 0) for a BWP of a UE,

$${N}_{CRB}^{SSB}$$

means a resource block offset between a lowest frequency of an SSB and a first PRB, and k_{SSB} means a subcarrier offset from a lowest subcarrier 0 of a CRB

$${N}_{CRB}^{SSB}$$

to subcarrier 0 of an SS/PBCH block. Herein, q and Fₖ may be configured through RRC or MAC-CE.

In addition, a configuration of on-off transmission of frequency-multiplexed SSBs in each time interval may be considered. That is, based on Lₘₐₓ, allocation of frequency-multiplexed SSBs may be configured in an on-off form in each time interval in which SSBs are allocated. Information on on-off may be delivered through RRC or MAC-CE and may be indicated in a bitmap format.

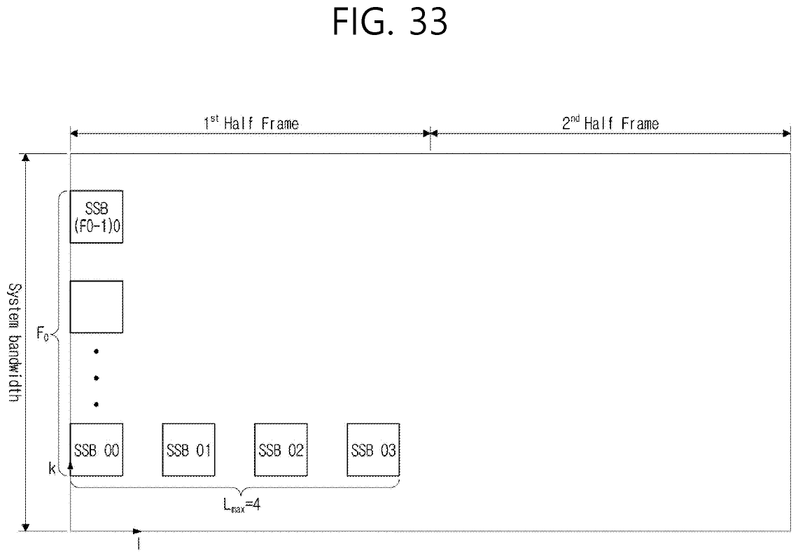

In an embodiment, in a case where Lₘₐₓ=4, in a case where frequency-multiplexed SSBs are allocated only to a first time interval, it may be indicated in a form of ‘0001’. The bitmap format may be indicated through an IE and may be delivered to a UE in a form of an information element IE. In an embodiment, it may be configured through an information element (IE) named Multiple SSB_FₘₐₓOn-OFF, and it may be configured as Multiple SSB_FₘₐₓOn-OFF=0001. In this case, SSBs may be allocated as shown in FIG. 33.

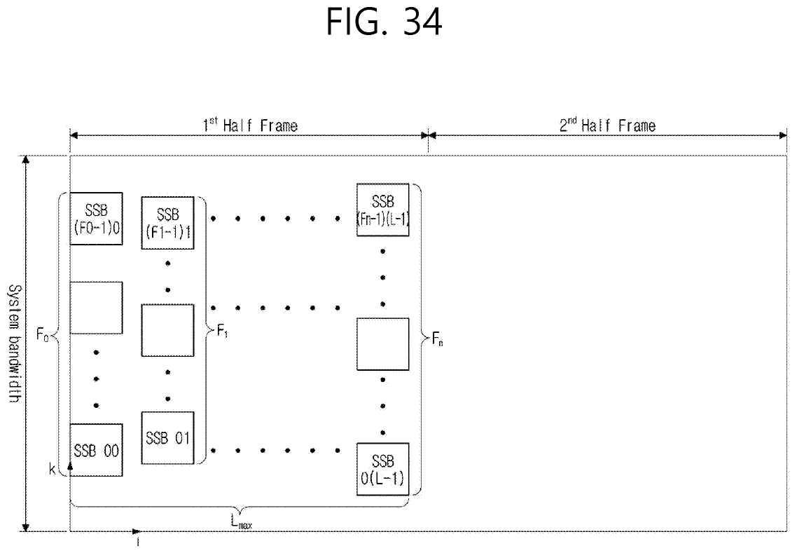

FIG. 34 illustrates an example of a sixth SSB transmission type according to an embodiment of the present disclosure. Referring FIG. 34, A base station may transmit frequency-multiplexed SSBs based on a BWP.

As shown in FIG. 34, a plurality of SSBs may be allocated based on a BWP. Similar to a fifth SSB transmission type, based on a BWP, a base station may determine Fₗ₁, which is the number of frequency-multiplexed SSBs included in an l-th time interval, differently, respectively. In an embodiment, in a case where Lₘₐₓ=n+1, that is, the base station may determine F₀, F₁, . . . , Fₙ, which are numbers of SSBs to be frequency-multiplexed in time intervals of existing SSBs. In this case,

$${k}_{CRB}^{ssb} ,$$

which is a start position of an SSB included in an (l+1)-th time interval and allocated to a q-th on a frequency domain, may be determined based on a system bandwidth and Fₖ as shown in [Equation 15] below.

$${k}_{CRB}^{ssb} = q \frac{S ystem bandwidth - ( {k}_{ssb} + offsetToCarrier )}{{F}_{l}} where q = 0 , 1 , 2 , … , {F}_{l} - 1 \qquad [ Equation 15 ]$$

That is, in a case where SSBs are allocated based on a BWP (e.g., NR), starting points in which SSBs are allocated may all be changed.

The fifth SSB transmission type in which a base station allocates SSBs based on a BWP may cause a conflict with an existing SSB configuration. In a case where the fifth SSB transmission type conflicts with an existing SSB configuration, allocation of SSBs may be determined based on a priority of the conflict. In an embodiment, in a case where the fifth SSB transmission type conflicts with an existing SSB configuration, for backward compatibility, a UE may not expect a configuration of frequency-multiplexed SSBs using Fₖ. On the other hand, in a case where backward compatibility is not considered, a UE may determine based on

$${k}_{CRB}^{ssb}$$

based on [Equation 15], and may derive a reference point A using

$${k}_{CRB}^{ssb} .$$

Based on the above-described SSB transmission types, a base station may multiplex a plurality of SSBs on a frequency domain and may transmit them to a UE. Hereinafter, a procedure in which a base station controls beams through an RIS or an NCR will be described.

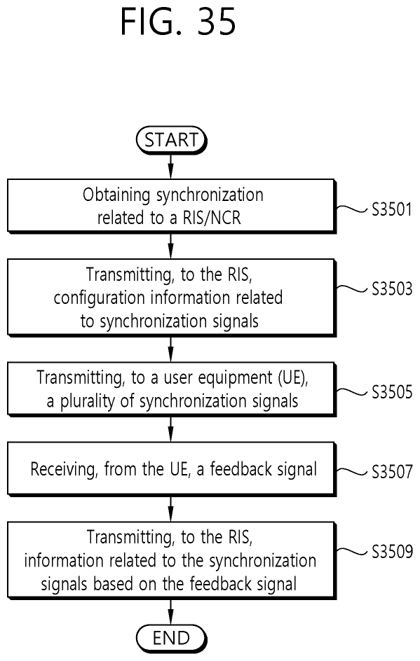

FIG. 35 illustrates an example of a procedure in which a base station transmits a plurality of synchronization signals multiplexed in a frequency domain through RIS or NCR according to an embodiment of the present disclosure. Referring to FIG. 35, a base station may control an RIS and an NCR to transmit synchronization signals by applying different beams to respective ones of a plurality of synchronization signals. Hereinafter, for convenience of description, a procedure of transmitting synchronization signals through an RIS or an NCR will be described, but it may be equally applied to a device capable of changing beams such as a repeater.

Referring to FIG. 35, in step S3501, a base station obtains synchronization with an RIS or an NCR. The base station may obtain synchronization through an initial access procedure to control the NCR. In addition, in a case where the RIS is controlled by the base station through a wireless controller, a synchronization procedure between the wireless controller and the base station may be performed. Through the initial access procedure, the base station may perform a synchronization procedure related to a reference point A to control the RIS or the NCR.

In step S3503, a base station transmits a configuration related to a synchronization signals to an RIS or an NCR. The synchronization signals may be transmitted in a form included in an SSB. The base station may set different beams to transmit frequency-multiplexed SSBs. Accordingly, for beam management, an RIS or an NCR may receive information related to an SSB transmission type from the base station. The RIS or the NCR that has received information related to an SSB transmission type from the base station may change an RIS reflection pattern or change a transmission beam of the NCR in accordance with an SSB transmission period of the base station.

In step S3505, a base station transmits a plurality of synchronization signals to a UE. The plurality of synchronization signals may be frequency-multiplexed on a frequency domain and may be transmitted. The plurality of synchronization signals may be transmitted in a form included in an SSB. Accordingly, the plurality of synchronization signals may be allocated to radio resources based on the above-described first SSB transmission type to sixth SSB transmission type, and different beam configurations may be applied to respective synchronization signals.

In step S3507, a base station receives a feedback signal from a UE. The UE may detect at least one synchronization signal among the frequency-multiplexed synchronization signals. The UE transmits a feedback signal including information related to the detected synchronization signal to the base station. The base station may identify which synchronization signal has been detected based on the feedback signal. A method of indicating the detected synchronization signal may be explicitly or implicitly indicated. In an embodiment, the synchronization signals may be transmitted in a form included in an SSB, and the feedback signal may be transmitted based on an occasion related to the SSB. In this case, the base station may identify an index of an SSB including the detected synchronization signal based on an occasion in which the feedback signal is delivered.

In step S3509, a base station transmits information related to a synchronization signal to an RIS or an NCR based on a feedback signal. The base station may determine a beam to be used by the base station and the RIS or the NCR based on the detected synchronization signal. Accordingly, the base station may deliver a beam to be used by the RIS or the NCR by delivering information related to the detected synchronization signal. The information related to the synchronization signal may be delivered in a form of an index of an SSB including the synchronization signal as described above. Thereafter, the base station may perform communication with a UE by using a beam determined based on the detected synchronization signal.

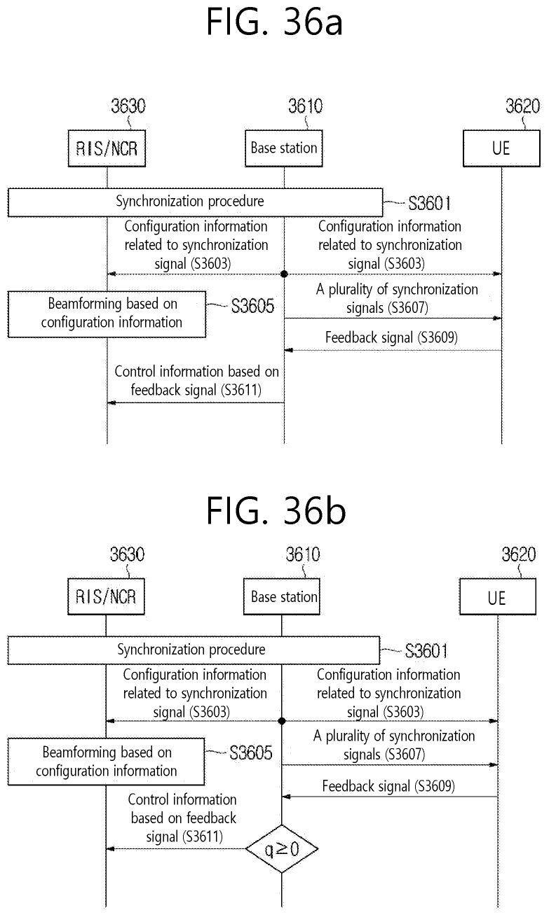

FIGS. 36a and 36b illustrate examples of signaling procedures for transmitting synchronization signals multiplexed in a frequency domain according to an embodiment of the present disclosure. Referring to FIGS. 36a and 36b, a base station 3610 and a UE 3620 may perform communication based on frequency-multiplexed synchronization signals by using an RIS or an NCR 3630. Hereinafter, for convenience of description, it is assumed that the base station 3610 uses the RIS 3630.

Referring to FIGS. 36a and 36b, in step S3601, the RIS 3630 performs a synchronization procedure with the base station 3610. Based on the synchronization procedure, the base station 3610 and the RIS 3630 may obtain synchronization of a reference point A or a center frequency. If the RIS 3630 is controlled with an RIS 3630 controller and the RIS 3630 controller performs communication with the base station 3610 through wireless, a synchronization procedure between the RIS 3630 controller and the base station 3610 may be required.

In step S3603, the base station 3610 transmits information related to synchronization signals to the RIS 3630 and the UE 3620. The information related to synchronization signals may be transmitted in a unicast format or may be transmitted in a broadcast format. In a case where synchronization signals are transmitted included in an SSB, the information related to synchronization signals may include information related to an SSB transmission type. In addition, the information related to synchronization signals may include the number of SSBs frequency-multiplexed in a time interval (e.g., Fₘₐₓ or Fₖ) or the number of SSBs allocated to one frame on a domain axis (e.g., Lₘₐₓ). Additionally, in a case where whether frequency multiplexing is performed is indicated as on-off, the information related to synchronization signals may include a configuration related to on-off of frequency-multiplexed SSBs (e.g., Multiple SSB_FₘₐₓOn-OFF).

In step S3605, the RIS 3630 performs beamforming based on received configuration information. The RIS 3630 may perform beamforming based on a transmission period of an SSB of the base station 3610 based on the received configuration information. Accordingly, passive elements of the RIS 3630 may be controlled by the base station 3610 based on the transmission period.

In step S3607, the base station 3610 transmits a plurality of synchronization signals. The synchronization signals may be transmitted included in an SSB. Accordingly, the base station 3610 may transmit frequency-multiplexed synchronization signals based on an SSB transmission type. In an embodiment, the base station 3610 may allocate SSBs using a configuration in which SSBs are not frequency-multiplexed, and may allocate a plurality of SSBs frequency-multiplexed in each time interval in which respective SSBs are allocated. In another embodiment, the base station 3610 may allocate SSBs using an existing configuration, and may allocate frequency-multiplexed SSBs by shifting a plurality of SSBs by a certain time offset in each time interval in which respective SSBs are allocated. The base station 3610 may transmit a plurality of SSBs based on beamforming of respective frequency-multiplexed SSBs.

In step S3609, the UE 3620 transmits a feedback signal to the base station 3610. The UE 3620 may detect at least one synchronization signal among a plurality of synchronization signals. In a case where synchronization signals are transmitted included in an SSB, PSS and SSS included in a received SSB may be detected and a physical cell ID (PCI) may be derived. In addition, through decoding of a payload of a PBCH included in the SSB and a DMRS of the PBCH, an SSB id and a q value indicating an order of an SSB on a frequency domain may be obtained. Accordingly, the feedback signal may include information related to an SSB resource indicator (RI) obtained by the UE 3620 and a corresponding q value. A method of transmitting the feedback signal is not limited to a specific method. In an embodiment, the feedback signal may be delivered to the base station 3610 through the RIS 3630. In another embodiment, the UE 3620 may transmit the feedback signal through a pre-configured channel connected with the base station 3610 without using the RIS 3630.

In step S3611, the base station 3610 transmits control information to the RIS 3630 based on a feedback signal. The base station 3610 may deliver an SSB RI received from the UE 3620 and a corresponding q value to the RIS 3630. To specify the RIS 3630 to be transmitted, an RNTI for identification of the RIS 3630 may be configured. An RNTI for the RIS 3630 may be configured through RRC or MAC-CE.

Step S3611 may be omitted or selectively performed depending on a case. In an embodiment, as shown in FIG. 36b, in a case where q >0, the base station 3610 may transmit an SSB RI and a corresponding q to the RIS 3630 through an RIS 3630 control link. In another embodiment, if q=0, a response for q=0 may be transmitted to the RIS 3630 through the RIS 3630 control link.

In FIGS. 36a and 36b, the above-described SSB RI may be delivered in various forms and is not limited to a specific form. In an embodiment, the base station 3610 may transmit to the UE 3620 by including in configuration information in a bitmap format information on resources to which SSBs are transmitted. The UE 3620 may transmit a feedback signal in a bitmap format to the base station 3610 through the strongest beam in the resources to which the SSBs are transmitted. The base station 3610 may deliver the feedback signal in a bitmap format again to the RIS 3630.

Specifically, the base station 3610 may deliver a value of ‘1110’ to the UE 3620 by using an ‘ssb-PositionsInBurst’ IE. The UE 3620 may receive SSBs of a first time interval to a third time interval. Thereafter, the UE 3620 may set a response to ‘ssb-PositionsInBurst’ to ‘1000’, and the base station 3610 may recognize that the strongest signal is delivered in a first SSB. Thereafter, the base station 3610 may deliver, through ‘1000’, information that the strongest signal is received in a first time interval to the RIS 3630.

In another embodiment, the UE 3620 may deliver to the base station 3610 in a form in which time intervals in which an SSB is detected and q information are combined. That is, the UE 3620 may feedback to the base station 3610 that a q-th SSB is detected in an l-th time interval in a form of qₗ, which is one parameter, and the base station 3610 may deliver a feedback signal to the RIS. qₗ may be delivered as a combination of l and q and is not limited to a specific method. In an embodiment, qₗ may be delivered in a form of an index using a table. In another embodiment, the UE 3620 may be delivered to the base station 3610 by using a parameter in which an l value of qₗ is used as an MSB and q of qₗ is used as an LSB. In still another embodiment, the UE 3620 may be delivered to the base station 3610 by using a parameter in which q of qₗ is used as an MSB and the l value of qₗ is used as an LSB.

The above-described method describes a procedure in which an RIS is used, but is not limited thereto. In a case where not only an RIS but also an NCR, a repeater, etc. are used, it may be equally applied. In addition, the above-described method of allocating a plurality of SSBs is not limited to SSBs. Therefore, the above-described method of allocating SSBs may be applied to reference signals (e.g., CSI-RS, etc.). Therefore, it may also be used in a beam measurement procedure using a CSI-RS. Therefore, a placement structure of frequency-multiplexed SSBs may be applied to an initial access and a beam reporting procedure regardless of reference signals.

By using the above-described method in the present disclosure, a frequency may be efficiently used in a measurement and reporting procedure related to a plurality of beams. Therefore, a time for measuring beams may be shortened and efficient communication may be performed. In addition, not only a measurement procedure related to beams but also, in a case where channel measurement is performed in a plurality of frequency bands, a frequency multiplexing method described in the present disclosure may be used.

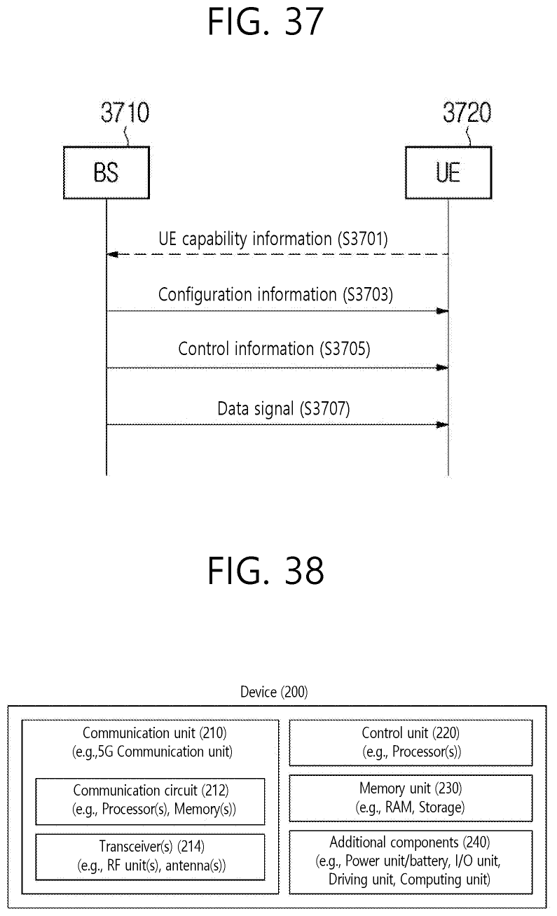

FIG. 37 illustrates an example of signaling between a base station and UE according to an embodiment of the present disclosure. The procedure of FIG. 37 may be applied to various embodiments of the present disclosure but is for convenience of description and is not to be construed as being limited to the procedure of FIG. 37.

The base station may mean a generic term for an object that performs transmission and reception of data with a UE. For example, the base station may be a concept including one or more transmission points (TPs), one or more transmission and reception points (TRPs), etc. (Here, UE/BS are only examples and may be replaced with various devices such as those described in X1 to X9 described below.) In addition, a TP and/or a TRP may include a panel of a base station, a transmission, reception unit, etc. In addition, some of steps described in FIG. 37 may be merged or may be omitted.

In step S3710, the UE may transmit UE capability information to the base station. In an embodiment, the UE capability information may include information on whether the UE can perform methods described in the above-described proposed methods (e.g., the first SSB transmission type to the sixth SSB transmission type, signaling of a base station and a UE, etc.) (e.g., transmission mode information supported by a UE). In a case where the UE capability information is predefined/promised, the step may also be omitted.

For example, an operation in which the UE in step S3710 transmits the UE capability information to the base station may be implemented by devices of FIG. 38 to FIG. 44 described below. In an embodiment, referring to FIG. 38, one or more processors 212 may control one or more transceivers 214 and/or one or more memories 230 to transmit the UE capability information, and one or more transceivers 214 may transmit the UE capability information from the UE.

In step S3703, the UE may receive configuration information from the base station. The configuration information may include system information (SI) and/or scheduling information and/or configuration related to CSI and/or PUCCH/PUSCH-Config and/or PDCCH/PDSCH-Config, etc. In an embodiment, the configuration information may be received through a higher layer such as RRC or MAC CE.

For example, an operation in which the UE in step S3703 receives the configuration information from the base station may be implemented by devices of FIG. 38 to FIG. 44 described below. In an embodiment, referring to FIG. 38, one or more processors 212 may control one or more transceivers 214 and/or one or more memories 230 to receive the configuration information, and one or more transceivers 214 may receive the configuration information from the base station.

In step S3705, the UE may receive control information from the base station. In an embodiment, the control information may be received through a control channel (e.g., a PDCCH). In an embodiment, the control information may be DCI. For example, above-described information related to an OAM state may also be configured through the DCI.

For example, an operation in which the UE in step S3703 receives the control information from the base station may be implemented by devices of FIG. 38 to FIG. 44 described below. In an embodiment, referring to FIG. 38, one or more processors 212 may control one or more transceivers 214 and/or one or more memories 230 to receive the control information, and one or more transceivers 214 may receive the control information from the base station.

In step S3707, the UE may perform transmission and reception of data with the base station. In a case where the data is downlink data, the data may be received from the base station through a downlink channel (e.g., a PDCCH/PDSCH). In a case where the data is uplink data, the data may be transmitted to the base station through an uplink channel (e.g., a PUCCH/PUSCH). The data may be scheduled based on configuration information/control information received in steps S3703 and S3705.

For example, the UE may receive a RS related to CSI (e.g., a CSI-RS) from the base station, measure it, and report CSI to the base station. In this case, the data may include CSI reporting. The CSI reporting may include a PMI/RI, etc., and the PMI may be derived based on a codebook.

An operation in which the UE in the above-described step S3707 transmits and receives the data with the base station may be implemented by devices of FIG. 38 to FIG. 44 described below. In an embodiment, referring to FIG. 38, one or more processors 212 may control one or more transceivers 214 and/or one or more memories 230 to transmit and receive the data, and one or more transceivers 214 may perform to transmit and receive the data with a network side.

As described above, the above-described base station/UE signaling and the above-described proposed methods (e.g., the first SSB transmission type to the sixth SSB transmission type, procedures of FIG. 26 and FIG. 27, etc.) may be implemented by devices of FIG. 38 to FIG. 44 described below. In an embodiment, the base station may correspond to a first wireless device, the UE may correspond to a second wireless device.

Therefore, they may be processed by one or more processors (e.g., 212) of FIG. 38 to FIG. 44, and the above-described base station/UE signaling and operations may also be stored in a memory (e.g., 230) in a form of an instruction/program (e.g., instruction, executable code) to operate at least one processor (e.g., 212) of FIG. 38 to FIG. 44.

Examples of use of a wireless device to which various embodiments of the present disclosure are applied are described below.

FIG. 38 illustrates an example of a wireless device applicable to the present disclosure. The wireless device may be implemented in various forms based on use cases/services (see FIG. 1).

Referring to FIG. 38, a wireless device 200 may correspond to the wireless devices 200 of FIG. 2 and include various elements, components, units/portions and/or modules. For example, the wireless device 200 may include a communication unit 210, a control unit (controller) 220, a memory unit (memory) 230 and additional components 240. The communication unit may include a communication circuit 212 and a transceiver(s) 214. For example, the communication circuit 212 may include one or more processors 202 and/or one or more memories 204 of FIG. 2. For example, the transceiver(s) 214 may include one or more transceivers 206 and/or one or more antennas 208 of FIG. 2. The control unit 220 may be electrically coupled with the communication unit 210, the memory unit 230 and the additional components 240 to control overall operation of the wireless device. For example, the control unit 220 may control electrical/mechanical operation of the wireless device based on a program/code/instruction/information stored in the memory unit 230. In addition, the control unit 220 may transmit the information stored in the memory unit 230 to the outside (e.g., another communication device) through the wireless/wired interface using the communication unit 210 or store information received from the outside (e.g., another communication device) through the wireless/wired interface using the communication unit 210 in the memory unit 230.

The additional components 240 may be variously configured according to the types of the wireless devices. For example, the additional components 240 may include at least one of a power unit/battery, an input/output unit, a driving unit or a computing unit. Without being limited thereto, the wireless device may be implemented in the form of the robot (FIG. 1, 100 a), the vehicles (FIGS. 1, 100 b-1 and 100 b-2), the XR device (FIG. 1, 100 c), the hand-held device (FIG. 1, 100 d), the home appliance (FIG. 1, 100 e), the IoT device (FIG. 1, 100 f), a digital broadcast terminal, a hologram apparatus, a public safety apparatus, an MTC apparatus, a medical apparatus, a Fintech device (financial device), a security device, a climate/environment device, an AI server/device (FIG. 1, 400), the base station (FIG. 1, 200), a network node, etc. The wireless device may be movable or may be used at a fixed place according to use example/service.

In FIG. 38, various elements, components, units/portions and/or modules in the wireless device 200 may be coupled with each other through wired interfaces or at least some thereof may be wirelessly coupled through the communication unit 210. For example, in the wireless device 200, the control unit 220 and the communication unit 210 may be coupled by wire, and the control unit 220 and the first unit (e.g., 230 or 240) may be wirelessly coupled through the communication unit 210. In addition, each element, component, unit/portion and/or module of the wireless device 200 may further include one or more elements. For example, the control unit 220 may be composed of a set of one or more processors. For example, the control unit 220 may be composed of a set of a communication control processor, an application processor, an electronic control unit (ECU), a graphic processing processor, a memory control processor, etc. In another example, the memory unit 130 may be composed of a random access memory (RAM), a dynamic RAM (DRAM), a read only memory (ROM), a flash memory, a volatile memory, a non-volatile memory and/or a combination thereof.

Hereinafter, an example of implementing FIG. 38 will be described in detail with reference to the drawings.

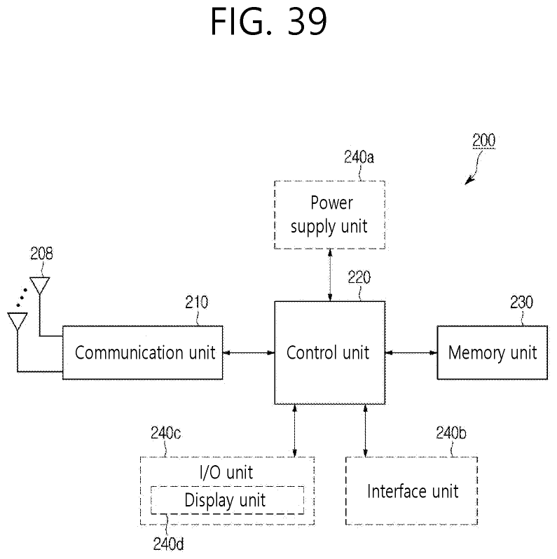

FIG. 39 illustrates an example of a hand-held device applicable to the present disclosure. The hand-held device may include a smartphone, a smart pad, a wearable device (e.g., a smart watch or smart glasses), and a hand-held computer (e.g., a laptop, etc.). The hand-held device may be referred to as a mobile station (MS), a user terminal (UT), a mobile subscriber station (MSS), a subscriber station (SS), an advanced mobile station (AMS) or a wireless terminal (WT).

Referring to FIG. 39, the hand-held device 200 may include an antenna unit (antenna) 208, a communication unit (transceiver) 210, a control unit (controller) 220, a memory unit (memory) 230, a power supply unit (power supply) 240 a, an interface unit (interface) 240 b, and an input/output unit 240 c. An antenna unit (antenna) 208 may be part of the communication unit 210. The blocks 210 to 230/240 a to 240 c of FIG. 39 may correspond to the blocks 210 to 230/240 of FIG. 38, respectively.

The communication unit 210 may transmit and receive signals (e.g., data, control signals, etc.) to and from other wireless devices or base stations. The control unit 220 may control the components of the hand-held device 200 to perform various operations. The control unit 220 may include an application processor (AP). The memory unit 230 may store data/parameters/program/code/instructions necessary to drive the hand-held device 200. In addition, the memory unit 230 may store input/output data/information, etc. The power supply unit 240 a may supply power to the hand-held device 200 and include a wired/wireless charging circuit, a battery, etc. The interface unit 240 b may support connection between the hand-held device 200 and another external device. The interface unit 240 b may include various ports (e.g., an audio input/output port and a video input/output port) for connection with the external device. The input/output unit 240 c may receive or output video information/signals, audio information/signals, data and/or user input information. The input/output unit 240 c may include a camera, a microphone, a user input unit, a display 240 d, a speaker and/or a haptic module.

For example, in case of data communication, the input/output unit 240 c may acquire user input information/signal (e.g., touch, text, voice, image or video) from the user and store the user input information/signal in the memory unit 230. The communication unit 210 may convert the information/signal stored in the memory into a radio signal and transmit the converted radio signal to another wireless device directly or transmit the converted radio signal to a base station. In addition, the communication unit 210 may receive a radio signal from another wireless device or the base station and then restore the received radio signal into original information/signal. The restored information/signal may be stored in the memory unit 230 and then output through the input/output unit 240 c in various forms (e.g., text, voice, image, video and haptic).

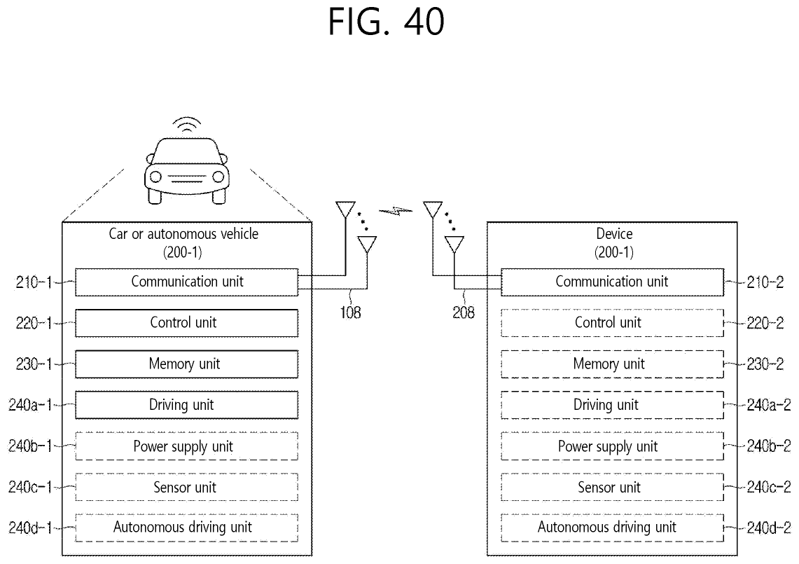

FIG. 40 illustrates an example of a car or an autonomous driving vehicle applicable to the present disclosure. The car or the autonomous driving vehicle may be implemented as a mobile robot, a vehicle, a train, a manned/unmanned aerial vehicle (AV), a ship, etc.

Referring to FIG. 40, the car or autonomous driving vehicle 200-1 may include an antenna unit (antenna) 208-1, a communication unit (transceiver) 210-1, a control unit (controller) 220-1, a driving unit 240 a-1, a power supply unit (power supply) 240 b-1, a sensor unit 240 c-1, and an autonomous driving unit 240 d-1. The antenna unit 208-1 may be configured as part of the communication unit 210-1. The blocks 210-1/230-1/240 a-1 to 240 d-1 of FIG. 40 correspond to the blocks 210/230/240 of FIG. 38.

The communication unit 210-1 may transmit and receive signals (e.g., data, control signals, etc.) to and from external devices such as another vehicle, a base station (e.g., a base station, a road side unit, etc.), and a server. The control unit 220-1 may control the elements of the car or autonomous driving vehicle 200-1 to perform various operations. The control unit 220-1 may include an electronic control unit (ECU). The driving unit 240 a-1 may drive the car or autonomous driving vehicle 200-1 on the ground. The driving unit 240 a-1 may include an engine, a motor, a power train, wheels, a brake, a steering device, etc. The power supply unit 240 b-1 may supply power to the car or autonomous driving vehicle 200-1, and include a wired/wireless charging circuit, a battery, etc. The sensor unit 240 c-1 may obtain a vehicle state, surrounding environment information, user information, etc. The sensor unit 240 c-1 may include an inertial navigation unit (IMU) sensor, a collision sensor, a wheel sensor, a speed sensor, an inclination sensor, a weight sensor, a heading sensor, a position module, a vehicle forward/reverse sensor, a battery sensor, a fuel sensor, a tire sensor, a steering sensor, a temperature sensor, a humidity sensor, an ultrasonic sensor, an illumination sensor, a brake pedal position sensor, and so on. The autonomous driving sensor 240 d-1 may implement technology for maintaining a driving lane, technology for automatically controlling a speed such as adaptive cruise control, technology for automatically driving the car along a predetermined route, technology for automatically setting a route when a destination is set and driving the car, etc.

For example, the communication unit 210-1 may receive map data, traffic information data, etc. from an external server. The autonomous driving unit 240 d-1 may generate an autonomous driving route and a driving plan based on the acquired data. The control unit 220-1 may control the driving unit 240 a-1 (e.g., speed/direction control) such that the car or autonomous driving vehicle 200-1 moves along the autonomous driving route according to the driving plane. During autonomous driving, the communication unit 210-1 may aperiodically/periodically acquire latest traffic information data from an external server and acquire surrounding traffic information data from neighboring cars. In addition, during autonomous driving, the sensor unit 240 c-1 may acquire a vehicle state and surrounding environment information. The autonomous driving unit 240 d-1 may update the autonomous driving route and the driving plan based on newly acquired data/information. The communication unit 210-1 may transmit information such as a vehicle location, an autonomous driving route, a driving plan, etc. to the external server. The external server may predict traffic information data using AI technology or the like based on the information collected from the cars or autonomous driving vehicles and provide the predicted traffic information data to the cars or autonomous driving vehicles. When the device 220-2 is an autonomous driving vehicle, the device 220-2 may perform the same procedure as the car or the autonomous driving vehicle 200-1. In addition, when the device 220-2 is a base station or a roadside base station, the device 220-2 may transmit data, control signals, etc. to the car or the autonomous driving vehicle 200-1 through the communication unit 210-2.

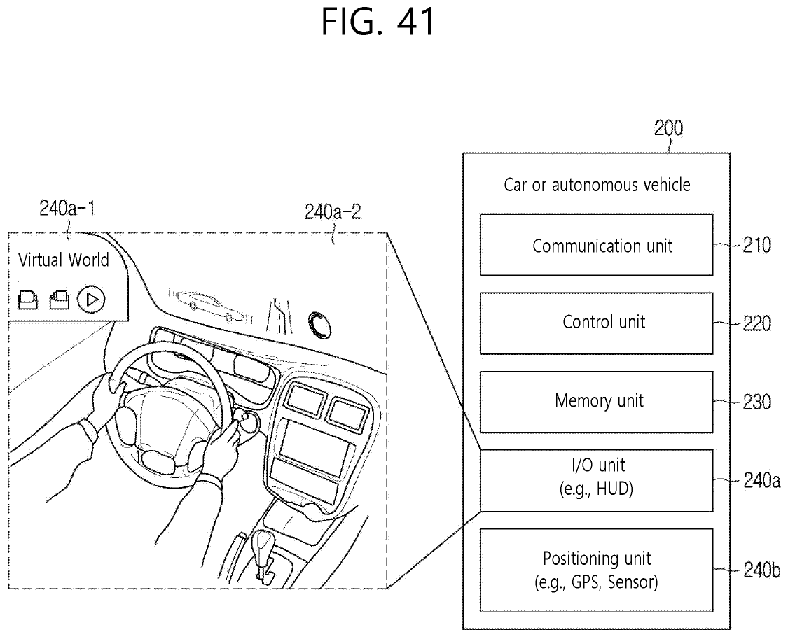

FIG. 41 illustrates an example of a car applicable to the present disclosure. The car may be implemented as a transportation means, a train, an aerial vehicle or a ship, etc. Referring to FIG. 41, the car 200 may include a communication unit (transceiver) 210, a control unit (controller) 220, a memory unit (memory) 230, an input/output unit 240 a and a positioning unit 240 b. Here, the blocks 210 to 230/240 a to 240 b of FIG. 41 may corresponding to the blocks 210 to 230/240 of FIG. 38.

The communication unit 210 may transmit and receive signals (e.g., data, control signals, etc.) to and from external devices such as another car or a base station. The control unit 220 may control the components of the car 200 to perform various operations. The memory unit 230 may store data/parameters/programs/code/instructions supporting the various functions of the car 200. The input/output unit 240 a may output AR/VR objects based on information in the memory unit 230. The input/output unit 240 a may include a HUD. The positioning unit 240 b may acquire the position information of the car 200. The position information may include absolute position information of the car 200, position information in a driving line, acceleration information, position information of neighboring vehicles, etc. The positioning unit 240 b may include a global positioning system (GPS) and various sensors.

For example, the communication unit 210 of the car 200 may receive map information, traffic information, etc. from an external server and store the map information, the traffic information, etc. in the memory unit 230. The positioning unit 240 b may acquire car position information through the GPS and the various sensors and store the car position information in the memory unit 230. The control unit 220 may generate a virtual object based on the map information, the traffic information, the car position information, etc., and the input/output unit 240 a may display the generated virtual object in a glass window (240 a-1 and 240 a-2). In addition, the control unit 220 may determine whether the car 200 is normally driven in the driving line based on the car position information. When the car 200 abnormally deviates from the driving line, the control unit 220 may display a warning on the glass window of the car through the input/output unit 240 a. In addition, the control unit 220 may broadcast a warning message for driving abnormality to neighboring cars through the communication unit 210. Depending on situations, the control unit 220 may transmit the position information of the car and information on driving/car abnormality to a related institution through the communication unit 210.

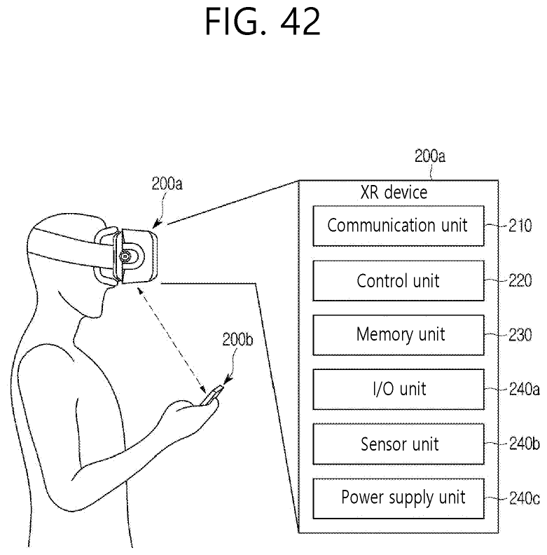

FIG. 42 illustrates an example of an XR device applicable to the present disclosure. The XR device may be implemented as a HMD, a head-up display (HUD) provided in a vehicle, a television, a smartphone, a computer, a wearable device, a home appliance, a digital signage, a vehicle, a robot, etc.

Referring to FIG. 42, the XR device 200 a may include a communication unit (transceiver) 210, a control unit (controller) 220, a memory unit (memory) 230, an input/output unit 240 a, a sensor unit 240 b and a power supply unit (power supply) 240 c. Here, the blocks 210 to 230/240 a to 240 c of FIG. 42 may correspond to the blocks 210 to 230/240 of FIG. 38, respectively.

The communication unit 210 may transmit and receive signals (e.g., media data, control signals, etc.) to and from external devices such as another wireless device, a hand-held device or a media server. The media data may include video, image, sound, etc. The control unit 220 may control the components of the XR device 200 a to perform various operations. For example, the control unit 220 may be configured to control and/or perform procedures such as video/image acquisition, (video/image) encoding, metadata generation and processing. The memory unit 230 may store data/parameters/programs/code/instructions necessary to drive the XR device 200 a or generate an XR object. The input/output unit 240 a may acquire control information, data, etc. from the outside and output the generated XR object. The input/output unit 240 a may include a camera, a microphone, a user input unit, a display, a speaker and/or a haptic module. The sensor unit 240 b may obtain an XR device state, surrounding environment information, user information, etc. The sensor unit 240 b may include a proximity sensor, an illumination sensor, an acceleration sensor, a magnetic sensor, a gyro sensor, an inertia sensor, a red green blue (RGB) sensor, an infrared (IR) sensor, a finger scan sensor, an ultrasonic sensor, an optical sensor, a microphone and/or a radar. The power supply unit 240 c may supply power to the XR device 200 a and include a wired/wireless charging circuit, a battery, etc.

For example, the memory unit 230 of the XR device 200 a may include information (e.g., data, etc.) necessary to generate an XR object (e.g., AR/VR/MR object). The input/output unit 240 a may acquire an instruction for manipulating the XR device 200 a from a user, and the control unit 220 may drive the XR device 200 a according to the driving instruction of the user. For example, when the user wants to watch a movie, news, etc. through the XR device 200 a, the control unit 220 may transmit content request information to another device (e.g., a hand-held device 200 b) or a media server through the communication unit 230. The communication unit 230 may download/stream content such as a movie or news from another device (e.g., the hand-held device 200 b) or the media server to the memory unit 230. The control unit 220 may control and/or perform procedures such as video/image acquisition, (video/image) encoding, metadata generation/processing, etc. with respect to content, and generate/output an XR object based on information on a surrounding space or a real object acquired through the input/output unit 240 a or the sensor unit 240 b.

In addition, the XR device 200 a may be wirelessly connected with the hand-held device 200 b through the communication unit 210, and operation of the XR device 200 a may be controlled by the hand-held device 200 b. For example, the hand-held device 200 b may operate as a controller for the XR device 200 a. To this end, the XR device 200 a may acquire three-dimensional position information of the hand-held device 200 b and then generate and output an XR object corresponding to the hand-held device 200 b.

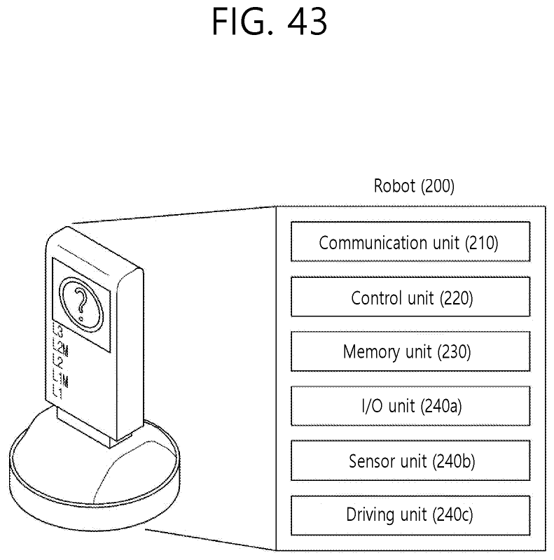

FIG. 43 illustrates an example of a robot applicable to the present disclosure. The robot may be classified into industrial, medical, household, military, etc. according to the purpose or field of use.

Referring to FIG. 43, the robot 200 may include a communication unit (transceiver) 210, a control unit (controller) 220, a memory unit (memory) 230, an input/output unit 240 a, sensor unit 240 b and a driving unit 240 c. Here, blocks 210 to 230/240 a to 240 c of FIG. 43 may correspond to the blocks 210 to 230/240 of FIG. 38, respectively.

The communication unit 210 may transmit and receive signals (e.g., driving information, control signals, etc.) to and from external devices such as another wireless device, another robot or a control server. The control unit 220 may control the components of the robot 200 to perform various operations. The memory unit 230 may store data/parameters/programs/code/instructions supporting various functions of the robot 200. The input/output unit 240 a may acquire information from the outside of the robot 200 and output information to the outside of the robot 200. The input/output unit 240 a may include a camera, a microphone, a user input unit, a display, a speaker and/or a haptic module. The sensor unit 240 b may obtain internal information, surrounding environment information, user information, etc. of the robot 200. The sensor unit 240 b may include a proximity sensor, an illumination sensor, an acceleration sensor, a magnetic sensor, a gyro sensor, an inertia sensor, an infrared (IR) sensor, a finger scan sensor, an ultrasonic sensor, an optical sensor, a microphone and/or a radar. The driving unit 240 c may perform various physical operations such as movement of robot joints. In addition, the driving unit 240 c may cause the robot 200 to run on the ground or fly in the air. The driving unit 240 c may include an actuator, a motor, wheels, a brake, a propeller, etc.

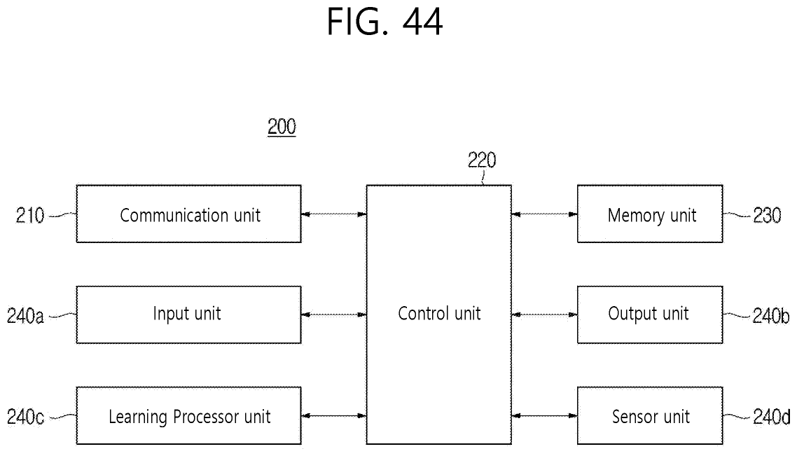

FIG. 44 illustrates an example of artificial intelligence (AI) device applicable to the present disclosure.

The AI device may be implemented as fixed or movable devices such as a TV, a projector, a smartphone, a PC, a laptop, a digital broadcast terminal, a tablet PC, a wearable device, a set-top box (STB), a radio, a washing machine, a refrigerator, a digital signage, a robot, a vehicle, or the like.

Referring to FIG. 44, the AI device 200 may include a communication unit (transceiver) 210, a control unit (controller) 220, a memory unit (memory) 230, an input/output unit 240 a/240 b, a leaning processor unit (learning processor) 240 c and a sensor unit 240 d. The blocks 210 to 230/240 a to 240 d of FIG. 44 may correspond to the blocks 210 to 230/140 of FIG. 38, respectively.

The communication unit 210 may transmit and receive wired/wireless signals (e.g., sensor information, user input, learning models, control signals, etc.) to and from external devices such as another AI device (e.g., FIG. 1, 100 a to 100 f or 120) or the AI server (FIG. 1, 100g) using wired/wireless communication technology. To this end, the communication unit 210 may transmit information in the memory unit 230 to an external device or transfer a signal received from the external device to the memory unit 230.

The control unit 220 may determine at least one executable operation of the AI device 200 based on information determined or generated using a data analysis algorithm or a machine learning algorithm. In addition, the control unit 220 may control the components of the AI device 200 to perform the determined operation. For example, the control unit 220 may request, search for, receive or utilize the data of the learning processor unit 240 c or the memory unit 230, and control the components of the AI device 200 to perform predicted operation or operation, which is determined to be desirable, of at least one executable operation. In addition, the control unit 220 may collect history information including operation of the AI device 200 or user's feedback on the operation and store the history information in the memory unit 230 or the learning processor unit 240 c or transmit the history information to the AI server (FIG. 1, 100g). The collected history information may be used to update a learning model.

The memory unit 230 may store data supporting various functions of the AI device 200. For example, the memory unit 230 may store data obtained from the input unit 240 a, data obtained from the communication unit 210, output data of the learning processor unit 240 c, and data obtained from the sensing unit 140. In addition, the memory unit 230 may store control information and/or software code necessary to operate/execute the control unit 220.

The input unit 240 a may acquire various types of data from the outside of the AI device 200. For example, the input unit 220 a may acquire learning data for model learning, input data, to which the learning model will be applied, etc. The input unit 240 a may include a camera, a microphone and/or a user input unit. The output unit 240 b may generate video, audio or tactile output. The output unit 240 b may include a display, a speaker and/or a haptic module. The sensing unit 140 d may obtain at least one of internal information of the AI device 200, the surrounding environment information of the AI device 200 and user information using various sensors. The sensing unit 140 d may include a proximity sensor, an illumination sensor, an acceleration sensor, a magnetic sensor, a gyro sensor, an inertia sensor, a red green blue (RGB) sensor, an infrared (IR) sensor, a finger scan sensor, an ultrasonic sensor, an optical sensor, a microphone and/or a radar.

The learning processor unit 240 c may train a model composed of an artificial neural network using training data. The learning processor unit 240 c may perform AI processing along with the learning processor unit of the AI server (FIG. 1, 100g). The learning processor unit 240 c may process information received from an external device through the communication unit 210 and/or information stored in the memory unit 230. In addition, the output value of the learning processor unit 240 c may be transmitted to the external device through the communication unit 210 and/or stored in the memory unit 230.

The proposed methods described above may be implemented independently, but may also be implemented in a form combining (or merging) some of the proposed methods. Information on whether the proposed methods are applied (or information on rules for the proposed methods) may be defined by a rule that the base station informs the UE through a predefined signal (e.g., a physical layer signal or a higher layer signal).

The present disclosure may be embodied in other specific forms without departing from the technical idea and essential features described herein. Therefore, the above detailed description should not be interpreted in a limiting sense in all aspects and should be considered as illustrative. The scope of the present disclosure should be determined by a reasonable interpretation of the appended claims, and all modifications within the equivalent scope of the present disclosure are included in the scope of the present disclosure. In addition, claims having no explicit reference relationship in the claims may be combined to constitute an embodiment, or may be included as new claims through amendment after filing.

### INDUSTRIAL APPLICABILITY

The embodiments of the present disclosure may be applied to various wireless access systems. Examples of various wireless access systems include 3GPP (3rd Generation Partnership Project) systems or 3GPP2 systems.

The embodiments of the present disclosure may be applied not only to the above various wireless access systems but also to all technical fields to which the above various wireless access systems are applied. Furthermore, the proposed method may be applied to mm Wave and THz communication systems using an ultra-high frequency band.

Additionally, the embodiments of the present disclosure may be applied to various applications such as autonomous vehicles and drones.

1. A method comprising:
receiving, by a user equipment (UE), from a base station, at least one synchronization signal block (SSB) among a plurality of SSBs including a first SSB and a second SSB;
detecting, by the UE, a synchronization signal included in the at least one SSB;
transmitting, by the UE, to the base station, a feedback signal based on the synchronization signal; and
performing, by the UE, a communication with the base station,
wherein the first SSB and the second SSB are multiplexed in a frequency domain within one time interval.

2. The method of claim 1, wherein the plurality of SSBs are transmitted through a reconfigurable intelligent surface (RIS) or a network-controlled repeater (NCR).

3. The method of claim 2, wherein a beamforming for each of the plurality of SSBs is determined based on a first beamforming between the base station and the RIS or the NCR and a second beamforming from the RIS or the NCR to the UE.

4. The method of claim 1, further comprising:
identifying, by the UE, a frequency offset of the at least one SSB which is received;
identifying, by the UE, information related to a location in the frequency domain of the at least one SSB which is received; and
determining, by the UE a reference point based on the frequency offset and the information related to the location in the frequency domain,
wherein the communication is performed based on the reference point.

5. The method of claim 4,
wherein the information related to the location in the frequency domain is determined based on at least one of a payload of a physical broadcast channel (PBCH) included in the at least one SSB which is received or a parameter value for scrambling of a demodulation reference signal (DMRS) of the PBCH.

6. The method of claim 5,
wherein a most significant bit (MSB) of the information related to the location in the frequency domain is determined based on the payload of the PBCH, and a least significant bit (LSB) is determined based on the parameter value for scrambling of the DMRS.

7. The method of claim 5,
wherein the parameter value for scrambling of the DMRS is determined based on a half frame index including the SSB which is received, the information related to the location on frequency domain or the received SSB index.

8. The method of claim 1, further comprising:
receiving, by the UE, from the base station, configuration information;
wherein the configuration information including information related to a number of SSBs which are multiplexed in a frequency domain within the one time interval.

9. The method of claim 8,
wherein a frequency gap between the first SSB and the second SSB is determined based on the number of SSBs which are multiplexed in a frequency domain and system band; and
wherein a reference point determined based on the frequency gap.

10. The method of claim 8,
wherein the configuration information includes information related to an on-off state of frequency multiplexing for each time interval in which the plurality of SSBs are transmitted.

11. The method of claim 1,
wherein the plurality of SSBs is transmitted within a plurality of time intervals,
wherein a same number of SSBs is multiplexed in frequency domain within each of the plurality of time intervals, and
wherein SSBs belonging to a same time interval have a same SSB index value.

12. The method of claim 1,
wherein the plurality of SSBs is transmitted within a plurality of time intervals,
wherein a same number of SSBs is multiplexed in frequency domain within each of the plurality of time intervals, and
wherein each of the plurality of SSBs has a unique SSB index value.

13. The method of claim 1,
wherein the plurality of SSBs is transmitted within a plurality of time intervals,
wherein a same number of SSBs is multiplexed in frequency domain within each of the plurality of time intervals, and
wherein each of the plurality of SSBs is allocated to a time interval shifted by a pre-configured value from a time interval in which SSBs that are not multiplexed in a frequency domain are allocated.

14. The method of claim 1,
wherein the plurality of SSBs is transmitted within a plurality of time intervals, and
wherein a number of SSBs multiplexed in a frequency domain within each of the plurality of time intervals is changed.

15. The method of claim 1,
wherein the plurality of SSBs is transmitted within a plurality of time intervals, and
wherein the plurality of SSBs are multiplexed in a frequency domain based on bandwidth part (BWP).

16. The method of claim 15,
wherein the configuration related to SSBs that are not multiplexed in a frequency domain applied based on a collision between the plurality of SSBs that are multiplexed in a frequency domain and the SSBs that are not multiplexed in a frequency domain.

17. A method performed comprising:
transmitting, by a base station, to a user equipment (UE), a plurality of synchronization signal blocks (SSBs) including a first SSB and a second SSB;
receiving, by the base station, from the UE, a feedback signal based on a detected synchronization signal; and
performing, by the base station, communication with the UE,
wherein the first SSB and the second SSB are multiplexed in a frequency domain within one time interval.

18. The method of claim 17, further comprising:
obtaining, by the base station, synchronization related to reconfigurable intelligent surface (RIS) or a network-controlled repeater (NCR);
transmitting, by the base station, to the RIS or the NCR, a configuration related to the plurality of SSBs; and
transmitting, by the base station, to the UE, the configuration related to the plurality of SSBs to the UE.

19. The method of claim 18, further comprising:
transmitting, by the base station, to the RIS or the NCR, information related to a detected SSB based on the feedback signal received from the UE.

20. A user equipment (UE) comprising:
at least one transceiver;
at least one processor; and
at least one memory connected to the at least one processor and storing instructions that, based on being executed, cause the UE to perform operation comprising:
receiving, from a base station, at least one synchronization signal block (SSB) among a plurality of SSBs including a first SSB and a second SSB;
detecting a synchronization signal included in the at least one SSB;
transmitting, to the base station, a feedback signal based on the synchronization signal; and
performing a communication with the base station,
wherein the first SSB and the second SSB are multiplexed in a frequency domain within one time interval.

21-23. (canceled)
